(19) United States
(12) Patent Application Publication
(10) Pub. No.: US 2005/0107608 A1
(43) Pub. Date: May 19, 2005

(54) Ligands for use in catalytic processes

(76) Inventors: Stephan Deblon, Odenthal (DE); Hansjorg Gruzmacher, Wettswil (CH); Pascal F. Marie, Liestal (CH); Hartmut Schonberg, Kilchberg (CH)

Correspondence Address: HARNESS, DICKEY & PIERCE, P.L.C., P.O. BOX 828, BLOOMFIELD HILLS, MI, 48303, US

(21) Appl. No.: 10/494,083

(22) PCT Filed: Nov. 30, 2002
(86) PCT No.: PCT/EP02/13533

(30) Foreign Application Priority Data
Dec. 1, 2001 (DE) 101590156

(51) Int. Cl. C07F 9/6512

(52) U.S. Cl. 544/243; 544/157

(57) ABSTRACT

The invention relates to novel phosphorus compounds, to a method for producing said phosphorus compounds and their intermediate products. The invention also relates to the catalysts produced according to the invention on the basis of the phosphorus compounds and to their use in catalytic processes, especially in asymmetric catalytic processes.

The present invention relates to novel phosphorus compounds, methods for the preparation of such phosphorus compounds and their intermediates. Further, the invention also relates to catalysts which can be prepared from the phosphorus compounds, and their application in catalytic processes, especially in asymmetric catalytic processes.

Deblon et al. (New. J. Chem., 2001, 25, 8393) describe chiral racemic compounds for electrochemical examinations: 5-diphenylphosphanyl-10-methyl-5H-dibenzo[a,d]cycloheptene (Metroppph), 5-diphenylphosphanyl-10-ethyl-5H-di-benzo[a,d]cycloheptene (Ettroppph), 5-diphenylphosphanyl-10-pentyl-5H-di-benzo[a,d]cycloheptene (Penttroppph) and 5-diphenylphosphanyl-10-benzyl-5H-dibenzo[a,d]cycloheptene (BenzYItroppph). The compound mentioned first was described as a racemic mixture, the remaining were described in the form of ligands in racemic rhodium complexes.

The non-asymmetric hydrogenation of olefins with rhodium complexes of 5-di-phenylphosphanyl-5H-dibenzo[a,d]cycloheptene (troppph) and dicyclohexylphosphanyl-5H-dibenzo[a,d]cycloheptene (troppcYc) has been known from Thomaier, dissertation Universität Freiburg 1996. However, the conversion rates are low, especially for the hydrogenation of enamides, and therefore unsuitable for industrial use.

Phosphorus compounds, such as phosphines, phosphites, phosphoramidites or phosphonites have gained great importance especially in homogeneous catalytic processes, because they are capable to control the catalytic activity of transition metals by complexation thereto, and in the case of chiral phosphorus compounds, may transfer stereo information to a substrate to be converted.

Therefore, an enormous variety of phosphorus compounds for use in (asymmetric) catalytic processes has been described in the literature.

In the course of the last decades, it has been found that it is difficult, for the use of phosphorus compounds in such processes, to make predictions about the extent of catalytic activity and selectivity, such as the stereoselectivity in asymmetric syntheses, because both the steric and electronic demands on a particularly effective catalyst may be different for each substrate to be converted, depending on the type of reaction (e.g., hydrogenations or carbon-carbon coupling reactions).

Therefore, there was a need for preparing phosphorus compounds which can be easily varied in their substitution patterns and thus their steric and electronic properties and are suitable for use in catalytic processes and, in particular, asymmetric catalytic processes.

Surprisingly, it has now been found that chiral compounds of general formula (I) are suitable for use in catalytic processes: 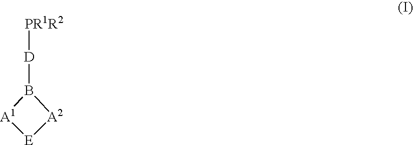
wherein
R¹ and R² independently represent a monovalent residue containing from 1 to 30 carbon atoms; or
PR¹R² together represent a five- to nine-membered heterocyclic residue which contains a total of 2 to 50 carbon atoms and contains up to three further heteroatoms selected from the group consisting of oxygen and nitrogen; and
D is absent or represents NR³, wherein
   R³ represents C₁-C₁₂ alkyl, C₃-C₁₂ alkenylalkyl, C₄-C₁₅ aryl or C₅-C₁₆ arylalkyl; and
      in the case where D is absent:
B represents nitrogen or CH; and
   in the case where D represents NR³:
B represents CH; and
A¹ and A² independently represent a substituted or unsubstituted ortho-arylene residue; and
E represents E¹ or E², and E¹ represents an unsubstituted, mono- or disubstituted vicinal cis-alkenediyl residue, and E² represents a vicinal alkanediyl residue in which each of the two -yl- carbon atoms bears one or two hydrogen atoms;
   wherein at least one or more of the following conditions are met:
A¹-E-A², preferably E, does not possess a mirror plane as an element of symmetry orthogonal to the carbon-carbon bond which connects the two vicinal -yl- residues of E;
R¹ and R² are different;
PR¹R² as a whole possesses at least one stereogenic center;
R³ possesses a stereogenic center;
   except for 5-diphenylphosphanyl-10-methyl-5H-dibenzo[a,d]cycloheptene, 5-di-phenylphosphanyl-10-ethyl-5H-dibenzo[a,d]cycloheptene, 5-diphenylphosphanyl-10-pentyl-5H-dibenzo[a,d]cycloheptene and 5-diphenylphosphanyl-10-benzyl-5H-dibenzo[a,d]cycloheptene.

The invention also relates to the chiral compounds of general formula (I) themselves. They may occur in various stereoisomeric forms which either are mirror images of each other (enantiomers) or which are not mirror images of each other (diastereomers). The invention includes both the stereoisomerically pure forms of the respective compounds and any mixtures of the stereoisomers, such as racemates or pairs of diastereomers.

Further, the invention also relates to salts of compounds of general formula (I). For example, these are hydrohalides, such as hydrobromides and hydrochlorides, salts of carboxylic acids, such as trifluoroacetates, or salts of sulfonic acids, such as camphor sulfonates.

According to the invention, the terms “stereoisomer-enriched” (“enantiomer-enriched” or “diastereomer-enriched”) mean stereoisomerically pure (enantiomerically pure or diastereomerically pure) compounds or mixtures of stereoisomers (enantiomers or diastereomers) in which one stereoisomer (enantiomer or diastereomer) is contained in a higher proportion as compared to another or the other.

For example and preferably, for compounds of general formula (I), “stereoisomer-enriched” means a content of one stereoisomer of from 50% to 100%, more preferably 70% to 100%, even more preferably 90% to 100%.

According to the invention, “asymmetric catalytic processes” means syntheses of chiral compounds which take place in the presence of catalysts and in which the products are formed in a stereoisomer-enriched form.

It may be noted here that, for compounds of general formula (I), the invention includes any combinations of the preferential ranges mentioned in the following provided that they meet at least one of the above mentioned conditions.

According to the invention, for example, aryl as a substituent represents carbocyclic aromatic residues with 6 to 24 skeletal atoms, preferably phenyl, naphthyl, phenanthrenyl and anthracenyl, or heteroaromatic residues with 5 to 24 skeletal atoms in which none, one, two or three skeletal atoms per cycle, but at least one skeletal atom in the whole molecule, are heteroatoms selected from the group consisting of nitrogen, sulfur or oxygen, preferably pyridinyl, oxazolyl, thiophenyl, benzofuranyl, benzothiophenyl, dibenzofuranyl, dibenzothiophenyl, furanyl, indolyl, pyridazinyl, pyrazinyl, imidazolyl, pyrimidinyl and quinolinyl. According to the invention, statements like “C₅”, for example, relate to the number of carbon atoms of the aromatic skeleton in the case of aryl residues.

Further, the carbocyclic aromatic residues or heteroaromatic residues may be substituted with up to five identical or different substituents per cycle. For example and preferably, the substituents are selected from the group consisting of fluoro, chloro, nitro, cyano, free or protected formyl, hydroxy, C₁-C₁₂ alkyl, C₁-C₁₂ haloalkyl, C₁-C₁₂ alkoxy, C₁-C₁₂ haloalkoxy, C₃-C₁₀ aryl, such as phenyl, C₄-C₁₁ arylalkyl, such as benzyl, di(C₁-C₁₂ alkyl)amino, (C₁-C₁₂ alkyl)amino, CO(C₁-C₁₂ alkyl), OCO(C₁-C₁₂ alkyl), NHCO(C₁-C₁₂ alkyl), N(C₁-C₆ alkyl)CO(C₁-C₁₂ alkyl), CO(C₃-C₁₂ aryl), OCO(C₃-C₁₂ aryl), NHCO(C₃-C₁₂ aryl), N(C₁-C₆ alkyl)CO(C₃-C₁₂ aryl), COO-(C₁-C₁₂)-alkyl, COO-(C₃-C₁₂)-aryl, CON(C₁-C₁₂ alkyl)₂ or CONH(C₁-C₁₂ alkyl)CO₂M, CONH₂, SO₂NH₂, SO₂N(C₁-C₁₂ alkyl)₂, SO₃M, wherein M respectively represents optionally substituted ammonium, lithium, sodium, potassium or cesium.

For example and preferably, aryl represents phenyl, naphthyl, pyridinyl and quinolyl which may be further substituted with none, one, two or three residues per cycle, the residues being selected from the group consisting of fluoro, chloro, cyano, C₁-C₈ alkyl, C₁-C₈ perfluoroalkyl, C₁-C₈ alkoxy, C₃-C₁₀ aryl, such as phenyl, C₄-C₁₁ arylalkyl, such as benzyl, di(C₁-C₁₂ alkyl)amino, CO(C₁-C₁₂ alkyl), COO-(C₁-C₁₂)-alkyl, CON(C₁-C₁₂ alkyl)₂ or SO₂N(C₁-C₁₂ alkyl)₂.

More preferably, aryl represents phenyl or naphthyl which may be further substituted with none, one, two or three residues per cycle, the residues being selected from the group consisting of fluoro, chloro, cyano, C₁-C₈ alkyl, C₁-C₈ perfluoroalkyl, C₁-C₈ alkoxy, C₃-C₁₀ aryl, such as phenyl, or SO₂N(C₁-C₁₂ alkyl)₂.

According to the invention, the definition and the preferential ranges also apply, mutatis mutandis, to aryloxy substituents and the aryl moiety of an arylalkyl residue.

“Protected formyl” means a formyl residue which has been protected by conversion to an aminal, acetal or mixed aminal/acetal, wherein said aminals, acetals and mixed aminals/acetals may be acyclic or cyclic.

For example and preferably, protected formyl represents a 1,1-(2,5-dioxy)cyclopentyl residue.

According to the invention, alkyl, alkylene and alkoxy independently represent a straight-chain, cyclic, branched or unbranched alkyl or alkylene or alkoxy residue, respectively, which may optionally be further substituted with C₁-C₄ alkoxy residues in such a way that each carbon atom of said alkyl, alkylene or alkoxy residue bears at most one heteroatom selected from the group consisting of oxygen, nitrogen or sulfur.

The same applies to the alkylene moiety of an arylalkyl residue.

For example, according to the invention, C₁-C₆ alkyl represents methyl, ethyl, 2-ethoxyethyl, n-propyl, isopropyl, n-butyl, tert-butyl, n-pentyl, cyclohexyl and n-hexyl, and C₁-C₈ alkyl additionally represents, for example, n-heptyl, n-octyl or isooctyl, and C₁-C₁₂ alkyl still additionally represents, for example, norbornyl, adamantyl, n-decyl and n-dodecyl, and C₁-C₁₈ alkyl still additionally represents, for example, n-hexadecyl and n-octadecyl.

For example, according to the invention, C₁-C₄ alkylene represents methylene, 1,1-ethylene, 1,2-ethylene, 1,1-propylene, 1,2-propylene, 1,3-propylene, 1,1-butylene, 1,2-butylene, 2,3-butylene and 1,4-butylene, and C₁-C₈ alkylene additionally represents 1,5-pentylene, 1,6-hexylene, 1,1-cyclohexylene, 1,4-cyclohexylene, 1,2-cyclohexylene and 1,8-octylene.

For example, according to the invention, C₁-C₄ alkoxy represents methoxy, ethoxy, isopropoxy, n-propoxy, n-butoxy and tert-butoxy, and C₁-C₈ alkoxy additionally represents cyclohexyloxy.

According to the invention, alkylenylalkyl independently represents a straight-chain, cyclic, branched or unbranched alkyl residue which has at least one olefinic double bond and is bonded through an alkyl carbon atom.

For example and preferably, C₃-C₁₂ alkenylaryl represents allyl, methallyl or 3-butenyl.

According to the invention, haloalkyl and haloalkoxy independently represent a straight-chain, cyclic, branched or unbranched alkyl or alkoxy residue, respectively, which is monosubstituted, polysubstituted or completely substituted with halogen atoms. Residues which are completely substituted with fluorine are referred to as “perfluoroalkyl” or “perfluoroalkoxy”, respectively.

For example, according to the invention, C₁-C₆ haloalkyl represents trifluoromethyl, 2,2,2-trifluoroethyl, chloromethyl, fluoromethyl, bromomethyl, 2-bromoethyl, 2-chloroethyl, nonafluorobutyl, and C₁-C₈ haloalkyl additionally represents, for example, n-perfluorooctyl, and C₁-C₁₂ haloalkyl additionally represents, for example, n-perfluorododecyl.

For example, according to the invention, C₁-C₄ haloalkoxy represents trifluoromethoxy, 2,2,2-trifluoroethoxy, 2-chloroethoxy, heptafluoroisopropoxy, and C₁-C₈ haloalkoxy additionally represents n-perfluorooctyloxy.

In the compounds of general formula (I), for example and preferably, R¹ and R² independently represent C₁-C₁₈ alkyl, C₁-C₁₈ perfluoroalkyl, C₁-C₁₈ perfluoroalkoxy, C₁-C₁₈ alkoxy, C₃-C₂₄ aryl, C₃-C₂₄ aryloxy, C₄-C₂₅ arylalkyl, C₄-C₂₅ arylalkoxy or NR⁴R⁵, wherein R⁴ and R⁵ independently represent C₁-C₁₂ alkyl, C₃-C₁₄ aryl or C₄-C₁₅ arylalkyl, or NR⁴R⁵ as a whole represents a five- to seven-membered cyclic amino residue with a total of 4 to 12 carbon atoms.

Further, for example and preferably, R¹ and R² may independently represent residues of general formula (II):
F-Het¹-(R⁶)ₙ (II)
wherein
F represents a C₁-C₈ alkylene residue; and
Het¹ represents a heteroatom which is selected from the group consisting of sulfur, oxygen, phosphorus or nitrogen; and
   for sulfur and oxygen: n=1; and
   for phosphorus or nitrogen: n=2; and
R⁶ independently represents C₁-C₁₂ alkyl, C₄-C₁₄ aryl or C₅-C₁₅ arylalkyl; and
for n=2, in addition:
Het¹-(R⁶)₂ represents a five- to nine-membered heterocyclic residue which contains a total of 2 to 20 carbon atoms and optionally up to three further heteroatoms selected from the group consisting of nitrogen and oxygen.

Further, for example and preferably, R¹ and R² independently represent residues of general formulas (IIIa) and (IIIb):
F—R⁸-G-R⁹ (IIIa)
F-G-R⁷ (IIIb)
wherein
F has the meaning as mentioned under general formula (II);
G represents carbonyl or sulfonyl; and
R⁷ represents R⁹, NH, NR⁹, N(R⁹)₂, OH or OM or, if G is carbonyl, also OR⁹;
R⁸ represents NH, NR⁹ or, if G is carbonyl, also oxygen; and
R⁹ independently represents C₁-C₁₂ alkyl, C₄-C₁₄ aryl or C₅-C₁₅ arylalkyl; or
N(R⁹)₂ together represents a five- to seven-membered heterocyclic residue with a total of 2 to 12 carbon atoms which optionally contains up to three further heteroatoms selected from the group consisting of sulfur, nitrogen and oxygen;
M¹ represents, within the scope of R⁷, 1/m equivalents of a metal ion with a valence of m or optionally substituted ammonium, preferably ammonium or an equivalent of an alkali metal ion, such as lithium, sodium, potassium or cesium.

Further, for example and preferably, PR¹R² together represents a five- to seven-membered heterocyclic residue of general formula (IV): 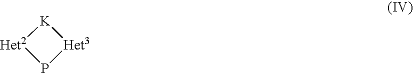
wherein
Het² and Het³ independently are absent or represent oxygen or NR¹⁰, wherein R¹⁰ represents C₁-C₁₂ alkyl, C₄-C₁₄ aryl or C₅-C₁₅ arylalkyl; and
K represents an alkanediyl residue with 2 to 25 carbon atoms, a divalent arylalkyl residue with 5 to 15 carbon atoms, an arylene residue with a total of 5 to 14 carbon atoms or a 2,2′-(1,1′-bisarylene) residue with a total of 10 to 30 carbon atoms.

More preferably, R¹ and R² independently represent C₁-Cl₂ alkyl, C₃-C₁₀ aryl, C₄-C₂₅ arylalkyl or residues of general formula (II) in which
F represents a C₁-C₄ alkylene residue; and
Het¹ represents a heteroatom selected from the group consisting of phosphorus or nitrogen; and
n=2; and
R⁶ independently represents C₁-C₆ alkyl or C₃-C₁₄ aryl, or Het¹-(R⁶)₂ represents a five- to seven-membered heterocyclic residue selected from the group consisting of morpholinyl, pyrrolidinyl, piperidinyl, furanyl, phospholanyl, which may further be substituted with none, one or two C₁-C₄ alkyl residues.

Further, more preferably, PR¹R² together represents a five- to seven-membered heterocyclic residue of general formula (IV) in which
Het² and Het³ are identically absent or independently represent oxygen or nitrogen; and
K represents a C1-C8 alkylene residue or a 2,2′-(1,1′-bisphenylene)-2,2′-(1,1′-bisnaphthylene) residue which may be further substituted with up to two substituents per cycle selected from the group consisting of fluoro, chloro, C₁-C₄ alkyl or C₁-C₄ alkoxy.

Even more preferably, R¹ and R² independently represent methyl, ethyl, n-propyl, isopropyl, tert-butyl, cyclohexyl, benzyl, 2-(2-pyridyl)ethyl, o-, m-, p-tolyl, 2,6-dimethylphenyl, 3,5-di-tert-butylphenyl, p-trifluoromethylphenyl, 3,5-bis(trifluoromethylphenyl), p-tert-butylphenyl, o-, m-, p-anisyl, 2,6-dimethoxyphenyl, o-, m-, p-dimethylaminophenyl, 2-, 3-, 4-pyridyl, 2-furanyl, 2-pyrrolyl or residues of general formula (II) in which
F represents methylene, 1,2-ethylene, 1,3-propylene, 1,2-propylene or 1,4-butylene; and
Het¹ represents phosphorus; and
n=2; and
R⁶ identically represent methyl, ethyl, n-propyl, isopropyl, tert-butyl, cyclohexyl, benzyl, phenyl, o-, m-, p-tolyl, 2,6-dimethylphenyl, 3,5-di-tert-butylphenyl, p-trifluoromethylphenyl, 3,5-bis(trifluoromethylphenyl), p-tert-butylphenyl, o-, m-, p-anisyl, 2,6-dimethoxyphenyl, o-, m-, p-dimethylaminophenyl, 2-, 3-, 4-pyridyl, furanyl or pyrrolyl; or
Het¹-(R⁶)₂ together represents a five- or six-membered heterocyclic residue selected from the group consisting of pyrrolidinyl, (R,R)- or (S,S)-2,5-dimethylpyrrolidinyl, piperidinyl, (R,R)- or (S,S)-2,5-dimethylphospholanyl.

Further, PR¹R² even more preferably together represents a five- to seven-membered heterocyclic residue of general formula (IV) in which either
Het² and Het³ are both absent; and
K represents a C₁-C₈ alkylene residue; or
Het²-K-Het³ as a whole represents a 2,2-dioxy(1,1-binaphthyl) residue a 2,2′-dioxy(1,1′-biphenyl) residue which is disubstituted at least in the 6,6′ positions, but at most disubstituted per cycle, the substituents being selected from the group consisting of fluoro, chloro, C₁-C₄ alkyl or C₁-C₄ alkoxy.

Most preferably, PR¹R² as a whole represents diisopropylphosphino, di-tertbutylphosphino, dicyclohexylphosphino, diphenylphosphino, bis(o-, m-, p-tolyl)-phosphino, di(3,5-bis(trifluoromethyl)phenyl)phosphino, di(o-anisyl)phosphino, di(2-pyridyl)phosphino or diisopropylphosphinomethylisopropylphosphino, 2-di-phenylphosphinoethylphenylphosphino, 3-diphenylphosphinopropylphenylphosphino, 2-(2-pyridylethyl)cyclohexylphosphino, 2-(2-pyridylethyl)phenylphosphino, 2-(N-pyrrolidinoethyl)cyclohexylphosphino, 2-(N-pyrrolidinoethyl)phenylphosphino, (R) or (S)-(2,2′-dioxy-1,1′-binaphthyl)phosphino, (4S,5R)-3,4-dimethyl-5-phenyl-1,3,2-oxazaphospholidino, (R,R)-2,5-dimethylphospholano or (S,S)-2,5-dimethylphospholano, wherein diisopropylphosphino, di-tert-butyl-phosphino, dicyclohexylphosphino, diphenylphosphino, bis(o-, m-, p-tolyl)phosphino, di(3,5-bis(trifluoromethyl)phenyl)phosphino, di(o-anisyl)phosphino, di-(2-pyridyl)phosphino and (R) or (S)-(2,2′-dioxy-1,l′-binaphthyl)phosphino are more preferred, and diphenylphosphino, dicyclohexylphosphino, di-tert-butyl-phosphino and (R,R)-2,5-dimethylphospholano are even more preferred.

Further, as compounds of general formula (I), those are preferred in which D is absent and

B in general formula (I) represents nitrogen or CH, CH being preferred.

For example and preferably, A¹ and A² independently represent an orthophenylene residue of general formula (V) 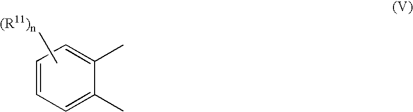
wherein
n represents 0, 1, 2, 3 or 4, preferably 0, 1 or 2, more preferably 0 or 1; and
R¹¹ is independently selected from the group consisting of fluorine, chlorine, bromine, iodine, nitro, free or protected formyl, C₁-C₁₂ alkyl, C₁-C₁₂ alkoxy, C₁-C₁₂ haloalkoxy, C₁-C₁₂ haloalkyl, C₃-C₁₀ aryl, C₄-C₁₁ arylalkyl or residues of general formula (VI):
   L-Q-T-W (VI)
   in which independently:
L is absent or represents an alkylene residue with 1 to 12 carbon atoms or an alkenylene residue with 2 to 12 carbon atoms; and
Q is absent or represents oxygen, sulfur or NR¹²;
   wherein R¹² represents hydrogen, C₁-C₈ alkyl, C₅-C₁₄ arylalkyl or C₄-C₁₅ aryl; and
T represents a carbonyl group; and
W represents R¹³, OR¹³, NHR¹⁴ or N(R¹⁴)₂;
   wherein
   R¹³ represents C₁-C₈ alkyl, C₅-C₁₅ arylalkyl or C₅-C₁₄ aryl; and
   R¹⁴ independently represents C₁-C₈ alkyl, C₅-C₁₄ arylalkyl or C₄-C₁₅ aryl, or N(R¹³)₂ together represents a five- or six-membered cyclic amino residue;
      or residues of general formulas (VIIa-g):
      L—W (VIIa)
      L—SO₂—W (VIIb)
      L—NR¹²—SO₂R¹² (VIIc)
      L—SO₃Z (VIId)
      L—PO₃Z₂ (VIIe)
      L—COZ (VIIf)
      L—CN (VIIg)
      wherein L, Q, W and R¹³ have the meanings as stated under the general formula (VI), and Z represents hydrogen or M¹, wherein Ml has the meaning as stated under the definition of R⁷.

More preferably, A¹ and A² independently represent an ortho-phenylene residue of general formula (V) in which
n represents 0 or 1; and
R¹¹ is independently selected from the group consisting of fluorine, chlorine, bromine, iodine, cyano, C₁-C₄ alkyl, C₁-C₄ alkoxy, di(C₁-C₄ alkyl)amino, (C₁-C₄ alkyl)amino, C₁-C₄ alkylthio, C0₂M¹, CONH₂, SO₂N(R²⁰)₂, SO₃M¹, wherein M¹ respectively represents lithium, sodium or potassium, and R²⁰ independently represents hydrogen or C₁-C₄ alkyl.

Even more preferably, A¹ and A² identically represent an ortho-phenylene residue of general formula (V) in which
n represents 0 or 1; and
R¹¹ is selected from the group consisting of fluorine, chlorine, cyano, methyl, ethyl, methoxy, ethoxy, methylthio, dimethylamino, CONH₂, SO₂N(methyl)₂ or SO₂N(ethyl)₂, wherein for n=1, R¹¹ is even more preferably arranged in a para position with respect to E.

Even more preferably, A¹ and A² identically represent ortho-phenylene.

For example and preferably, E¹ represents residues of general formula (VIIIa) 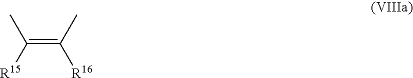
wherein
R¹⁵ and R¹⁶ independently represent hydrogen, cyano, fluorine, chlorine, bromine, iodine, C₁-C₁₈ alkyl, C₄-C₂₄ aryl, C₅-C₂₅ arylalkyl, CO₂M, CONH₂, SO₂N(R¹⁷)₂, SO₃M¹, wherein M¹ has the meaning as stated under R⁷, and R¹⁷ independently has the meaning defined below, or residues of general formula (IX):
   T²-Het⁴-R¹⁸ (IX)
   wherein
   T² is absent or represents carbonyl;
   Het⁴ represents oxygen or NR¹⁷, wherein R¹⁷ represents hydrogen, C₁-C₁₂ alkyl, C₄-C₁₄ aryl or C₅-C₁₅ arylalkyl; and
   R¹⁸ represents C₁-C₁₈ alkyl, C₃-C₂₄ aryl or C₄-C₂₅ arylalkyl.

Further, for example and preferably, E² represents residues of general formula (VIIIb): 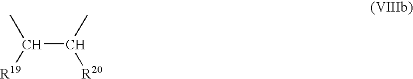
wherein
R¹⁹ and R²⁰ independently represent hydrogen, C₁-C₁₈ alkyl, C₃-C₂₄ aryl or C₄-C₂₅ arylalkyl.

Preferably, E represents E¹.

More preferably, E¹ represents residues of general formula (VIIIa) in which either of residues R¹⁵ and R¹⁶ represents hydrogen, the other being selected from the group consisting of hydrogen, cyano, fluorine, C₁-C₁₂ alkyl, phenyl, C₁-C₁₈ alkoxy or C₅-C₁₅ arylalkoxy, wherein C₁-C₁₈ alkoxy and C₅-C₁₅ arylalkoxy are preferably chiral.

Even more preferably, either of residues R¹⁵ and R¹⁶ represents hydrogen, the other being selected from the group consisting of hydrogen, cyano, fluorine, phenyl, methoxy or menthoxy, wherein (−)-menthoxy is preferred among the 8 isomers.

As individual compounds of general formula (I), the following may be mentioned:
(5R)-5-(phenyl-2-(2-pyridyl)ethylphosphanyl)-5H-dibenzo[a,d]cycloheptene (R-tropp^{Ph,Et-2-py}),
(5S)-5-(phenyl-2-(2-pyridyl)ethylphosphanyl)-5H-dibenzo[a,d]cycloheptene (S-tropp^{Ph,Et-2-py}),
(5R)-5-(phenyl-2-(N-pyrrolidinyl)ethylphosphanyl)-5H-dibenzo[a,d]cycloheptene (R-tropp^{Ph,Et-N-pyrro}),
(5S)-5-(phenyl-2-(N-pyrrolidinyl)ethylphosphanyl)-5H-dibenzo[a,d]cycloheptene (S-tropp^{Ph,Et-N-pyrro}),
(5S)-5-(cyclohexyl-2-(2-pyridyl)ethylphosphanyl)-5H-dibenzo[a,d]cycloheptene (S-tropp^{Ph,Et-2-py}),
(5R)-5-(cyclohexyl-2-(2-pyridyl)ethylphosphanyl)-5H-dibenzo[a,d]cycloheptene (R-tropp^{cyc,Et-2-py}),
(5R)-5-(cyclohexyl-2-(N-pyrrolidinyl)ethylphosphanyl)-5H-dibenzo[a,d]cycloheptene (R-tropp^{cyc,Et-2-pyrro}),
(5S)-5-(cyclohexyl-2-(N-pyrrolidinyl)ethylphosphanyl)-5H-dibenzo[a,d]-cycloheptene (S-tropp^{cyc,Et-2-pyrro}),
(5R)-10-cyano-5-diphenylphosphanyl-5H-dibenzo[a,d]cycloheptene (R-^{CN}tropp^{Ph}),
(5S)-10-cyano-5-diphenylphosphanyl-5H-dibenzo[a,d]cycloheptene (S-^{CN}tropp^{Ph}),
5-(2S,5S-2,5-dimethylphospholanyl)-5H-dibenzo[a,d]cycloheptene (S,S-tropphos^{ME}),
5-(2R,5R-2,5-dimethylphospholanyl)-5H-dibenzo[a,d]cycloheptene (R,R-tropphos^{ME}),
5-(2S,5S-2,5-dimethylphospholanyl)-3,7-diiodo-5H-dibenzo[a,d]cycloheptene (S,S-₁tropphos^{Me}),
5-(2R,5R-2,5-dimethylphospholanyl)-3,7-diiodo-5H-dibenzo[a,d]cycloheptene (R,R-₁tropphos^{Me}),
(5R)-5-[(3-diphenylphosphanylpropyl)phenylphosphanyl]-5H-dibenzo[a,d]cycloheptene (R-tropp^{Ph(CH2)3PPh2}),
(5S)-5-[(3-diphenylphosphanylpropyl)phenylphosphanyl]-5H-dibenzo[a,d]cycloheptene (S-tropp^{Ph(CH2)3PPh2}),
(5R)-5-[(4-diphenylphosphanylbutyl)phenylphosphanyl]-5H-dibenzo[a,d]cycloheptene (R-tropp^{Ph(CH2)4PPh2}),
(5S)-5-[(4-diphenylphosphanylbutyl)phenylphosphanyl]-5H-dibenzo[a,d]cycloheptene (S-tropp^{Ph(CH2)4PPh2}),
(5R)-5-{[(diisopropylphosphanyl)methyl]isopropylphosphanyl}-5H-dibenzo[a,d]-cycloheptene (R-tropp^{ipr(CH2)PiPr2}),
(5S)-5-{[(diisopropylphosphanyl)methyl]isopropylphosphanyl}-5H-dibenzo[a,d]-cycloheptene (S-tropp^{ipr(CH2)PiPr2}),
(4S,5R)-2-(5H-dibenzo[a,d]cycloheptyl)-3,4-dimethyl-5-phenyl-1,3,2-oxazaphospholidine (tropp^{(-)ephedrine}),
Rₚ-10,11-dihydro-5H-dibenzo[a,d]cyclohepten-5-yl)methylphenylphosphane ((R)-H₂tropp^{Me,Ph}),
Sₚ-10,11-dihydro-5H-dibenzo[a,d]cyclohepten-5-yl)methylphenylphosphane ((S)-H₂tropp^{Me,Ph}),
(S)-4-(10,11-dihydro-5H-dibenzo[a,d]cyclohepten-5-yl)-3,5-dioxa-4-phosphacyclohepta[2,1-a3,4.a′]dinaphthalene ((S)-H₂tropp^{ONp}),
(R)-4-(10,11-dihydro-5H-dibenzo[a,d]cyclohepten-5-yl)-3,5-dioxa-4-phosphacyclohepta[2,1-a3,4.a′]dinaphthalene ((R)-H₂tropp^{ONp}),
(S)-4-(5H-dibenzo[a,d]cyclohepten-5-yl)-3,5-dioxa-4-phosphacyclohepta[2,1-a3,4.a′]dinaphthalene ((S)-tropp^{ONp}),
(R)-4-(5H-dibenzo[a,d]cyclohepten-5-yl)-3,5-dioxa-4-phosphacyclohepta[2,1-a3,4.a′]dinaphthalene ((R)-tropp^{ONp}),
(5R)-10-methoxy-5H-dibenzo[a,d]cyclohepten-5-yldiphenylphosphane (R-^{MeO}tropp^{Ph}),
(5S)-10-methoxy-5H-dibenzo[a,d]cyclohepten-5-yldiphenylphosphane (S-^{MeO}tropp^{Ph}),
(5R)-10-methoxy-5H-dibenzo[a,d]cyclohepten-5-yldicyclohexylphosphane (R-^{MeO}tropp^{Cyc}),
(5S)-10-methoxy-5H-dibenzo[a,d]cyclohepten-5-yldicyclohexylphosphane (S-^{MeO}tropp^{Cyc}),
(5R)-10-fluoro-5H-dibenzo[a,d]cyclohepten-5-yldiphenylphosphane (R-^{F}tropp^{Ph}),
(5S)-10-fluoro-5H-dibenzo[a,d]cyclohepten-5-yldiphenylphosphane (S-^{F}tropp^{Ph}),
[(5S)-10-[(−)-menthyloxy]-5H-dibenzo[a,d]cyclohepten-5-yl]diphenylphosphane (S-^{menthyloxy}tropp^{Ph}),
[(5R)-10-[(−)-menthyloxy]-5H-dibenzo[a,d]cyclohepten-5-yl]diphenylphosphane (R-^{menthyloxy}tropp^{Ph}).

The preparation of the compounds of general formula (I) can be effected, for example, as follows:

(1.1) In the compounds of general formula (I), if B represents CH, the preparation is effected, for example, according to Thomaier et al. (New. J. Chem. 1998, 947-958) or Deblon et al. (New. J. Chem. 2001, 25, 83-92) or by an analogous procedure.

Thus, reduction of ketones of general formula (X) 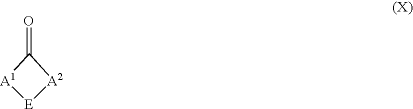
in which A¹, A² and E have the meanings and preferential ranges as stated under general formula (I), for example, in a per se known manner with aluminum triisopropylate or complex hydrides, for example, boranates, such as lithium or sodium borohydride, lithium or sodium triethylboranate, is first effected to form alcohols of general formula (XI) 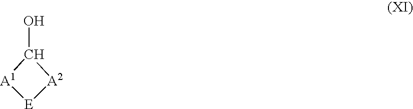
in which A¹, A² and E have the same meanings as above.

The ketones used as a starting material are commercially available, known from the literature, or can be synthesized by analogy with literature methods. Substituents which themselves react with all the mentioned reductants, such as those having keto groups or aldehyde functions, are preferably introduced into the molecule in a later step (see, for example, methods 1.7 and 1.8). The same applies to substituents which are easily alkylated, such as amino or hydroxy groups.

(1.2) The alcohols of general formula (XI) can then be reacted with halogenation agents, such as thionyl chloride, thionyl bromide, phosphorus pentachloride or with anhydrides or halides of carboxylic acids having a pKₐ value of from 0 to 3, such as trifluoroacetic anhydride or trifluoroacetic chloride, or sulfonic halides or sulfonic anhydrides, such as camphorsulfonyl chloride, to form compounds of general formula (XIII) 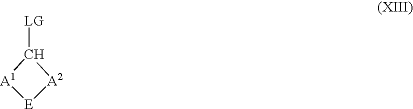
in which A¹, A² and E have the meanings and preferential ranges as mentioned under general formula (I), and LG represents chlorine, bromine, a carboxylate of a carboxylic acid having a pKₐ value of from 0 to 3, or a sulfonate, preferably chlorine. If A¹, A² and/or E have substituents which are easily alkylated, such as amino or hydroxy groups, these should be protected in the usual way (e.g., as acetamide or acetate) already before the reduction of the ketones.

(1.3) Subsequently, the compounds of general formula (XIII) can be directly reacted with secondary phosphines of general formula (XV)
HPR¹R² (XV)
in which PR¹R² and R¹ and R² have the meanings as stated under general formula (I) and are preferably those in which R¹ and R² are bonded to phosphorus through a carbon atom. This yields intermediate salts of compounds of general formula (I) with acids of the type H-LG in which LG has the meaning as mentioned under formula (XIII), and to which the invention also relates.

Some of the intermediates which lead to the preparation of compounds of general formula (I) are novel.

Therefore, the invention also relates to compounds of general formula (Xb): 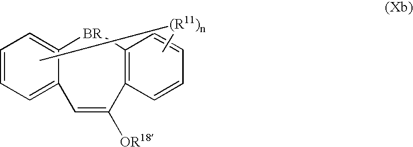
in which
BR represents C═O, CH—OH or DH-LG, wherein LG has the meaning as stated under formula (XIII); and
n represents 0 or 1;
R¹¹ has the meaning and preferential ranges as stated under general formula (V); and
R^{18*} represents a chiral C₅-C₁₈ arylalkyl residue.

(1.4) Reaction of compounds of general formula (XIII) with primary amines of general formula (XIV)
H₂NR³ (XIV)
in which R³ has the meaning as stated under general formula (I) (see, for example, I. Liedtke, S. Loss and H. GrUtzmacher, Tetrahedron (symposium in print) 2000, 56, 143), followed by

(1.5) reaction with halophosphanes of general formula (XII)
Hal¹-PR¹R² (XII)
in which
Hal¹ represents chlorine or bromine; and
PR¹R² or R¹ and R² have the meanings as stated under general formula (I);
yields compounds of general formula (I) in which D represents NR³.

The halophosphanes of general formula (I) are commercially available or can be synthesized according to literature methods or by analogy therewith.

(1.6) Further, for example, the compounds of general formula (XIII) can be reacted first with ammonia, primary or secondary amines, preferably secondary amines to form compounds of general formula (XVI) 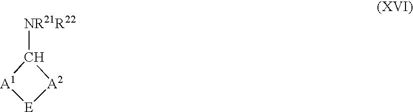
in which A¹, A² and E have the meanings and preferential ranges as stated under general formula (I); and
R²¹ and R²² independently represent hydrogen, C₁-C₁₈ alkyl, C₄-C₂₄ aryl or C₅-C₂₅ arylalkyl, or NR²¹R²² as a whole represents a five- to seven-membered cyclic amino residue having a total of 5 to 24 carbon atoms.

Optionally, the compounds of general formula (XVI) can be further varied in their substitution patterns by well-known methods for conversion of introduction of new substituents. In particular, in this stage, for example, when secondary amines are used, halogen atoms on A1, A2 and/or E can be converted to residues containing keto groups or formyl groups (carbonylations), for example, by palladium or nickel catalysis. Further, for the variation of the ligand pattern, reactions with copper reagents may also be used in this stage.

(1.7) According to the invention, compounds of general formula (XVI) can be reacted with phosphines of general formula (XV) in the presence of acids.

In a preferred embodiment of the method according to the invention, for example, the procedure involves providing the phosphine of general formula (XV) and the amine of general formula (XVI), optionally dissolved in a solvent, and adding acid.

In a particularly preferred embodiment, a carboxylic acid which is liquid at room temperature, such as acetic acid, serves itself as a solvent.

The temperature of the method according to the invention may be, for example, from 20 to 120° C., preferably from 40 to 110° C., more preferably from 60 to 100° C. The duration of the reaction may be, for example, from one minute to 24 h.

(2.1) The compounds of general formula (I) in which B represents CH and D is absent may also be prepared, for example, by deprotonating compounds of general formula (XVII) 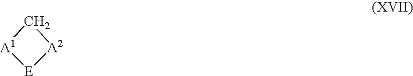
in which
A¹, A² and E have the meanings and preferential ranges as stated under general formula (I) and are not irreversibly changed by strong bases, by means of strong bases followed by reaction with halophosphanes of general formula (XII). Strong bases preferably include amides, such as sodium diisopropylamide and potassium diisopropylamide, or basic mixtures, such as potassium tert-butanolate/lithium diisopropylamide.

For further variation of the substitution pattern, the compounds of general formula (I) themselves may also be transformed by per se known methods. Thus, for example, bromine or iodine substituents on A¹, A² and/or E can be metalated (magnesium or organolithium compounds) and then converted to carboxylic acid salts using carbon dioxide. Further known possibilities are summarized, for example, in J. March Advanced Organic Chemistry 4th Edition, Wiley & Sons.

(3.1) Compounds of general formula (I) in which B represents nitrogen are obtained, for example, by reacting compounds of general formula (XVIII) 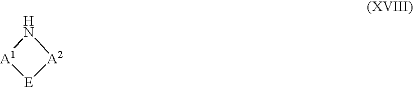
in which
A¹, A² and E have the meanings and preferential ranges as stated under general formula (I) with chlorophosphanes of general formula (XII) in the presence of bases or preferably after deprotonation with strong bases. Suitable strong bases include, for example, hydrides, amides and organometallic compounds, such as sodium hydride, n-butyllithium, tert-butyllithium, lithium diisopropylamide, potassium diisopropylamide, sodium diisopropylamide or basic mixtures, such as potassium tert-butanolate/n-butyllithium or potassium tert-butanolate/lithium diisopropylamide.

The chiral compounds of general formula (I) are suitable, in particular, for use in catalytic processes.

In asymmetric catalytic processes, the chiral compounds of general formula (I) are preferably employed in a stereoisomer-enriched form.

If, for example, enantiomerically pure chiral amines of general formula (XIV) and/or enantiomerically pure secondary phosphines of general formula (XV) are employed for the synthesis of compounds of general formula (I), the following cases are to be distinguished, for example:

1) If compounds are employed in which A¹-E-A², preferably E, has a mirror plane orthogonal to the carbon-carbon bond which connects the two vicinal -yl- residues, then the compounds of general formula (I) are obtained already in a stereoisomerically pure form.
2) If compounds are employed in which A¹-E-A², preferably E, has not a mirror plane orthogonal to the carbon-carbon bond which connects the two vicinal -yl- residues, then the compounds of general formula (I) are obtained as mixtures of diastereomers because in this case a new stereogenic center is produced, for example, in the reduction of the ketones of general formula (X). Such mixtures of diastereomers can be separated in a per se known manner, for example, by crystallization with an enantiomerically pure chiral auxiliary. Further, chromatographic separation is possible; for oxidation-sensitive phosphorus compounds, it is preferably performed after conversion to an adduct with boranes.

If no chiral amines of general formula (XIV) and no chiral phosphines of general formula (XV) are employed for the synthesis of compounds of general formula (I), then A¹-E-A² should not possess a mirror plane orthogonal to the carbon-carbon bond which connects the vicinal -yl- residues in accordance with the conditions mentioned above under the formula for compounds of general formula (I).

The following cases are to be distinguished, for example:

3) If A¹-E-A², preferably E, itself has at least one stereo center, then mixtures of diastereomers are obtained in the synthesis of compounds of general formula (I), which may optionally be separated as described above.

If A¹-E-A², preferably E, does not itself have a stereo center in the synthesis variants described, pairs of enantiomers are obtained which can preferably be converted, for example, to diastereomeric adducts with boranes after reaction with a chiral borane. These may then be separated, for example, by chromatography (see, for example, Petterson, Schill, J. Chromatogr. 1981, 204, 179; Helmchen, Nill, Angew. Chem. Int. Edit. 1979, 18, 65).

The compounds of general formula (I) can be obtained in a stereoisomer-enriched form in the way described.

Since the separation of stereoisomeric compounds of general formula (I) is advantageously effected via their adducts with boranes (see, for example, Kaloun, Jugé et al., J. Organomet. Chem. 1997, 529, 455), the invention also relates to adducts of compounds of general formula (I) with boranes, wherein several adducts with boranes in one molecule may also be present in the presence of more than one phosphorus atom or nitrogen atom.

For example and preferably, the following may be mentioned as achiral boranes: borane, borabicyclononane (BBN-9), borane being preferred.

For example and preferably, the following may be mentioned as chiral boranes: tetrahydropyrrolo[1,2-c][1,3,2]oxazaborol, 1-methyltetrahydropyrrolo[1,2-c]-[1,3,2]oxazaborol, 4-isopropyl-3-(toluene-4-sulfonyl)[1,3,2]oxazaborolidin-5-one, 2,6,6-trimethylbicyclo[3.1.1]hept-3-ylborane, isopinocampheylborane, bis-(2,6,6-trimethylbicyclo[3.1.1]hept-3-yl)borane and diisopinocampheylborane.

The use of boranes may be, for example, in the form of borane adducts to sulfur compounds. For borane, borane dimethylsulfide may be mentioned as an example.

After the separation has been effected, the free compounds of general formula (I) can be prepared from the adducts of boranes, for example, by reaction with amines, for example, triethylamine or morpholine.

Surprisingly, compounds in which E represents El are not or but slightly hydroborinated.

Alternatively, the separation of stereoisomeric compounds of general formula (I) may also be effected by either converting the compounds of general formula (I) to the corresponding phosphane oxides, or by synthesizing the latter directly by per se known methods.

For example, the oxidation can be effected by a reaction in the presence of oxygen or oxygen-releasing substances, such as peroxides. Subsequently, the oxides can be separated into the stereoisomers in a per se known manner by fractional crystallization in the presence of chiral auxiliaries, such as tartaric acid derivatives.

The reduction of phosphane oxides to the phosphanes of formula (I) can be effected in a per se known manner, for example, in the presence of silanes.

Therefore, the invention further comprises phosphane oxides of formula (Ia) 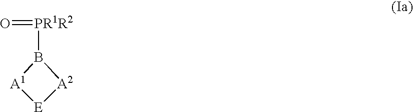
in which R¹, R², B, E, A¹ and A² have the same meanings including the preferential ranges mentioned, and the compounds of formula (Ia) must meet the same conditions as mentioned under formula (I).

As an example of the syntheses of compounds of general formula (I) followed by separation of the stereoisomers, there may be mentioned the reaction sequence which yields the diastereomerically pure compounds [(5S)-10-[(−)-menthyloxy]-5H-dibenzo[a,d]cyclohepten-5-yl]diphenylphosphane and [(5R)-10-[(−)-menthyloxy]-5H-dibenzo[a,d]cyclohepten-5-yl]diphenylphosphane:

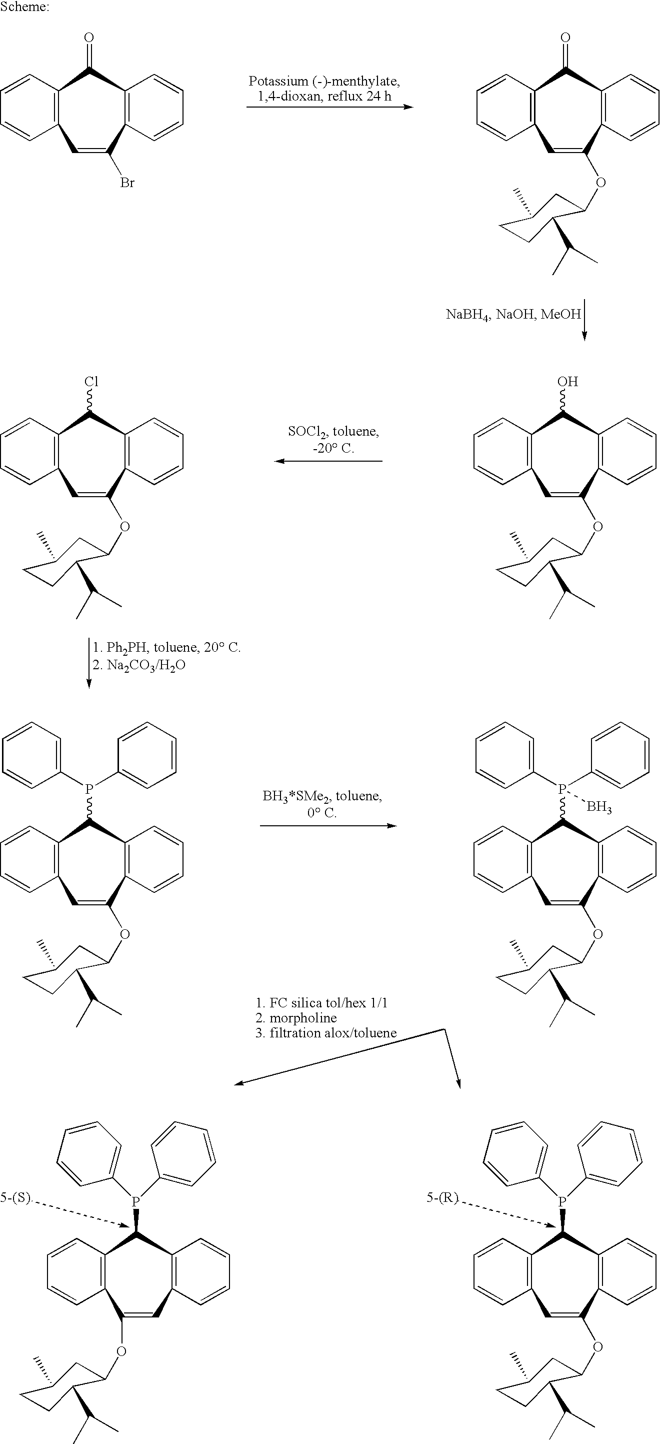

It may be noted here that the invention also includes any combinations of the preferential ranges mentioned in the following.

For the preparation of compounds of general formula (I), especially those in which R¹ and R² are different, compounds of general formula (XIX) are also suitable, in particular: 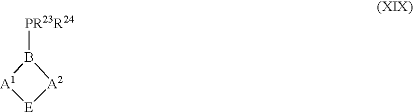
wherein
A¹, A², B and E have the meanings and preferential ranges as stated under general formula (I), and R²³ and R²⁴ independently represent a residue selected from the group consisting of halogen or NR²⁵R²⁶ in which R²⁵ and R²⁶ independently represent C₁-C₆ alkyl, or NR²⁵R²⁶ together represents a five- or six-membered cyclic amino residue.

Preferably, halogen represents chlorine, and NR²⁵R²⁶ preferably represents dimethylamino, diethylamino or diisopropylamino.

Examples of compounds of general formula (XIX) include:
5-Bis(diethylamino)phosphanyl-5H-dibenzo[a,d]cycloheptene, (troppNEt²), 5-bis(dimethylamino)phosphanyl-5H-dibenzo[a,d]cycloheptene, (tropp^{NMe2}), 5-bis(dimethylamino)phosphanyl-10,11-dihydro-5H-dibenzo[a,d]cycloheptene, (H₂tropp^{NMe2}), 5-chlorodimethylaminophosphanyl-10,11-dihydro-5H-dibenzo-[a,d]cycloheptene (H₂tropp^{Cl,NMe2}), 5-bis(diethylamino)phosphanyl-5H-dibenzo-[b,f]azepine (H₂tropnp^{NMe2}), 5-(bischlorophosphanyl-10/11-dihydro-5H-dibenzo-[a,d]cycloheptene (H₂tropp^{Cl}) and 5-(bischlorophosphanyl-5H-dibenzo[a,d]cycloheptene (tropp^{Cl}).

For example, by analogy with (1.3), the compounds are prepared from compounds of general formula (XIII) and phosphines of general formula (XX)
Act-PR²³R²⁴ (XX)
in which
Act represents tri(C₁-C₆)alkylsilyl or hydrogen, preferably trimethylsilyl or hydrogen, and R²³ and R²⁴ have the meaning as stated under general formula (XIX).

Further, the compounds may be obtained by analogy with (2.1) or (3.1) from compounds of general formulas (XVII) or (XVIII) by deprotonation followed by reaction with halophosphines of general formula (XXI):
(Hal²)_{q}-P-(N(C₁l-C₆-alkyl)₂)_{3-q} (XXI)
in which
Hal² represents halogen, preferably chlorine; and
q represents zero, one, two or three.

Further, the compounds of general formula (XIX) can be obtained by per se known disproportionation reactions of compounds of general formula (XIX) with halophosphines of general formula (XXI).

The reaction of compounds of general formula (XIX) to form compounds of general formula (I) may be effected, for example, in accordance with Kaloun, Jugé et al., J. Organomet. Chem. 1997, 529, 455.

The invention also relates to the compounds of general formula (XIX).

The stereoisomer-enriched compounds of general formula (I) are suitable, in particular, for use in catalytic processes.

The invention also relates to a process for preparing stereoisomer-enriched chiral compounds which is characterized by being performed in the presence of compounds of general formula (I).

Suitable catalysts for use in catalytic processes include those, in particular, which contain isolated transition metal complexes of compounds of general formula (I).

Suitable catalysts further include those which contain transition metal complexes produced in the reaction medium from transition metal compounds and the compounds of general formula (I).

Suitable catalysts for use in asymmetric catalytic processes include those, in particular, which contain isolated transition metal complexes of the stereoisomer-enriched compounds of general formula (I), and further those which contain transition metal complexes produced in the reaction medium from transition metal compounds and stereoisomer-enriched compounds of general formula (I).

The invention also relates to the catalysts mentioned.

The invention also relates to isolated transition metal complexes containing compounds of general formula (I), except for the complexes described by Deblon et al. (New J. Chem., 2001, 25, 83-91) for electrochemical examinations. These include, in particular, the complexes [Rh(^{Me}tropp^{Ph})Cl]₂, [Rh(^{Me}tropp^{Ph})₂PF₆ and [Rh(^{Me}tropp^{Ph})(^{allyl}tropp^{Ph})].

Further, the invention also relates to transition metal complexes obtainable by reaction of a transition metal compound with compounds of general formula (I).

The complexes described may optionally be in the form of isomers, such as cis/trans isomers, coordination isomers or solvatation isomers. The invention also relates to such isomers.

Preferred are isolated transition metal complexes containing stereoisomer-enriched compounds of general formula (I) and transition metal complexes obtainable by reacting a transition metal compound with stereoisomer-enriched compounds of general formula (I).

Preferred isolated transition metal complexes are those which contain at least one transition metal selected from the group consisting of cobalt, rhodium, iridium, nickel, palladium, platinum, copper, osmium and ruthenium, and at least one compound of general formula (I), or transition metal complexes obtainable by reacting a transition metal compound containing a transition metal selected from the group consisting of cobalt, rhodium, iridium, nickel, palladium, platinum, copper, osmium and ruthenium with stereoisomer-enriched compounds of general formula (I).

Preferred transition metals are selected from the group consisting of rhodium, iridium, nickel, palladium and ruthenium, more preferred transition metals are selected from the group consisting of iridium, palladium and ruthenium, wherein iridium, especially in the oxidation stage one, is even more preferred.

The same applies, mutatis mutandis, to transition metal compounds.

Particularly preferred isolated transition metal complexes include those in which the molar ratio of metal to compounds of general formula (I), preferably stereoisomer-enriched ones, is one to one.

For example and preferably, suitable transition metal compounds from which complexes are produced with compounds of general formula (I), preferably stereoisomer-enriched compounds of general formula (I), in the reaction medium include those of general formula
M²(Y¹)ₚ (XXIIa)
in which
M² represents ruthenium, rhodium, iridium, nickel, palladium, platinum or copper; and
Y¹ represents chloride, bromide, acetate, nitrate, methanesulfonate, trifluoromethanesulfonate, allyl, methallyl or acetylacetonate; and
p represents 3 for ruthenium, rhodium and iridium, 2 for nickel, palladium and platinum, and 1 for copper;
   or metal compounds of general formula (XXIIb)
   M³(Y²)ₚB¹₂ (XXIIb)
   in which
M³ represents ruthenium, rhodium, iridium, nickel, palladium, platinum or copper; and
Y² represents chloride, bromide, acetate, methanesulfonate, trifluoromethane-sulfonate, tetrafluoroborate, hexafluorophosphate, perchlorate, hexafluoroantimonate, tetrakis[3,5-bis(trifluoromethyl)phenyl]borate; and
p represents 1 for rhodium and iridium, 2 for nickel, palladium, platinum and ruthenium, and 1 for copper;
each B¹ represents a C₂-C₁₂ alkene, such as ethylene or cyclooctene, or a nitrile, such as acetonitrile, benzonitrile or benzylnitrile; or
B¹₂ together represent a (C₄-C₁₂) diene, such as norbornadiene or 1,5-cyclooctadiene;
   or metal compounds of general formula (XXIIc)
   [M⁴B²Y¹₂]₂ (XXIIc)
   in which
M⁴ represents ruthenium; and
B² represents aryl residues, such as cymyl, mesityl, phenyl or cyclooctadiene, norbornadiene or methylallyl;
   or metal compounds of general formula (XXIId)
   M⁵ₚ[M⁶(Y³)₄] (XXIId)
   in which
M⁶ represents palladium, nickel, iridium or rhodium; and
Y³ represents chloride or bromide; and
M⁵ represents lithium, sodium, potassium, ammonium or organic ammonium; and
p represents 3 for rhodium and iridium, and 2 for nickel, palladium and platinum;
   or metal compounds of general formula (XXIIe)
   [M⁷(B³)₂]An (XIIIe)
   in which
M⁷ represents iridium or rhodium; and
B³ represents a (C₄-C₁₂) diene, for example, norbornadiene or 1,5-cyclooctadiene; and
An represents a non-coordinating or weakly coordinating anion, such as methanesulfonate, trifluoromethanesulfonate (Otf, OTf), tetrafluoroborate, hexafluorophosphate, perchlorate, hexafluoroantimonate, tetrakis[3,5-bis-(trifluoromethyl)phenyl]borane, tetraphenylborate or a closo-boranate or a carboboranate.

In addition, suitable transition metal compounds include, for example, Ni(1,5-cyclooctadiene)₂, Pd₂(dibenzylideneacetone)₃, Pt(norbornene)₃, Ir(pyridine)₂(1,5-cyclooctadiene), [Cu(CH₃CN)₄]BF₄ and [Cu(CH₃CN)₄]PF₆ or polynuclear bridged complexes, such as [Rh(1,5-cyclooctadiene)Cl]₂ and [Rh(1,5-cyclooctadiene)Br]₂, [Rh(ethene)₂C]₂, [Rh(cyclooctene)₂Cl]₂.

Preferably employed metal compounds include:
[Rh(cod)CI]₂, [Rh(cod)₂Br], [Rh(cod)₂]ClO₄, [Rh(cod)₂]BF₄, [Rh(cod)₂]PF₆, [Rh(cod)₂]OTf, [Rh(cod)₂]BAr₄ (Ar=3,5-bis(trifluoromethyl)phenyl) [Rh(cod)₂]SbF₆, RuCl₂(cod), [(cymene)RuCl₂]₂, [(benzene)RuCl₂]₂, [(mesityl)RuCl₂]₂, [(cymene)RuBr₂]₂, [(cymene)RuI₂]₂, [(cymene)Ru(BF₄)₂]₂, [(cymene)Ru(PF₆)₂]₂, [(cymene)Ru(BAr₄)₂]₂, (Ar =3,5-bis(trifluoromethyl)-phenyl), [(cymene)Ru(SbF₆)₂]₂, [Ir(cod)Cl]₂, [Ir(cod)₂]PF₅, [Ir(cod)₂]ClO₄, [Ir(cod)₂]SbF₆, [Ir(cod)₂]BF₄ [Ir(cod)₂]OTf, [Ir(cod)₂]BAr₄ (Ar=3,5-bis(trifluoromethyl)phenyl), RuCl₃, NiCl₂, IrCl₃, RhCl₃, PdCl₂, PdBr₂, Pd(OAc)₂, Pd₂(dibenzylideneacetone)₃, Pd(acetylacetonate)₂, CuOTf, CuI, CuCl, Cu(OTf)₂, CuBr, CuI, CuBr₂, [Rh(nbd)Cl]₂ (nbd=norbornadiene), [Rh(nbd)₂Br], [Rh(nbd)₂]ClO₄, [Rh(nbd)₂]BF₄, [Rh(nbd)₂]PF₅, [Rh(nbd)₂]OTf, [Rh(nbd)₂]BAr₄ (Ar=3,5-bis-(trifluoromethyl)phenyl), [Rh(nbd)₂]SbF₆, RuCl₂(nbd), [Ir(nbd)₂]PF₆, [Ir(nbd)₂]ClO₄, [Ir(nbd)₂]SbF₆, [Ir(nbd)₂]BF₄, [Ir(nbd)₂]OTf, [Ir(nbd)₂]BAr₄ (Ar=3,5-bis(trifluoromethyl)phenyl), Ir(pyridine)₂(nbd), [Ru(DMSO)₄Cl₂], [Ru(CH₃CN)₄Cl₂], [Ru(PhCN)₄Cl₂], [Ru(cod)Cl₂]n, [Ru(acetylacetonate)₃], [Ru(cod)(acetylacetonate)₂].

The molar content of the transition metal in the transition metal compound employed may be, for example, from 50 to 200 mole percent, based on the (stereoisomer-enriched) compound of general formula (I) employed, preferably from 90 to 150 mole percent, more preferably from 95 to 110 mole percent and even more preferably from 95 to 105 mole percent.

The catalysts which contain either isolated transition metal complexes of the compounds of general formula (I), preferably stereoisomer-enriched compounds of general formula (I), or those transition metal complexes which are produced in the reaction medium from transition metal compounds and the compounds of general formula (I), preferably stereoisomer-enriched compounds of general formula (I), are particularly suitable for use in a process for preparing chiral compounds, preferably stereoisomer-enriched compounds.

Preferably, the catalysts according to the invention are employed for 1,4-additions, carbon-carbon coupling reactions, hydrosilylations and hydrogenations, more preferably for carbon-carbon coupling reactions and hydrogenations, even more preferably for asymmetric hydrogenations.

The term “hydrogenations” means reactions in which hydrogen is transferred to a substrate. This can be effected either by hydrogen itself (actual hydrogenations) or hydrogen-transferring systems, such as hydrazine, formic acid/amine mixtures or isopropanol (transfer hydrogenations).

Preferred asymmetric hydrogenations include, for example, hydrogenations of prochiral C═C bonds, such as prochiral olefins, enamines and enamides, and C═N bonds, such as prochiral imines. Particularly preferred asymmetric hydrogenations include hydrogenations of prochiral enamines, enamides and imines.

Particularly surprisingly, it has been found that suitable catalysts for the hydrogenation of enamines, enamides and imines are those catalysts which are produced in the reaction medium from an iridium compound and a compound of general formula (XXIII). 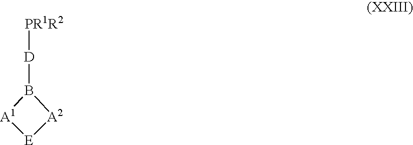
in which
A¹, A², B and E have the meanings and preferential ranges as stated under general formula (I), but none of the conditions mentioned there needs to be met. Ther

efore, the invention also relates to the novel non-chiral phosphorus compounds N-diphenylphosphanyldibenzo[a,d]azepine (tropnp^{Ph}), 5-bis(2-methoxyphenyl)phosphanyl-5H-dibenzo[a,d]cycloheptene (tropp^{2-MeOPh}), 5-bis(2-pyridyl)-phosphanyl-5H-dibenzo[a,d]cycloheptene (tropp^{2-Py}), 3,7-difluoro-5-diphenyl-phosphanyl-5H-dibenzo[a,d]cycloheptene (_{F}tropp^{Ph}) and 3,7-diiodo-5-diphenyl-phosphanyl-5H-dibenzo[a,d]cycloheptene (_{I}tropp^{Ph}).

Further, suitable catalysts for the hydrogenation of enamines, enamides and imines are those which contain isolated iridium complexes comprising compounds of general formula (XXIII) in which E represents E² or those residues E¹ in which any substituents present are bonded to the double bond through an atom which bears hydrogen atoms, which leads to dehydrogenation reactions in the course of which the ligands are converted. In this way, for example, a 1,2-ethanediyl residue can be converted to a 1,2-ethenediyl residue with loss of hydrogen.

It is to be consider a surprising fact that the iridium-containing catalysts according to the invention are particularly suitable for the hydrogenation of enamides, enamines and imines. The hydrogenated enamides, enamines and, in particular, imines are valuable products in the preparation of agrochemicals and medicaments or their intermediates in a stereoisomer-enriched form.

Therefore, the invention also relates to a process for the hydrogenation of enamines, enamides and imines which is characterized by being performed in the presence of catalysts which contain isolated iridium complexes which contain phosphorus compounds of general formula (XXIII) according to the above definition, or by being performed in the presence of catalysts which contain iridium complexes produced in the reaction medium from an iridium compound and a compound of general formula (XXIII).

Suitable imines to be hydrogenated preferably include those of general formula (XXIV)
Ar—N═CR²⁷R²⁸
in which
Ar represents a C₄-C₂₄ aryl or C₅-C₂₅ arylalkyl with the above mentioned preferential ranges; and
R²⁷ and R²⁸ independently represent hydrogen, C₁-C₁₈ alkyl, C₄-C₂₄ aryl or C₅-C₂₅ arylalkyl, or CR²⁷R²⁸ together form a five- to seven-membered cyclic residue which may contain up to two further heteroatoms selected from the group consisting of oxygen or nitrogen and which may be further substituted like an alkyl residue according to the above definition.

Further, one of the residues R²³ or R²³ together with the residue Ar and the imine function may form a five- or six-membered N-heterobicyclic residue with a total of from 4 to 34 carbon atoms.

Prochiral imines which are to be subjected to asymmetric hydrogenation are preferably those of general formula (XXIV) in which the residues neither represent hydrogen nor are identical.

Examples of imines of general formula (XXIV) include:

Benzylideneaniline, phenyl(1-phenylethylidene)amine, benzyl(1-phenylethylidene)amine, benzylbenzylideneaniline, benzylidenephenylamine, (4-methoxy-benzylidene)phenylamine, (2-ethyl-6-methylphenyl)(2-methoxy-1-methylethylidene)amine, (2,6-dimethylphenyl)(2-methoxy-1-methylethylidene)amine, 7,8-difluoro-3-methyl-2H-benzo[1,4]oxazine, 6,7-dimethoxy-1-methyl-3,4,4a,8a-tetrahydroisoquinoline, 6,7-dimethoxy- 1-phenyl-3,4,4a,8a-tetrahydroisoquinoline, (6,7-dimethoxy-3,4,4a,8a-tetrahydroisoquinoline-1-yl)acetic acid ethyl ester, 1-(2-bromophenyl)-6,7-dimethoxy-3,4,4a,8a-tetrahydroisoquinoline, 1-(2-bromophenyl)-3,4,4a,8a-tetrahydroisoquinoline, 1-isopropyl-6,7-dimethoxy-3,4,4a,8a-tetrahydroisoquinoline, 1-cyclohexyl-6,7-dimethoxy-3,4,4a,8a-tetrahydroisoquinoline, 2,3,3-trimethyl-3a,7a-dihydro-3H-indole, 2-methyl-2,3-dihydroquinoxaline, 6-phenyl-2,3,4,5-tetrahydropyridine, 1-phenyl-4,9-dihydro-3H-b-carboline, 1-methyl-4,9-dihydro-3H-b-carboline, 4,9-dihydro-3H-b-carboline-1-carboxylic acid methyl ester, 4,9-dihydro-3H-b-carboline-1-carboxylic acid ethyl ester, (4,9-dihydro-3H-b-carboline-1-yl)acetic acid methyl ester, (4,9-dihydro-3H-b-carboline-1-yl)acetic acid ethyl ester, (4,9-dihydro-3H-b-carboline-1-yl)acetic acid ethyl ester, (4,9-dihydro-3H-b-carboline-1-yl)acetic acid methyl ester, 1-(3,5-bis(benzyloxy)-4-methoxybenzyl)-6-methoxy-3,4,4a,8a-tetrahydroisoquinoline.

Suitable enamides to be hydrogenated preferably include those of general formula (XXV): 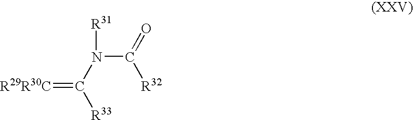
in which
R²⁹ and R³⁰ independently represent hydrogen, C₁-C₁₈ alkyl, C₅-C₂₄ aryl or C₆-C₂₅ arylalkyl, or CR²⁹R³⁰ together form a five- to seven-membered residue which contains up to two further heteroatoms selected from the group consisting of oxygen or nitrogen and may be further substituted like an alkyl residue according to the above definition;
R³⁰ represents hydrogen or C₁-C₁₆ alkyl; and
R³² represents C₁-C₁₈ alkyl, C₅-C₂₄ aryl or C₆-C₂₅ arylalkyl; and
R³² represents hydrogen, C₁-C₁₈ alkyl or residues of general formula (XXVI): 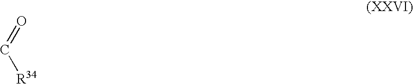
   in which
R³⁴ represents C₁-C₁₈ alkoxy, C₅-C₂₄ aryloxy or C₆-C₂₅ arylalkoxy or amino, C₁-C₆ alkylamino or di(C₁-C₆ alkyl)amino.

Prochiral enamides which are to be subjected to asymmetric hydrogenation are more preferably those of general formula (XXV) in which one of the two residues R²⁹ and R³⁰ represents hydrogen, and R³⁴ represents a residue of general formula (XXVI).

Examples of enamides of general formula (XXV) include N-(1-phenylethylidene)-acetamide and N-(1-phenylvinyl)acetamide.

Suitable catalysts for the asymmetric hydrogenation of enamines, enamides and imines include those, in particular, which contain isolated iridium complexes which in turn contain stereoisomer-enriched compounds of general formula (I) in which E represents E¹ with the above mentioned exceptions, or those catalysts which contain iridium complexes produced in the reaction medium from an iridium compound and a stereoisomer-enriched compound of general formula (I).

The iridium complexes described may optionally be in the form of isomers, such as cis/trans isomers, coordination isomers or solvatation isomers. The invention also relates to such isomers.

For example, preferred isolated iridium complexes include those of general formula (XXVIIa)
[Ir(XXIII)(L¹)₂]An (XXVIIa)
in which
(XXIII) represents a compound of general formula (XXIII) in which E represents E¹ with the above mentioned exceptions; and
each L¹ represents an olefin ligand; or
(L¹)₂ as a whole represents a diolefin ligand; and
An represents the anion of an oxy acid or a complex acid.

For example and preferably, L¹ represents cyclooctene, norbornene, cyclohexene or ethene, and (L¹)₂ represents 1,5-cyclooctadiene, norbornadiene or butadiene.

For example and preferably, anions of an oxy acid or a complex acid include perchlorate, hydrogensulfate, tetrafluoroborate, hexafluorophosphate, hexafluoroarsenate, hexafluoroantimonate and tetraphenylborate.

Further, suitable isolated iridium complexes include, for example, those of general formula (XXVIIIa)
[Ir(XXIII)(L²)ₓ]An (XXVIIIa)
in which
(XXIII) represents compounds of general formula (XXIII) in which E represents E¹ with the above mentioned exceptions; and
L² represents a coordinated solvent molecule, such as a nitrile or ether; and
x represents one, two or three, preferably one or two.

For example and preferably, L² represents acetonitrile, benzonitrile or tetrahydrofuran.

Preferred isolated complexes for asymmetric hydrogenations include those of general formulas (XXVIIb) and (XXVIIIb):
[Ir(I)(L¹)₂]An (XXVIIb)
[Ir(I)(L²)ₓ]An (XXVIIIb)
in which
(I) represents stereoisomer-enriched compounds of general formula (I) in which E represents an unsubstituted, mono- or disubstituted vicinal cis-alkenediyl residue, and L¹, L² and x as well as An have the meanings as stated in general formulas (XXVIIa) and (XXVIIIa).

As examples of isolated iridium complexes of general formula (XXVIIa), there may be mentioned:
[Ir(cod)(tropnp^{Ph})]Otf, [Ir(cod)(_{Me2NO2S}tropp^{Ph})]Otf, [Ir(cod)(tropp^{Ph})]Otf, [Ir(^{F}tropp^{Ph})(cod)]Otf.

In addition, as examples of isolated iridium complexes of general formula (XXVIIa) which are also covered by formula (XXVIIb), there may be mentioned:
[Ir(cod)((R)-tropp^{Ph,Et-2-Py})]otf, [Ir(cod)((S)-tropp^{Ph,Et-2-Py})]otf, [Ir(cod)((R)-tropp^{Cyc,Et-2-Py})]Otf, [Ir(cod)((R)-tropp^{Cyc,Et-2-Py})]PF₆, [Ir(cod)((S)-tropp^{Cyc,Et-2-Py})]Otf, [Ir(cod)((R)-tropp^{Ph,Et-N-Pyrro})]Otf, [Ir(cod)((S)-tropp^{Ph,Et-N-Pyrro})]Otf, [Ir(cod)((R)-tropp^{Cyc,Et-N-Pyrro})]Otf, Ir(cod)((S)-tropp^{Cyc,Et-N-Pyrro})]Otf, [Ir(cod)-(R,R)-tropphos^{Me})]Otf, [Ir(cod)(S,S)-tropphos^{Me})]Otf, [Ir((R)-^{menthyloxy}tropp^{Ph})(cod)]PF₆, [Ir((S)-^{menthyloxy}tropp^{Ph})(cod)]PF₆, [Ir((R)-^{Ph}tropp^{Ph})(cod)]Otf, [Ir((S)-^{Ph}tropp^{Ph})-(cod)]Otf, [Ir(cod)((R)-^{menthyloxy}tropp^{Ph})]Otf, [Ir(cod)((S)-^{menthyloxy}tropp^{Ph})]Otf, [Ir(cod)((R)-^{methoxy}tropp^{Cyc})]Otf, [Ir(cod)((S)-^{methoxy}tropp^{Cyc})]Otf, [Ir(cod)((R)-^{methoxy}tropp^{Ph})]Otf, [Ir(cod)((S)-^{methoxy}tropp^{Ph})]Otf, [Ir(cod)((R)-tropp^{IPrCH2P(iPr)2})]-Otf, [Ir(cod)((S)-tropp^{IPrCH2P(iPr)2})]Otf.

As examples of isolated iridium complexes of general formula (XXVIIIa) which are also covered by formula (XXVIIIb), there may be mentioned:

[Ir((R)-tropp^{Ph(CH2)4PPh2} )(CH₃CN)]Otf, [Ir((S)-tropp^{Ph(CH2)4PPh2})(CH₃CN)]Otf, [Ir((R)-tropp^{Ph(CH2)3PPh2})(CH₃CN)₂]Otf and [Ir((S)-tropp^{Ph(CH2)3PPh2})(CH₃CN)₂]Otf.

Particularly preferred isolated iridium complexes of general formula (XXVIIb) are [Ir(cod)(R,R)-tropphos^{Me})]Otf, [Ir((R)-^{menthyloxy}tropp^{Ph})(cod)]PF₆, [Ir((S)-^{menthyloxy}-tropp^{Ph})(cod)]PF₆ [Ir((R)-^{menthyloxy}tropp^{Ph})(cod)]Otf and [Ir((S)-^{menthyloxy}tropp^{Ph}) (cod)]Otf.

When iridium complexes are produced in the reaction solution, for example and preferably, the following iridium compounds are used:
[Ir(cod)Cl]₂, [Ir(cod)₂]PF₆, [Ir(cod)₂]CI0₄, [Ir(cod)₂]SbF₆ [Ir(cod)₂]BF₄, [Ir(cod)₂]OTf, [Ir(cod)₂]BAr₄ (Ar=3,5-bis(trifluoromethyl)phenyl), IrCl₃, [Ir(nbd)₂]PF₆, [Ir(nbd)₂]ClO₄, [Ir(nbd)₂]SbF₆, [Ir(nbd)₂]BF₄, [Ir(nbd)₂]OTf, [Ir(nbd)₂]BAr₄ (Ar=3,5-bis(trifluoromethyl)phenyl), Ir(pyridine)₂(nbd).

The same applies, mutatis mutandis, to the production of iridium complexes which are produced in the reaction medium from an iridium compound and a compound of general formula (I) or a stereoisomer-enriched compound of general formula (I).

In a preferred embodiment of the process according to the invention, the isolated iridium complexes are provided, optionally together with a solvent, and set under hydrogen after the substrate has been added.

Alternatively, a procedure may be employed in which the iridium compound is provided in a solvent, and the compounds of general formula (XXIII) are added. Subsequently, the reaction mixture can be set under hydrogen pressure after the substrate has been added.

Suitable solvents include, for example:

Ethers, such as diethyl ether, tetrahydrofuran, dioxan, methyl tert-butyl ether, esters, such as acetic acid ethyl ester, amides, such as dimethylformamide, N-methylpyrrolidone, aliphatic or araliphatic solvents with up to 16 carbon atoms, such as toluene, o-, m-, p-xylene, hexane and cyclohexane, halogenated aliphatic or araliphatic solvents, such as chloroform, dichloromethane, chlorobenzene, the isomeric dichlorobenzenes, fluorobenzene, carboxylic acids, such as acetic acid, alcohols, such as methanol, ethanol, isopropanol and tert-butanol, or mixtures thereof.

Preferred solvents include halogenated aliphatic or araliphatic solvents.

Particularly preferred are chloroform, dichloromethane and chlorobenzene, or mixtures thereof.

In a further embodiment, the reaction may also be performed without solvents, i.e., in substrates which are liquid at the reaction temperature.

The temperature in the hydrogenation may be, for example, from 0 to 200° C., preferably from 20 to 100° C., more preferably from 20 to 80° C.

In the hydrogenation, the hydrogen partial pressure may be, for example, from 0.1 to 200 bar, preferably from 1 to 100 bar, more preferably from 5 to 100 bar, and even more preferably from 5 to 50 bar.

The molar amount of iridium from the iridium compound employed or of the isolated iridium complex employed may be, for example, from 0.001 to 4 mole percent, based on the substrate employed, preferably from 0.001 to 4 mole percent, more preferably from 0.01 to 1 mole percent and even more preferably from 0.01 to 0.1 mole percent.

In all embodiments, the molar ratio of halides selected from the group consisting of chloride, bromide and iodide to iridium is preferably from 0 to 1, more preferably from 0 to 0.5, and even more preferably from 0 to 0.1.

The invention is characterized in that a broadly and easily variable ligand system is provided which enables high conversions and conversion rates in catalytic processes. Further, high stereoisomeric excesses can be achieved in asymmetric catalytic processes, especially hydrogenations on iridium complexes.

### EXAMPLES

General Remarks

The starting substances used in the following are commercially available or were synthesized according to the following literature protocols:

Di(2-methoxyphenyl)phosphane [1]; di(2-pyridyl)phosphane [2]; bis(diethylamino)chlorophosphane [3]; phenyl-2-(2-pyridyl)ethylphosphane [4]; dicyclohexylphosphanyl-5H-dibenzo[a,d]cycloheptene [5]; 5-diphenylphosphanyl-5H-dibenzo[a,d]cycloheptene [5]; phenyl-R,R-2,5-dimethylphospholane [6-8]; diisopropyl[(isopropylphosphino)methyl]phosphane [9]; (3-chloropropyl)diphenylphosphane [10]; (2R,4S,5R)-2-chloro-3,4-dimethyl-5-phenyl-1,3,2-oxazaphospholidine [11]; (Rₚ)-chloromethylphenylphosphane*borane [12]; (1,1′-binaphthalene-2,2′-dioxy)chlorophosphane [13].

2-(2-Chloroethyl)pyridine [4]; N-(2-chloroethyl)pyrrolidine [14]; 5-chloro-5H-dibenzo[a,d]cycloheptene [15]; 5H-dibenzo[a,d]cycloheptane [16]; 3,7-diiodo-10,11-dihydro-5H-dibenzo[a,d]cyclohepten-5-one [17]; 10-bromo-5H-dibenzo-[a,d]cycloheptene [18]; 10-cyano-5H-dibenzo[a,d]cycloheptene [19]; 3,7-difluoro-5H-dibenzo[a,d]cyclohepten-5-one.

[Rh(cod)₂]PF₆ (21); [Ir(cod)₂]OTf [21].

[1] a) J. van Doorn, N. Meijboom, Recl. Trav. Chim. Pays-Bas, 1992, 111, 170-177

b) P. Budzelaar, J. A. van Doorn, N. Meijboom, Recl. Trav. Chim. Pays-Bas, 1991, 110, 420-432

[2] Steiner, D. Stalke, J. Chem. Soc. Chem. Commun., 1993, 444-445

[3] R. B. King, P. M. Sudaram, J. Org. Chem., 1984, 49, 1784-1789

[4] G. U. Spiegel, O. Stelzer, Z. Naturforsch. B, 1987, 42, 579-588

[5] J. Thomaier, Dissertation, Universität Freiburg, 1996

[6] (a). Lieser, Synth. Commun., 1983, 13, 76;

(b) S. Otten, R. Fröhlich, G. Haufe, Tetrahedron Asymmetry, 1998, 9, 189

[7] K. Julienne, P. Metzner, J. Org. Chem., 1998, 63, 4532

[8] (a) S. Wilson, A. Pasternak, Synthetic Letters, 1990, 199; (b) M.

Burk, J. Feaster, R. Harlow, Tetrahedron Asymmetry, 1991, 2, 569;

[9] S. Hietkamp, H. Sommer, O. Stelzer, Chem. Ber. 1984, 117, 3400

[10] Arpac, L. Dahlenburg, Z. Natufforsch. B. 1980, 35, 146.

[11] Nielsen, O. Dahl, J. Chem. Soc. Perkin Trans. 2 1984, 3, 553

[12] E. B. Kaloun, R. Merdès, J. -P. Genêt, J. Uziel, S. Jugé, J. Organomet. Chem. 1997, 529, 455.

[13] K. Nozaki, N. Sakai, T. Nanno, T. Higashijima, S. Mano, T. Horiuchi, T. H., J. Am. Chem. Soc. 1997, 119, 4413.

[14] Tilford, J. Am. Chem. Soc., 1948, 70, 4001

[15] Berti, Gazz. Chim. Ital. 1957, 87, 293, 305

[16] A. Ceccon, A. Gambaro, A. Venzo, J. Organomet. Chem., 1984, 275, 209-222

[17] L. Le\check{s}eticky, S. Smrèek, V. Sváta, J. Podlahova, J. Podlaha, I. Císaøová, Collect. Czech. Chem. Commun., 1990, 55, 2677-2684

[18] G. N. Walker, A. R. Engle, J. Org. Chem., 1972, 37, 4294-4302

[19] G. N. Walker, J. Org. Chem., 1971, 36, 466

[20] W. Thompson, J. Med. Chem., 1990, 33, 789-808

[21] T. Schenck, J. Downes, C. Milne, P. Mackenzie, H. Boucher, J. Whelan, B. Bosnich, Inorg. Chem., 1985, 24, 2334-2337

General Working Protocols

(I) General Working Protocol for the Reduction of Substituted 5H-dibenzo[a,d]cyclohepten-5-ones to the Corresponding Alcohols

To a suspension of the respective ketone (10 mmol) in 150 ml of methanol, a solution of sodium borohydride (190 mg, 5 mmol) and potassium hydroxide (280 mg, 5 mmol) in 2 ml of distilled water is added at once, a slight evolution of heat being observed in most cases. After stirring over night, the solvent is removed under reduced pressure, and the residue is taken up in 100 ml of water and 200 ml of dichloromethane. The organic phase is separated, dried over sodium sulfate and concentrated to dryness. The pale yellow raw product is recrystallized from a suitable solvent.

(II) General Working Protocol for the Synthesis of Substituted 5-chloro-5H-dibenzo[a,d]cycloheptenes from the Corresponding Alcohols

A solution of the alcohol (10 mmol) in toluene or dichloromethane is cooled down to −10° C., and under an atmosphere of a protective gas, a threefold excess of freshly distilled thionyl chloride (about 2 ml, about 3 g) is added dropwise, a slightly pink color from the formation of dibenzotropylium cations being observed in most cases. After thawing, stirring is performed over night. Excess thionyl chloride is removed together with the solvent under a vacuum. The thus obtained product is of sufficient purity for further use. For analytic purposes, a fraction thereof is recrystallized from a suitable solvent.

(III) General Working Protocol for the Preparation of Substituted 5-phosphanyl-5H-dibenzo[a,d]cycloheptenes (tropp ligands)

The respective substituted 5-chloro-5H.dibenzo[a,d]cycloheptene (10 mmol) is provided in 50 ml of toluene and 10 ml of hexane, and the corresponding secondary phosphane (10 mmol), dissolved in 10 ml of toluene, is added at once at room temperature with vigorous stirring. After a short time, the hydrochloride of the product precipitates either as a viscous oil or as fine crystals. Stirring is continued for 5 min at room temperature, followed by heating to boil for 10 min. After cooling, about 20 ml of a carefully degassed 10% aqueous solution of sodium carbonate is added, and the mixture is again heated to boil for 10 min with vigorous stirring. This causes most of the precipitate to dissolve. The organic phase is decanted by means of a transfer needle, and the aqueous phase is extracted with 20 ml of toluene. Decantation is repeated, and the combined toluene phases are dried over sodium sulfate. After filtration, the solvent is removed under vacuum, and the residue recrystallized from acetonitrile.

(IV) General Working Protocol for the Synthesis of Secondary Phosphanes from Primary Phosphanes and Chloroalkyl Compounds

To the primary phosphane (10 mmol) dissolved in 50 ml of THF, a 1.6 M solution of n-butyllithium in hexane (6.5 ml, 10.4 mmol) is added at −20° C. Stirring is continued for 30 min at the same temperature. The solution of phosphide formed thereby is subsequently slowly added dropwise to a solution of the chloroalkyl compound (10 mmol) in 50 ml of THF at −78° C. After the addition is completed, the cooling means is removed, and stirring is continued for 2 h. The solvent is evaporated, and the remaining slightly colored oil is subjected to fractional distillation directly from the precipitated lithium chloride under vacuum.

(II) General Working Protocol for the Synthesis of Complexes of the Type [M(cod)(tropp)]X (M=Rh, Ir, and X=PF₆, OTf)

A solution of the respective tropp ligand (0.25 mmol) in 3 ml of dichloromethane is added dropwise with vigorous stirring to a solution of the metal compound [M(cod)₂]X (M=Rh, Ir, and X=PF₆, OTf) in 3 ml of dichloromethane. Stirring is continued for 5 min, and the reaction solution is subsequently cautiously covered by a layer of 5 ml of hexane. After standing over night, the product is obtained as a crystalline solid which is washed with hexane and dried under vacuum.

### EXAMPLES

### Example 1

### N-Diphenylphosphanyidibenzo[a,d]azepine (tropnp^{Ph})

Empirical formula:

C₂₆H₂₀NP

Molecular weight: 377.43

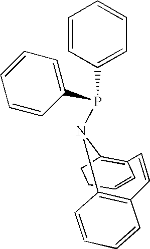

To a solution of dibenzoazepine (1.92 g, 10 mmol) in 100 ml of THF, a 1.6 M solution of n-butyllithium in hexane (6.5 ml, 10.4 mmol) was slowly added dropwise at −78° C. Stirring was continued for 15 min whereby the deep blue anion of the starting substance formed. Thereafter, a solution of chlorodiphenylphosphane (2.25 g, 10.0 mmol) in 30 ml of THF was added dropwise until the reaction solution was colorless. After heating to room temperature, the solvent was removed under vacuum, the residue was taken up in 50 ml of toluene and filtered from the precipitated lithium chloride. After removing the toluene, the raw product was recrystallized from acetonitrile to obtain the aminophosphane in the form of pale yellow crystals.

Yield: 2.87 g (76%)

M.p.: 143° C.

¹H-NMR (CDCl₃): δ=7.51-7.44 (m, 4H, CHar), 7.42-7.37 (m, 2H, CHₐᵣ), 7.35-7.21 (m, 8H, CHₐᵣ), 7.15-7.05 (m, 4H, CHₐᵣ), 6.47 (s, 2H=CH)
   ³¹P-NMR (CDCl₃): δ=72.7
   MS (m/z, %): 377 (92, M⁺), 192 (100, dibenzotropan), 165 (79), 152 (46).

### Example 2

### [Ir(cod)(tropnp^{Ph})]OTf

Empirical formula:

C₃₅H₃₂F₃IrNO₃PS

Molecular weight: 826.90

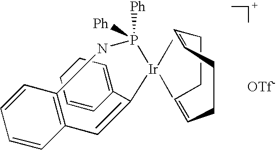

Reaction of the ligand from Example 1 (76 mg, 0.20 mmol) with [Ir(cod)₂]OTf (110 mg, 0.20 mmol) in dichloromethane according to A (V) and standing over night yielded almost black shining crystals of the product which were filtered off and dried under vacuum.

Yield: 87%

M.p.: 172-175° C. (decomp.)

¹H-NMR (CD₂Cl₂): δ=7.70 (dd, ³J_{HH}=7.3 Hz, ⁴J_{HH}=2.0 Hz, 2H, CHₐᵣ), 7.54 (td, ³J_{HH}=7.6 Hz, ⁴J_{HH}=1.2 Hz, 2H, CHₐᵣ), 7.44-7.31 (m, 8H, CHₐᵣ), 7.30-7.14 (m, 4H, CHₐᵣ), 7.11-7.03 (m, 2H, CHₐᵣ), 6.28 (s, 2H, =CHₜᵣₒₚₚ), 5.71 (s(br), 2H, =CH_{cod}), 4.36 (s(br), 2H, =CHC_{cod}), 2.57 (m(br), 4H, CH_{2 cod}), 2.19-2.06 (m, 2H, CH_{2 cod}), 1.98-1.89 (m, 2H, CH_{2 cod} )

³¹P-NMR (CD₂Cl₂): δ=106.9

UV (λₘₐₓ/nm): 473, 401, 323 (CH₂Cl₂)

### Example 3

### Bis(diethylamino)trimethylsilylphosphane

Empirical formula:

C₁₁H₂₉N₂PSi

Molecular weight: 248.43

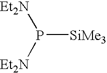

To a suspension of ultrasound-activated lithium powder (1,0 g, 143 mmol) in 200 ml of THF and trimethylsilyl chloride (5.3 g, 50 mmol), a solution of bis(N,N-diethylamino)chlorophosphane (10.5 g, 50 mmol) in 50 ml of THF was added at −78° C. over a period of 3 h. After the addition was completed, the cooling means was removed, and stirring continued for 2 h. Excess lithium was filtered off, the solvent evaporated under vacuum, and the residue was subjected to fractional distillation directly from the precipitated lithium chloride. The product is obtained as a first fraction in the form of a colorless liquid, the by-product tetrakis(N,N-diethylamino)diphosphane, which is also a colorless liquid, has a clearly higher boiling point.

Yield: 65%

M.p.: 56° C./0.05 mbar

¹H-NMR (C₆D₆): δ=3.13 (m, 8H, N(CH₂)₂), 1.04 (m, 12H, CH₂CH₃), 0.22 (m, 9H, Si(CH₃)₃)

²⁹Si-NMR (C₆D₆): δ=−8.13 (d, ¹J_{PSi}=2.3 Hz)

### Example 4a

### 5-Bis(diethylamino)phosphanyl-5H-dibenzo[a,d]cycloheptene (tropp^{NEt2})

Empirical formula:

C₂₃H₃₁N₂P

Molecular weight: 366.49

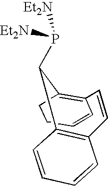

The silyl phosphane from Example 3 (2.48 g, 10 mmol) and 5-chloro-5H-di-benzo[a,d]cycloheptene (2.26 g, 10.0 mmol) were dissolved in 50 ml of toluene, and the reaction mixture was heated over night at 90° C. Thereafter, the volatile components were removed under vacuum, and the remaining residue was recrystallized from acetonitrile to obtain a colorless solid.

Yield: 2.9 g (80%)

M.p.: 157° C.

¹H-NMR (CDCl₃): δ=7.31-7.13 (m, 8H, CHₐᵣ), 6.92 (s, 2H =CH), 4.68 (d, ²J_{PH}=2.8 Hz, 1H, CHP), 3.01-2.85 (m, 8 H, CH₂), 0.68 (t, ³J_{HH}=7.0 Hz; 12 H, CH₃)

³¹P-NMR (CDCl₃): δ=84.4

MS (m/z, %): 366 (9, M⁺), 294 (10, M⁺−N(C₂H₅)₂), 191 (88, dibenzotropylium⁺), 175 (100, M⁺-dibenzotropylium⁺), 165 (72), 104 (95)

### Example 4b

### 5-Bis(diethylamino)phosphanyl-5H-dibenzo[b,f]azepine (tropnp^{NEt2})

Empirical formula:

C₂₂H₃₀N₃P

Molecular weight: 367.47

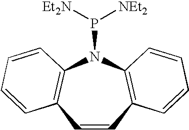

To iminostilbene (5,00 g, 25.9 mmol) in THF (100 ml), butyllithium (16.2 ml, 1.6 M in hexane, 25.9 mmol) was added at −78° C. This yielded a dark-blue solution which was stirred at low temperature for another 30 min. Thereafter, the lithium amide solution was added dropwise to a cooled solution of chlorobis(diethylamino)-phosphane (4.21 g, 25.9 mmol) in THF (40 ml). A yellow solution formed which was concentrated under vacuum. The raw product was taken up in toluene (50 ml), filtered through celite, concentrated, and crystallized from acetonitrile.

Yield: 6.24 g (66%) as light yellow crystals

M.P.: 88° C.

¹H-NMR (250.1 MHz, CDCl₃): δ=7.32-7.28 (m, 2H, CHₐᵣ), 7.25-7.19 (m, 2H, CHₐᵣ), 7.13 (dd, J_{HH}=7.6 Hz, J_{HH}=1.6 Hz, 2H, CHₐᵣ), 7.04-6.99 (m, 2H, CHₐᵣ), 6.85 (s, 2H, CH_{olefin}), 3.04-2.79 (m, 8H, CH₂), 0.69 (t, ³J_{HH}=7.1 Hz, 12H, CH₃) MS (m/z, %): 367 (28, M⁺), 295 (10), 224 (22), 192 (49), 175 (100, P(NEt₂)₂⁺), 165 (16), 104 (84), 74 (15);

### Example 4c

### [Pt(tropnp^{NMe2})₂]

To a solution of [Pt(norbornene)3] (87 mg) in 3 ml of THF, the ligand from Example 4b was added (135 mg), and the raw product was recrystallized from acetonitrile.

Empirical formula: C44H₆₀N₆P₂Pt

Molecular weight: 931.02

³¹P-NMR (C₆D₆): δ=138.4 (1J_{PtP}=5815 Hz)

¹⁹⁵Pt-NMR (C6D6): δ=−6608.7 (t, ¹J_{PtP}=5815 Hz)

### Example 5

### 5-Bis(2-methoxyphenyl)phosphanyl-5H-dibenzo[a,d]cycloheptene (tropp^{2-MeOPh})

Empirical formula:

C₂₉H₂₅O₂P

Molecular weight: 436.49

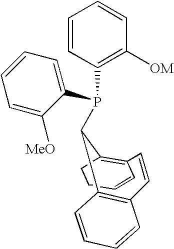

According to (III), bis(2-methoxyphenyl)phosphane [4] (2.60 g, 10.5 mmol) was reacted with 5-chloro-5Hdibenzo[a,d]cycloheptene (2.35 g, 10.5 mmol), and the raw product was recrystallized from acetonitrile to obtain the product in the form of colorless crystals.

Yield: 3.30 g (72%)

M.P.: 141° C.

¹H-NMR (CDCl₃): δ=7.45 (dd, ³J_{HH}=7.5 Hz, ⁴J_{HH}=1.5, CHₐᵣ), 7.35-7.01 (m, 12H, CHₐᵣ, =CH), 6.84 (t, ³J_{HH}=7.5 Hz, 2H, CHₐᵣ), 6.58 (dd, ³J_{HH}=8.4 Hz, J₂=3.2, CHₐᵣ), 5.14 (d, ²J_{PH}=4.2 Hz, CHP), 3.51 (s, 6H, —OCH₃)

³¹P-NMR (CDCl₃): δ=−36.0

### Example 6

### 5-Bis(2-pyridyl)phosphanyl-5H-dibenzo[a,d]cycloheptene (tropp^{2-Py})

Empirical formula:

C₂₅H₁₉N₂P

Molecular weight: 378.42

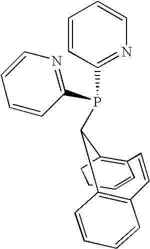

According to (III), bis(2-pyridyl)phosphane (1.88 g, 10 mmol) was reacted with 5-chloro-5H-dibenzo[a,d]cycloheptene (2.26 g, 10.0 mmol). The raw product was obtained as a slightly red oil and could be caused to crystallize by covering with a layer of 2 ml of diethyl ether.

Yield: 72%

M.p.: 126° C.

¹H-NMR (CDCl₃): δ=8.63 (m, 2H, CHₐᵣ), 7.43-7.30 (m, 4H, CHₐᵣ), 7.24 (dd, ³J_{HH}=7.6 Hz, ⁴J_{HH}=2.0 Hz, 2H, CHₐᵣ), 7.17-6.98 (m, 10H, CHₐᵣ), 5.78 (d, J_{PH}=6.4 Hz, 1H, CHP)

³¹P-NMR (CDCl₃): δ=−11.4

MS (m/z, %): 378 (100, M⁺), 191 (95, dibenzotropylium⁺), 165 (82)

### Example 7

### [Rh₂(m-Cl)(m-tropp^{2-Py})₂]PF₆

Empirical formula:

C₅₀H₃₈F₆N₄P₃Rh₂

Molecular weight: 1143.06

A mixture of the phosphone from Example 6 (390 mg, 1.03 mmol), [Rh₂(m-Cl)₂(cod)₂] (247 mg, 0.5 mmol) and potassium hexafluorophosphate (200 mg, 1.08 mmol) was taken up in 20 ml of acetonitrile and heated to boil for 45 min. The solvent was evaporated, the residue was taken up in 10 ml of dichloromethane, the solution was filtered and cautiously covered by a layer of 20 ml of hexane. After standing over night, the product was obtained in the form of raspberry-red crystals one of which was used for X-ray structural analysis.

Yield: 390 mg (68%)

M.p.: 203-205° C. (decomp.)

¹H-NMR (CD₃CN): δ=9.15 (d, J_{HH}=1.5 Hz, 2H, CH_{py}), 8.95 (d, ³J_{HH}=5.6 Hz, 2H, CH_{py}), 8.61 (d, ³J_{HH}=4.0 Hz, CHpy), 8.17 (m, 2H, CHₐᵣ), 7.99 (m, 2H, CHₐᵣ), 7.77 (m, 2H, CHₐᵣ), 7.69 (d, ³J_{HH}=8.1 Hz, 2H, CHₐᵣ), 7.43 (m(br), 2H, CHₐᵣ), 7.39-7.01 (m, 16H, CHₐᵣ), 5.58 (d, ²J_{PH}=14.7 Hz, 2H, CHP), 4.97 (d, ²J_{RhH}=8.8 Hz, 2H, =CH), 4.05 (d, ²J_{RhH}=8.5 Hz, 2H, =CH)

³¹P-NMR (CD₃CN): d=95.7 (d, ¹J_{RhP}=173 Hz), -143.0 (sept, ¹J_{PF}=712 Hz, PF₆⁻)

¹⁰³Rh-NMR (CD₃CN): δ=626 (d)

UV (λₘₐₓ/nm): 521, 252 (CH₂Cl₂)

### Example 8

### [Rh₂(MeCN)₂(m-tropp^{2-Py})₂](PF₆)₂

Empirical formula:

C₅₄H₄₄F₁₂N₄P₃Rh₂

Molecular weight: 1334.68

To a solution of the complex from Example 8 (114 mg, 0.10 mmol) in 5 ml of acetonitrile, thallium hexafluorophosphate (35 mg, 0.10 mmol) was added. The solution turned intensively green, and a flaky colorless precipitate of thallium chloride formed. The solution was filtered, concentrated to a volume of about 2 ml, and covered by a layer of 2 ml of toluene. After some time, almost black shining crystals of the product precipitated; they were filtered off and dried.

Yield: 100 mg (75%)

M.p.: 162-165° C. (decomp.)

¹H-NMR (CD₃CN): δ=9.06 (d, J_{HH}=5.4 Hz, 2H, CH_{PY}), 8.04 (dd, ³J_{HH}=4.7 Hz, ⁴J_{HH}=0.9 Hz, 2H, CH_{py}), 8.00 (dd, ³J_{HH}=7.5 Hz, ⁴J_{HH}=1.2 Hz, 2H, CH_{py}), 7.91 (d, J_{HH}=7.9 Hz, 2H, CHₐᵣ), 7.68-7.08 (m, 9H, CHₐᵣ),, 6.93 (dt, ³J_{HH}=7.8 Hz, 4J_{HH}=1.4 Hz, 2H, CHₐᵣ), 6.71 (d, ³J_{HH}=7.8 Hz, 2H, CHₐᵣ), 6.25 (dd, ²J_{RhH}=9.3 Hz, ³J_{PH}=2.1 Hz, 2H, =CH), 6.21 (m, 2H, CHₐᵣ), 5.10 (d, ²J_{RhH}=8.9 Hz, 2H, =CH), 4.98 (dd, ²J_{PH}=14.8 Hz, 3J_{RhH}=1.4 Hz, 2H, CHP), 2.35 (s, 6H, CH₃CN)

³¹P-NMR (CD₃CN): δ=101.0 (d, ¹J_{RhP}=191 Hz), -143.3 (sept, ¹J_{PF}=712 Hz, PF₆⁻)

¹⁰³Rh-NMR (CD₃CN): δ=655 (d)

UV (λₘₐₓ/nm): 612, 255 (CH₂Cl₂)

### Example 9

### Cyclohexyl-2-(2-pyridyl)ethylphosphane

Empirical formula:

C₁₃H₂₀NP

Molecular weight: 221.28

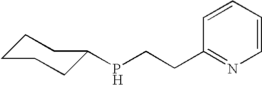

According to (IV), cyclohexylphosphane (1.17 g, 10.0 mmol) was reacted with a 1.6 M solution of n-butyllithium in hexane (6.5 ml, 10.4 mmol) and 2-(2-chloroethyl)pyridine (1.42 g, 10.0 mmol), and the product was worked up by distillation. The product was obtained as a colorless liquid.

Yield: 1.8 g (82%)

M.p.: 86° C./0.05 mbar

¹H-NMR (CDCl₃): δ=8.45 (m, 1H, CH_{py}), 7.66-7.37 (m, 1H, CH_{py}), 7.19-6.90 (m, 2H, CH_{py}), 2.90 (d(br), ¹J_{PH}=199 Hz, PH), 2.99-2.78 (m, 2H, CHₐₗₖ), 2.22-1.43 (m, 8H, CHₐₗₖ), 1.39-0.89 (m, 5H, CHₐₗₖ)

³¹P-NMR (CDCl₃): δ=−49.6

### Example 10

### Phenyl-2-(N-pyrrolidinyl)ethylphosphane

Empirical formula:

C₁₂H₁₈NP

Molecular weight: 207.26

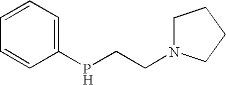

According to (IV), phenylphosphane (2.05 g, 18.5 mmol) was reacted with a 1.6 M solution of n-butyllithium in hexane (12 ml, 19.2 mmol) and N-(2-chloroethyl)-pyrrolidine (2.47 g, 18.5 mmol), and the product was worked up by distillation. The product was obtained as a colorless liquid.

Yield: 3.3 g (86%)

M.p.: 72° C./0.05 mbar

¹H-NMR (CDCl₃): δ=7.54-7.43 (m, 2H, CHₐᵣ), 7.34-7.21 (m, 3H, CHₐᵣ), 4.16 (ddd, ¹J_{PH}=211 Hz, ²J_{PH}=7.2 Hz, ³J_{PH}=6.8 Hz, PH), 2.64-2.49 (m, 2H, CHₐₗₖ), 2.45 (m, 4H, N(CH₂)₂), 2.13-1.88 (m, 2H, CHₐₗₖ), 1.74 (m, 4H, CHₐₗₖ)

³¹P-NMR (CDCl₃): δ=−56.3

### Example 11

### Cyclohexyl-2-(N-pyrrolidinyl)ethylphosphane

Empirical formula:

C₁₂H₂₄NP

Molecular weight: 213.31

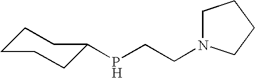

According to (IV), a 1.6 M solution of n-butyllithium in hexane (6.5 ml, 10.4 mmol) was reacted with cyclohexylphosphane (1.17 g, 10.0 mmol). The resulting reaction solution was reacted with N-(2-chloroethyl)pyrrolidine (1.33 g, 10.0 mmol), and the product was worked up by distillation. The product was obtained as a colorless liquid.

Yield: 1.8 g (87%)

M.p.: 92° C./0.05 mbar

¹H-NMR (CDCl₃): δ=2.92 (d(br), ¹J_{PH}=211 Hz, PH), 2.67-2.40 (m, 6H, CHₐₗₖ), 1.95-1.55 (m, 12H, CHₐₗₖ), 1.34-1.02 (m, 5H, CHₐₗₖ)

³¹P-NMR (CDCl₃): δ=−53.4

### Example 12

### 5-(Phenyl-2-(2-pyridyl)ethylphosphanyl)-5H-dibenzo[a,d]cycloheptene (tropp^{Ph,Et-2-Py})

Empirical formula:

C₂₈H₂₅NP

Molecular weight: 405.48

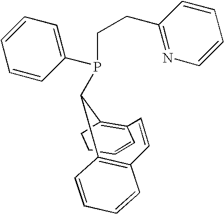

The reaction of 5-chloro-5H-dibenzo[a,d]cycloheptene (2.27 g, 10.0 mmol) and phenyl-2-(2-pyridyl)ethylphosphane (2.15 g, 10.0 mmol) according to (III) yielded the product as a crystalline colorless solid in the form of a racemate.

Yield: 79%

M.p.: 140° C.

¹H-NMR (CDCl₃): δ=8.46 (ddd, ³J_{HH}=4.9 Hz, ⁴J_{HH}=1.9 Hz, ⁵J_{HH}=1.0 Hz, 1H, CH_{py}), dt, ³J_{HH}=7.6 Hz, ⁴J_{HH}=1.7 Hz, 1H, CH_{py}), 7.36-7.14 (m, 10H, CHₐᵣ), 6.97 (s, 2H, =CH), 6.91-6.84 (m, 2H, CHₐᵣ), 6.41 (d, ³J_{HH}=7.7 Hz, 1H, CHₐᵣ), 4.20 (d, ¹J_{PH}=6.8 Hz, CHP), 2.63-2.25 (m, 4H, PCH₂CH₂N)

³¹P-NMR (CDCl₃): δ=−21.5

MS (m/z, %): 406 (1, M⁺), 214 (100, M⁺−dibenzotropylium+), 191 (90, dibenzotropylium⁺), 165 (67), 136 (60), 109 (76)

IR (ν in cm⁻¹): 3015 w, 2895 w, 1590 m, 1569 m, 1491 w, 1472 m, 1432 s, 1105 w, 931 w, 894 w, 805 m, 792 m, 768 m, 745 vs, 722 m, 708 m, 691 s, 642 m, 616 w, 588 m

### Example 13

### 5-(Phenyl-2-(N-pyrrolidinyl)ethylphosphanyl)-5H-dibenzo[a,d]cycloheptene (tropp^{Ph,Et-N-pyrro})

Empirical formula:

C₂₇H₂₈NP

Molecular weight: 397.43

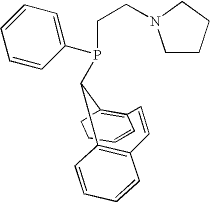

The reaction of the secondary phosphane from Example 10 (1.70 g, 8.2 mmol) with 5-chloro-5H-dibenzo[a,d]cycloheptene (1.86 g, 8.2 mmol) according to (III) yielded the product as a colorless crystalline solid in the form of a racemate.

Yield: 2.8 g (86%)

M.p.: 115° C.

MS (m/z, %): 397 (30, M⁺), 206 (100, M⁺-dibenzotropylium⁺), 191 (78, dibenzotropylium⁺), 165 (62), 137 (35), 109 (32)

¹H-NMR (CDCl₃): δ=7.37-7.14 (m, 10H, CHₐᵣ), 7.07 (t, ³J_{HH}=7.2 Hz; 1H, CHₐᵣ), 6.96 (s, 2H, =CH), 6.89 (t, ³J_{HH}=7.9 Hz, 1H, CHₐᵣ), 4.14 (d, ²J_{PH}=5.8 Hz, CHP), 2.31 (m, 4H, N(CH₂)₂), 2.29-2.16 (m, 1H, PCH₂CH₂N); 2.17-1.96 (m, 2H, PCH₂CH₂N), 1.70 (m, 4H, N(CH₂CH₂)₂), 1.65-1.52 (m, 1H, PCH₂CH₂N)

³¹P-NMR (CDCl₃): δ=−25.9

### Example 14

### 5-(Cyclohexyl-2-(2-pyridyl)ethylphosphanyl)-5H-dibenzo[a,d]cycloheptene (tropp^{Cyc,Et-2-Py})

Empirical formula:

C₂₈H₃₁NP

Molecular weight: 411.60

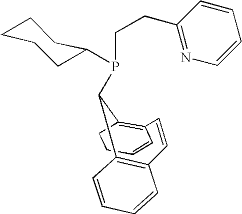

Reacting 5-chloro-5H-dibenzo[a,d]cycloheptene (1.13 g, 5 mmol) with the secondary phosphane from Example 9 (1.11 g, 5 mmol) according to (III) yielded the racemic product in the form of colorless crystals upon crystallization from acetonitrile.

Yield: 1.9 g (92%)

M.p.: 129° C.

¹H-NMR (CDCl₃): δ=8.46 (m, 1H, CH_{py}), 7.47 (dt, ³J_{HH}=7.7 Hz, ⁴J_{HH}=1.7 Hz, 1H, CH_{py}), 7.38-7.15 (m, 8H, CHₐᵣ), 7.07-6.88 (m, 1H, CHₐᵣ), 6.95 (s(br), 2H, =CH), 6.73 (d, ³J_{HH}=8.1 Hz, CHₐᵣ), 4.33 (d, ²J_{PH}=6.4 Hz, CHP), 2.49 (m, 1H, CHₐₗₖ), 2.0-5-1.37 (m, 8H, CHₐₗₖ), 1.21-0.93 (m, 6H, CHₐₗₖ)

³¹P-NMR (CDCl₃): δ=−13.7

### Example 15

### 5-(Cyclohexyl-2-(N-pyrrolidinyl)ethylphosphanyl)-5H-dibenzo[a,d]cycloheptene (tropp^{Cyc,Et-N-pyrro})

Empirical formula:

C₂₇H₃₄NP

Molecular weight: 403.55

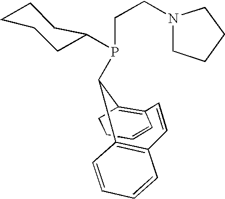

Reacting the chloride 5-chloro-5H-dibenzo[a,d]cycloheptene (1.13 g, 5 mmol) with the secondary phosphane from Example 11 (1.07 g, 5 mmol) according to (III) yielded the racemic product in the form of colorless crystals.

Yield: 1.5 g (76%)

M.p.: 106° C.

¹H-NMR (CDCl₃): δ=7.35-7.14 (m, 8H, CHₐᵣ), 6.91 (s, 1H, ═CH), 6.90 (s, 1H, ═CH), 4.27 (d, ²J_{PH}=6.2 Hz, CHP), 2.32-2.17 (m, SH, CHₐₗₖ), 1.92 (m, 1H, CHₐₗₖ), 1.80-1.39 (m, 10H, CHₐₗₖ), 1.36-1.23 (m, 1H, CHₐₗₖ), 1.18-0.93 (m, 6H, CHₐₗₖ)

³¹P-NMR (CDCl₃): δ=−17.3

MS (m/z, %): 403 (35, M⁺), 334 (39, M⁺—N(CH₂)₄), 306 (84, M⁺—(CH₂)₂N(CH₂)₄), 252 (59), 212 (91), 191 (100, dibenzotropylium⁺), 178 (82), 165 (65)

### Example 16

### [Ir(cod)(tropp^{Ph,Et-2-Py})]OTf

Empirical formula:

C₃₇H₃₆F₃IrNO₃PS

Molecular weight: 854.95

The ligand from Example 12 (85 mg, 0.21 mmol) was reacted with [Ir(cod)₂]OTf according to (V) to obtain the racemic product as pale yellow rectangular parallel-epipeds.

Yield: 160 mg (93%)

M.p.: 177-180° C. (decomp.)

¹H-NMR (CD₂Cl₂): δ=9.16 (d, ³J_{HH}=6.0 Hz, 1H, CH_{py}), 7.69-7.61 (m, 2H, CHₐᵣ), 7.51-7.30 (m, 5H, CHₐᵣ), 7.26-7.15 (m, 3H, CHₐᵣ), 7.09 (d, ³J_{HH}=7.2 Hz, CHₐᵣ), 7.02-6.87 (m, 3H, CHₐᵣ), 6.45 (t, ³J_{HH}=7.9 Hz, 2H, CHₐᵣ), 5.92 (d(br), ³J_{PH}=9.6 Hz, ═CH), 5.34 (m(br), 1H, ═CH), 5.06 (m (br), 1H, ═CH_{cod}), 5.00 (dd, ²J_{PH}=14.7 Hz, J₂=3.7 Hz, 1H, CHP), 4.80 (m, 1H, ═CH), 3.51-3.04 (m, 2H, CHₐₗₖ), 2.91-2.08 (m, 5H, CHₐₗₖ), 2H, ═CH), 2.02-1.66 (m, 2H, CHₐₗₖ), 0.86-0.78 (m, 1H, CHₐₗₖ)

³¹P-NMR (CD₂Cl₂): δ=49.3

### Example 17

### [Ir(cod)(tropp^{Cyc,Et-2-Py}]OTf

Empirical formula:

C₃₇H₄₂F₃IrNO₃PS

Molecular weight: 861.00

The ligand from Example 14 (135 mg, 0.30 mmol) was reacted with [Ir(cod)₂]OTf (165 mg, 0.30 mmol) according to (V) to obtain the product as an almost colorless crystalline solid.

Yield: 260 mg (quantitative)

M.p.: 189-191° C. (decomp.)

¹H-NMR (CD₂Cl₂): δ=8.99 (d, ³J_{HH}=6.0 HZ, 1H, CH_{py}), 7.75-7.65 (m, 2H, CHₐᵣ), 7.44 (dd, ³J_{HH}=7.7 Hz, ⁴J_{HH}=1.1 Hz, 1H, CHₐᵣ), 7.39-7.32 (m, 2H, CHₐᵣ), 7.28 (ddd, ³J_{HH}=7.7 Hz, ³J_{HH}=5.7 Hz, ⁴3HH =1.5 Hz, 1H, CHₐᵣ), 7.24-7.20 (m, 1H, CHₐᵣ), 7.16 (dd, ³J_{HH}=7.7 Hz, ⁴J_{HH}=1.3 Hz; 1H, CHₐᵣ), 7.09-6.99 (m, 2H, CHₐᵣ), 6.90 (tt, ³J_{HH}=7.3 Hz, ⁴J_{HH}=1.1 Hz, 1H, CHₐᵣ), 5.74 (d, ³J_{HH}=9.4 Hz, 1H, ═CHₜᵣₒₚₚ), 5.41 (m(br), 1H, ═CH_{cod}), 4.91 (d, ³J_{PH}=13.6 Hz, 1H, CHP), 4.71 (m(br), 1H, ═CH_{cod}), 4.28 (dd, ³J_{PH}=9.4 Hz, ⁴J_{HH}=2.6 Hz, 1H, ═CHₜᵣₒₚₚ), 4.05 (m(br), 2H, ═CH_{cod}), 3.24-3.00 (m, 2H, CHₐₗₖ), 2.90-2.74 (m, 1H, CHₐₗₖ), 2.66-0.71 (m, 19H, CHₐₗₖ), 0.59 (m, 1H, CHₐₗₖ)

³¹P-NMR (CD₂Cl₂): δ=51.9

### Example 18

### [Ir(cod)(tropp^{Ph,Et-N-pyrro})]OTf

Empirical formula:

C₃₆H₄₀F₃IrN PO₃S

Molecular weight: 846.97

The ligand from Example 13 (80 mg, 0.20 mmol) was reacted with [Ir(cod)₂]OTf (110 mg, 0.20 mmol) according to (V) to obtain pale yellow crystals of the product.

Yield: 170 mg (quantitative)

M.p.: 192-195° C. (decomp.)

¹H-NMR (CD₂Cl₂): δ=7.71 (d, ³J_{HH}=7.5 Hz, 1H, CHₐᵣ), 7.55-7.23 (m, 10H, CHₐᵣ), 7.09 (d, ³J_{HH}=7.7 Hz, 1H, CHₐᵣ), 6.74 (m, 2H, CHₐᵣ), 6.71 (t, ³J_{HH}=8.4 Hz, 2H, CHₐᵣ), 5.63 (d, ²J_{PH}=8.4 Hz, 1H, ═CHₜᵣₒₚₚ), 5.20 (m(br), 1H, ═CH_{cod}), 4.63 (m(br), 1H, ═CH_{cod}), 4.58 (dd, ²J_{PH}=9.3 Hz, J=2.2 Hz, 1H, ═CHₜᵣₒₚₚ), 3.41-3.22 (m, 4H, CHₐₗₖ), 2.99-2.60 (m, 5H, CHₐₗₖ), 2.59-2.18 (m, 5H, CHₐₗₖ), 2.13-1.76 (m, 7H, CHₐₗₖ), 0.59 (m, 1H, CHₐₗₖ)

³¹P-NMR (CD₂Cl₂): δ=66.3

### Example 19

### [Ir(cod)(tropp^{Cyc,Et-N-pyrro})]OTf

Empirical formula:

C₃₆H₄₆F₃IrNO₃PS

Molecular weight: 853.02

According to (V), the ligand from Example 15 (102 mg, 0.26 mmol) was reacted with [Ir(cod)₂]OTf (137 mg, 0.25 mmol) to obtain a pale yellow microcrystalline powder after crystallization.

Yield: 200 mg (94%)

M.p.: 170-173° C. (decomp.)

¹H-NMR (CD₂Cl₂): δ=d =7.58 (dd, ³J_{HH}=7.6 Hz, ⁴J_{HH}=3.0 Hz, 1H, CHₐᵣ), 7.37-7.12 (m, 7H, CHₐᵣ), 5.38 (s(br), 1H, ═CHₜᵣₒₚₚ), 5.19 (m(br), 1H, ═CH_{cod}), 5.12 (d, ²J_{PH}=13.2 Hz, 1H, CHP), 4.33 (m(br), 1H, ═CH_{cod}), 4.22 (m(br), 1H, ═CH_{cod}), 4.09 (dd, J_{PH}=9.4 Hz, ³J_{HH}=2.3 Hz, 1H, ═CHₜᵣₒₚₚ), 3.64 (m(br), 1H, ═CH_{cod}), 3.36 (m, 1H, CHₐₗₖ), 3.15 (s(br), 2H, CHₐₗₖ), 2.81-0.85 (m, 27H, CHₐₗₖ), 0.30 (m, 1H, CHₐₗₖ)

³¹P-NMR (CD₂Cl₂): δ=71.0

### Example 20

[IrCl(MeCN)(tropp^{Ph,Et-2-Py})]

Empirical formula:

C₃₀H₂₇ClIrN₂P

Molecular weight: 674.21

A mixture of [Ir(cod)CI]₂ (168 mg, 0.25 mmol) and the ligand of Example 12 (220 mg, 0.55 mmol) was admixed with 10 ml of acetonitrile, heated to boil for 2 min and subsequently concentrated to a quarter of its volume. Upon covering with a layer of 10 ml of a mixture of toluene and hexane (1:1), almost colorless crystals of the racemic product were obtained after some time which dissolve in dichloromethane to give a red color.

Yield: 300 mg (89%)

M.p.: 143-144° C. (decomp.)

¹H-NMR (CD₃CN): δ=9.15 (s(br), 1H, CH_{Py}), 7.74 (td, ³J_{HH}=7.8 Hz, ⁴J_{HH}=1.4 Hz, CHₐᵣ), 7.52-7.07 (m, 12H, CHₐᵣ), 7.01 (t, ³J_{HH}=7.4 Hz, 1H, CHₐᵣ), 6.80 (t, ³J_{HH}=7.8 Hz, 1H, CHₐᵣ), 6.63 (d, ³J_{HH}=7.3 Hz, 1H, CHₐᵣ), 4.78 (d, ²J_{PH}=13.8 Hz, 1H, CHP), 4.33 (d, ³J_{PH}=8.8 Hz, 1H, ═CH), 4.07 (d(br), ³J_{PH}=8.9 Hz, 1H, ═CH), 3.06-2.73 (m, 2H, CHₐₗₖ), 2.37-1.79 (m, 2H, CHₐₗₖ), 2.34 (s, 3H, CH₃CN_{coord})

³¹P-NMR (CD₃CN): δ=60.4 (s (br), Dn_{1/2}=28 Hz)

### Example 21

### [RhCl(tropp^{Ph,Et-2-Py})]

Empirical formula:

C₂₈H₂₄ClNPRh

Molecular weight: 543.84

[Rh(cod)CI]₂ (123 mg, 0.25 mmol) was added with weighing together with the ligand of Example 12 (210 mg, 0.52 mmol), and the mixture was admixed with 10 ml of dichloromethane. Upon slight heating and the subsequent addition of 10 ml of hexane, the racemic product could be obtained in the form of an orange powder.

Yield: 245 mg (90%)

M.p.: 215-220° C. (decomp.)

¹H-NMR (CDCl₂): δ=8.99 (d, ³J_{HH}=5.3 Hz, 1H, CH_{Py}), 7.67 (m, 1H, CH_{Py}), 7.56-7.45 (m, 4H, CHₐᵣ), 7.34-7.20 (m, 3H, CHₐᵣ), 7.15-6.96 (m, 6H, CHₐᵣ), 6.77 (td, ³J_{HH}=7.5 Hz, ⁴J_{HH}=1.5 Hz, 1H, CHₐᵣ), 6.53 (d, ³J_{HH}=7.5 Hz, CHₐᵣ), 5.67 (dd, ³J_{PH}=9.2 Hz, ²J_{RhH}=2.1 Hz, 1H, =CH), 5.01 (dd, ³J_{PH}=9.2 Hz, ²J_{RhH}=1.3 Hz, 1H, ═CH), 4.40 (dd, ²J_{PH}=14.5 Hz, ³J_{RhH}=2.3 Hz, 1H, CHP), 3.38 (m, 1H, PCH₂), 3.02 (ddt, ²J_{PH}=38.2 Hz, ²J_{Hgem}=13.1 Hz, J₃=4.0 Hz, , 1H, PCH₂), 2.08-1.79 (m, 2H, CH₂-py)

³¹P-NMR (CDCl): δ=113.5 (d, ¹J_{RhP}=195 Hz)

¹⁰³Rh-NMR (CDCl₂): δ=441 (d)

UV (λₘₐₓ/nm): 462, 282 (CH₂Cl₂)

### Example 22

### [Rh(MeCN)(tropp^{Ph,Et-2-Py})]PF₆

Empirical formula:

C₃₀H₂₇F₆N₂P₂Rh

Molecular weight: 694.41

A mixture of the complex from Example 22 (110 mg, 0.20 mmol) and thallium hexafluorophosphate (72 mg, 0.21 mmol) was admixed with 2 ml of acetonitrile to form a colorless precipitate of thallium chloride from the red solution obtained. The mixture was filtered, and the clear solution was cautiously covered with a layer of 5 ml of toluene. After standing over night, the racemic product was obtained in the form of bright red needles.

Yield: 98 mg (70%)

M.p.: 165-167° C. (decomp.)

¹H-NMR (CD₂Cl₂): δ=8.60 (d, ³J_{HH}=5.3 Hz, 1H, CH_{Py}), 7.75-7.70 (m, 2H, CHₐᵣ), 7.59 (d, ³J_{HH}=8.0 Hz, 1H, CHₐᵣ), 7.49-7.33 (m, 6H, CHₐᵣ), 7.29 (d, ³J_{HH}=8.1 Hz, 1H, CHₐᵣ), 7.23 (td, ³J_{HH}=7.3 Hz, ⁴J_{HH}=1.3 Hz, 1H, CHₐᵣ), 7.18-7.10 (m, 3H, CHₐᵣ), 6.92 (td, ³J_{HH}=7.5 Hz, ⁴J_{HH}=0.7 Hz, 1H, CHₐᵣ), 6.69 (d, ³J_{HH}=7.7 Hz, CHₐᵣ), 5.28 (dd,³J_{PH}=9.3 Hz, ²J_{RhH}=1.6 Hz, 1H, ═CH), 4.95 (d, ³J_{PH}=8.8 Hz, 1H, ═CH), 4.58 (dd, ²J_{PH}=14.7 Hz, ³J_{RhH}=2.0 Hz, 1H, CHP), 3.30-3.11 (m, 2H, PCH₂), 2.47 (s, 3H, CH₃CH_{coord}), 2.11-1.76 (m, 2H, CH₂py)

³¹P-NMR (CD₂Cl₂): δ=113.6 (d, ¹J_{RhP}=190 Hz), −142.8 (sept, ¹J_{PF}=712 Hz, PF₆ )

¹⁰³Rh-NMR (CD₂Cl₂): δ=344 (d)

UV (λₘₐₓ/nm): 451, 290 (CH₂Cl₂)

### Example 23

### 3,7-Bis(chlorosulfonyl)-10,11-dihydro-5H-dibenzo[a,d]cycloheptene-5-one

Empirical formula:

C₁₅HOCl₂O₅S₂

Molecular weight: 405.27

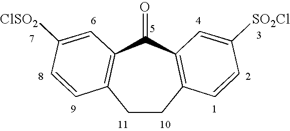

Dibenzosuberone (Aldrich) (20.8 g, 100 mmol) was liquefied (m.p.: 36° C.) and added dropwise to 200 ml of chlorosulfonic acid. After the addition was completed, the reaction mixture was heated at 150° C. for 2 h, which resulted in a vivid evolution of hydrogen chloride. After cooling, the mixture was cautiously poured onto 2 kg of ice, the yellow solid was isolated by vacuum filtration and washed repeatedly with water. The residue was continuously extracted by means of a Soxhlet apparatus over 5 h with 200 ml of acetone. Storage in the deep-freezer (−24° C.) yielded the product as a lemon-yellow crystalline solid. Further purification may be effected by recrystallization from chloroform.

Yield: 22.3 g (55%)

M.p.: 196° C.

¹H-NMR (CDCl₃): δ=8.71 (d, 2H, ⁴J_{HH}=2.2 Hz, 2H, C_{4,6}H), 8.13 (dd, 2H, ³J_{HH}=8.2 Hz, ⁴J_{HH}=2.1 Hz, 2H, C_{2,8}H), 7.58 (d, ²H, ³J_{HH}=8.2 Hz, 2H, C_{1,9}H), 3.31 (s, 4H, CH₂)

MS (m/z, %): 404 (93, M⁺), 369 (100, M⁺—Cl), 305 (89, M⁺—SO₂Cl), 277 (34), 205 (57), 178 (90), 151 (42)

### Example 24

### 3,7-Bis(dimethylaminosulfonyl)-10,11-dihydro-5H-dibenzo[a,d]cycloheptene-5-one

Empirical formula:

C₁₉H₂₂N₂O₅S₂

Molecular weight: 422.52 8

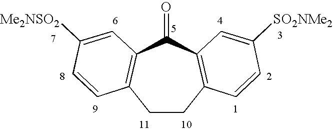

A solution of dimethylamine hydrochloride (12.0 g, 149 mmol) in 100 ml of water was admixed with sodium hydroxide (6.0 g, 150 mmol). This was followed by the addition of first 200 ml of THF and then the ketone from Example 13 (20.3 g, 50 mmol), which caused the solution to heat up strongly. After the reaction had subsided, the THF was distilled off in a rotary evaporator at normal pressure to obtain the product in the form of colorless nacreous platelets, which were filtered off, washed with water repeatedly and dried under a vacuum.

Yield: 21.1 g (quantitative)

M.p.: 196-198° C.

¹H-NMR (CDCl₃): δ=8.37 (d, 2H, ⁴J_{HH}=2.0 Hz, 2H, C_{4,6}H), 7.86 (dd, 2H, ³J_{HH}=8.0 Hz, ⁴J_{HH}=2.1 Hz, 2H, C_{2,8}H), 7.46 (d, 2H, ³J_{HH}=8.0 Hz, 2H, C_{1,9}H), 3.33 (s, 4H, CH₂), 2.75 (s, 12H, —N(CH₃)₂)

### Example 25

### 3,7-Bis(dimethylaminosulfonyl)-5H-dibenzo[a,d]cycloheptene-5-one

Empirical formula:

C₁₉H₂₀N₂O₅S₂

Molecular weight: 420.50

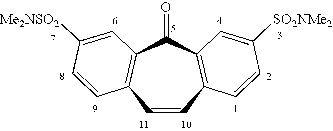

A suspension of the ketone from Example 24 (15.0 g, 35.5 mmol) in 500 ml of benzene was admixed with N-bromosuccinimide (9.6 g, 54.0 mmol) and a spatula tip-full of bis(azaisobutyronitrile) (AIBN), and the reaction mixture was slowly heated to boil. After the free-radical reaction had started, which could be seen from the brown color of the solvent condensing on the reflux condenser, the mixture was heated under reflux for 1 hour, and then N-bromosuccinimide (6.4 g, 36.0 mmol) was again added. The mixture was again heated to boil for 1 hour. The solvent was evaporated, and the remaining residue was suspended in 100 ml of water, isolated by vacuum filtration and shortly dried. Then, 500 ml of acetone and sodium iodide (14.2 g, 100.0 mmol) were added, and immediately the deep-brown color of elemental iodine showed. Heating under reflux was continued for another 30 min. After the addition of 200 ml of water, a 10% aqueous solution of sodium sulfite was added until the reaction solution became colorless. The acetone was removed under reduced pressure, and the precipitate formed was washed first with water, then with ethanol and finally with diethyl ether. For analytic purposes, a small fraction thereof was recrystallized from chloroform. The product was obtained as a pale yellow solid.

Yield: 8.2 g (55%)

M.p.: 257° C.

¹H-NMR (CDCl₃): δ=8.55 (d, 2H, ⁴J_{HH}=2.1 Hz, 2H, C_{4,6}H), 8.03 (dd, 2H, ³J_{HH}=8.1 Hz, ⁴J_{HH}=2.1 Hz, 2H, C_{2,8}H), 7.74 (d, 2H, ³J_{HH}=8.0 Hz, 2H, C_{1,9}H), 7.24 (s, 2H, ═CH), 2.80 (s, 12H, —N(CH₃)₂)

MS (m/z, %): 420 (45, M⁺), 313 (100, M⁺—SO₂NMe₂), 204 (98), 176 (79)

### Example 26

### 3,7-Bis(dimethylaminosulfonyl)-5H-dibenzo[a,d]cycloheptene-5-ol

Empirical formula:

C₁₉H₂₂N₂O₅S₂

Molecular weight: 422.52

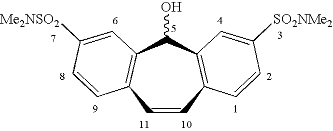

The reduction of the ketone from Example 25 (8.4 g, 20 mmol) was performed according to (I) and yielded the alcohol as a yellow powder upon reprecipitation of the raw product from dichloromethane with hexane.

Yield: 6.6 g (78%)

M.p.: 212° C.

¹H-NMR (CDCl₃): δ=8.20 (d, 2H, ⁴J_{HH}=1.9 Hz, 2H, C_{4,6}H), 7.70 (dd, 2H, ³J_{HH}=8.1 Hz, ⁴J_{HH}=2.1 Hz, 2H, C_{2,8}H), 7.51 (d, 2H, ³J_{HH}=8.1 Hz, 2H, C_{1,9}H), 7.26 (s, 2H, ═CH), 5.40 (s(br), 1H, —CHOH), 2.89 (s(br), 1H, —OH), 2.72 (s, 12H, —N(CH₃)₂ )

### Example 27

### 5-Chloro-3,7-bis(dimethylaminosulfonyl)-5H-dibenzo[a,d]cycloheptene

Empirical formula:

C₁₉H₂₁ClN₂O₄S₂

Molecular weight: 440.96

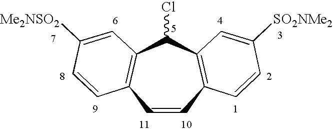

In the chlorination of the alcohol from Example 26 (4.2 g, 10 mmol) with thionyl chloride according to (II), the product was obtained as a colorless fine-crystalline powder upon reprecipitation from dichloromethane with hexane.

Yield: 3.9 g (89%)

M.p.: 210° C.

¹H-NMR (CDCl₃): δ=7.95 (s(br), 2H, C₄,₆H), 7.80 (d(br), 2H, ³J_{HH}=8.0 Hz, C_{2,8}H), 7.63 (s(br), 2H, C_{1,9}H), 7.30 (s, 2H, ═CH), 6.30 (s(br), 1H, CHCl), 2.75 (s, 12H, —N(CH₃)₂)

MS (m/z, %): 440 (2, M⁺), 405 (100, M⁺—Cl), 297 (33, M⁺—SO₂NMe₂—Cl), 189 (65)

### Example 28

### 3,7-Bis(dimethylaminosulfonyl)-5-diphenylphosphanyl-5H-dibenzo[a,d]cycloheptene (_{Me2NO2S}tropp^{Ph})

Empirical formula:

C₃₁H₃₁lN₂O₄PS₂

Molecular weight: 590.70

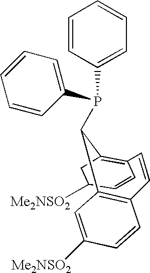

Reacting diphenylphosphane (1.4 g, 7.5 mmol) with the chlorine compound from Example 27 (3.3 g, 7.5 mmol) according to (III) yielded the pure product as colorless cubes upon recrystallization of the raw product from acetonitrile.

Yield: 2.7 g (62%)

M.p.: 222° C.

¹H-NMR (CD₂Cl₂): δ=7.65-7.50 (m, 4H, CHₐᵣ), 7.46-7.35 (m, 6H, CHₐᵣ), 7.33-7.16 (m, 8H, CHₐᵣ, ═CH), 5.19 (d, 1H, ²J_{PH}=4.7 Hz), 2.44 (s, 12H, 13 N(CH₃)₂)

³¹P-NMR (CD₂Cl₂): δ=−15.0

MS (m/z, %): 590 (15, M⁺), 405 (100, M⁺—P(Ph)₂), 370 (71), 297 (22), 189 (49), 183 (87)

### Example 29

### [Ir(cod)(_{Me2NO2S}tropp^{Ph})]OTf

Empirical formula:

C₄₀H₄₃F₃IrN₂O₇PS₃

Molecular weight: 1040.17

The reaction of the aminosulfonated ligand from Example 28 (138 mg, 0.20 mmol) with [Ir(cod)₂]OTf (110 mg, 0.20 mmol) in dichloromethane according to (V) yielded almost black shining crystals of the product after standing over night, which crystals were filtered off and dried under vacuum.

Yield: 190 mg (92%)

M.p.: 195-197° C. (decomp.)

¹H-NMR (CD₂Cl₂): δ=7.97 (d, ³J_{HH}=8.1 Hz, 2H, CHₐᵣ), 7.68 (d, ³J_{HH}=8.1 Hz, 2H, CHₐᵣ), 7.57 (m, 2H, CHₐᵣ), 7.51 (t, ³J_{HH}=7.6 Hz, 2H, CHₐᵣ), 7.38 (td, ³J_{HH}=8.0 Hz, ⁴J_{HH}=2.3 Hz, 4H, CHa,), 6.98-6.88 (m, 4H, CHₐᵣ), 6.39 (s, 2H, ═CHₜᵣₒₚₚ), 6.00 (d, ²J_{PH}=14.3 Hz, 1H, CHP), 5.91 (s(br), 2H, ═CH_{cod}), 4.45 (s(br), 2H, ═CH_{cod}), 2.65-2.35 (m, 4H, CH_{2 cod}), 2.58 (s, 12H, CH₃), 2.18-1.83 (m(br), 4H, CH_{2 cod})

### Example 30

### 5-Chloro-3,7-difluoro-5H-dibenzo[a,d]cycloheptene

Empirical formula:

C₁₅H₉ClF₂

Molecular weight: 262.69 8

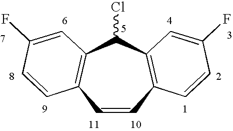

According to (II), the product was synthesized from the corresponding alcohol which can be obtained from the literature-known ketone according to (I) (1.05 g, 4.3 mmol) by reaction with thionyl chloride (3.0 ml, 4.90 g, 41.2 mmol) in 50 ml of toluene to obtain the product as a pale yellow microcrystalline powder.

Yield: 1.10 g (97%)

M.p.: 187° C.

¹H-NMR (CDCl₃): δ=7.40 (m(br), 2H, C_{4,6}Hₐᵣ), 7.26-7.05 (m(br), 4H, C_{1,2,8,9}Hₐᵣ), 7.07 (s, 2H, ═CH), 6.05 (s(br), 1H, CHCl)

¹⁹F-NMR (CDCl₃): δ=−112.7

### Example 31

### 3,7-Difluoro-5-diphenylphosphanyl-5H-dibenzo[a,d]cycloheptene (_{F}tropp^{Ph})

Empirical formula:

C₂₇H₁₉F₂P

Molecular weight: 412.42

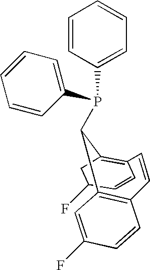

From the chloride from Example 30 (0.80 g, 3.0 mmol), the product was obtained by reaction with diphenylphosphane according to (III). For purification, it was recrystallized from acetonitrile to obtain the pure product as a colorless crystalline solid.

Yield: 75%

M.p.: 150° C.

¹H-NMR (CDCl₃): δ=7.35-7.18 (m, 12H, CHₐᵣ), 6.99 (s, 2H, ═CH), 6.87 (tdd, ³J_{HH}=8.5 Hz, J_{HH}=2.6, J_{FH}=1.0 Hz, 2H, CHₐᵣ), 6.65 (ddd, ³J_{HH}=9.2 Hz, ⁴J_{HH}=2.6, J_{FH}=1.0 Hz, 2H, CHₐᵣ), 4.70 (d, ²J_{PH}=5.5 Hz, 1H, CHP)

³¹P-NMR (CDCl₃): δ=−13.1

¹⁹F-NMR (CDCl₃): δ=−112.2

MS (m/z, %): 412 (10, M⁺), 227 (100, M⁺—PPh₂), 192 (26, dibenzotropan), 183 (46)

¹H-NMR (CD₃CN): δ=7.90 (dd, ³J_{HH}=8.6 Hz, J_{FH}=5.5 Hz, 4H, CHₐᵣ, ds), 7.55 (dd, J_{HH}=7.3 Hz, J_{FH}=6.8 Hz, 4H, CH_{ar, penta}), 7.48 (td, J_{HH}=7.6 Hz, J_{RhH}=1.0 Hz, 8H, CH_{ar, penta}), 7.33-7.25 (m, 8H, CH_{ar, penta}, 4H, CHₐᵣ, ds) 7.19 (td, ³J_{HH}7.2 Hz, J_{RhH}=2.1 Hz, 8H, CHₐᵣ, cis), 7.12-6.99 (m, 8H, CH_{ar, penta}, 8H, CHₐᵣ, cis), 6.90 (t, ³J_{HH}=7.6 Hz, 8H, CHₐᵣ, cis), 6.75 (dd, ³J_{PH}=9.0 Hz, J_{RhH}=2.4 Hz, 4H, ═CH_{cis}), 6.71-6.64 (m, 4H, CH_{ar, penta}), 5.58 (t, J_{PH, RhH}=4.0 Hz, 2H, CHPₚₑₙₜₐ), 5.23 (m, 2H, CHP_{cis}), 4.60 (m, 4H, ═CHₚₑₙₜₐ)

### Example 32

### 3,7-Diiodo-5H-dibenzo[a,d]cyclohepten-5-one

Empirical formula:

C₁₅H₈I₂O

Molecular weight: 458.04

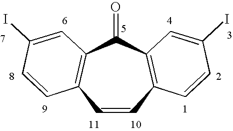

A suspension of 3,7-diiodo-5H-dibenzo[a,d]cycloheptan-5-one (6.2 g, 13.6 mmol) in 200 ml of carbon tetrachloride was admixed with N-bromosuccinimide (5.1 g, 28.6 mmol) and a spatula tip-full of bis(azaisobutyronitrile) (AIBN), and the reaction mixture was slowly heated to boil. After the free-radical reaction had started, which could be seen from the brown color of the solvent condensing on the reflux condenser, heated under reflux was continued for 3 h. Upon cooling, the dibrominated intermediate product precipitated in crystalline form. It was filtered off, washed with little carbon tetrachloride and dried under vacuum. Then, 300 ml of acetone and sodium iodide (4.3 g, 30.4 mmol) were added, and immediately the deep-brown color of elemental iodine showed. Heating under reflux was continued for another 30 min. After the addition of 100 ml of water, a 10% aqueous solution of sodium sulfite was added until the reaction solution became colorless. The acetone was removed under reduced pressure, and the precipitate formed was washed first with water, then with ethanol and finally with diethyl ether. For analytic purposes, a small fraction thereof was recrystallized from chloroform. The product was obtained as a pale yellow microcrystalline powder.

Yield: 4.7 g (75%)

M.p.: 260° C.

¹H-NMR (DMSO-d₆): δ=8.42 (d, 2H, ⁴J_{HH}=2.1 Hz, 2H, C_{4,6}H), 8.16 (dd, 2H, ³J_{HH}=8.0 Hz, ⁴J_{HH}=2.1 Hz, 2H, C₂, sH), 7.60 (d, 2H, ³J_{HH}=8.0 Hz, 2H, C_{1,9}H), 7.27 (s, 2H, ═CH)

### Example 33

### 3,7-Diiodo-5H-dibenzo[a,d]cyclohepten-5-ol

Empirical formula:

C₁₅H₁₀I₂O

Molecular weight: 460.05

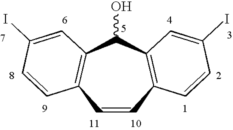

According to (I), the ketone from Example 32 (4.2 g, 9.2 mmol) was reduced, and the raw product recrystallized from methanol to obtain the product as colorless fibers.

Yield: 3.6 g (86%)

M.p.: 177-178° C.

¹H-NMR (CDCl₃): δ=8.06 (s(br), 2H, C_{4,6}H), 7.59 (d(br), ³J_{HH}=8.0 Hz, 2H, C_{4,6}H), 7.04 (s(br), 2H, C_{1,9}H), 7.02 (s, 2, —CH), 5.18 (s(br), 1H, —CHOH), 2.04 (s(br), 1H, —OH)

MS (m/z, %): 460 (100, M⁺), 430 (74, M⁺—H₂C═O), 333 (39, M⁺—I), 304 (76), 205 (32), 189 (49), 178 (91)

### Example 34

### 5-Chloro-3,7-diiodo-5H-dibenzo[a,d]cycloheptene

Empirical formula:

C₁₅HgClI₂

Molecular weight: 478.50

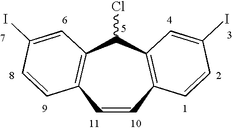

The reaction of the alcohol from Example 33 (3.0 g, 6.5 mmol) with thionyl chloride according to (II) results in the product, which is obtained as a yellow powder upon crystallization from toluene.

Yield: 95%

M.p.: 177° C.

¹H-NMR (CDCl₃): δ=7.82 (s(br), 2H, C_{4,6}H), 7.71 (d(br), 2H, ³J_{HH}=8.2 Hz, C_{2,8}H), 7.15 (s(br), 2H, C_{1,9}H), 7.07 (s, 2H, —CH), 6.00 (s(br), 1H, —CHCl) MS (m/z, %): 478 (83, M⁺), 443 (100, M⁺- Cl), 316 (77 , M⁺—Cl), 221 (50, M⁺-2I), 189 (79)

### Example 35

### 5-Diphenylphosphanyl-3,7-diiodo-5H-dibenzo[a,d]cycloheptene (ᵢtropp^{Ph})

Empirical formula:

C₂₇H₁₉I₂P

Molecular weight: 628.24

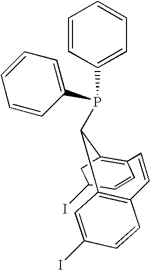

According to (III), diphenylphosphane (0.55 g, 0.30 mmol) and the chlorine compound from Example 34 (1.43 g, 3.0 mmol) were reacted in toluene to obtain the phosphane in the form of yellow needles upon recrystallization.

Yield: 70%

M.p.: 172° C.

¹H-NMR (CD₂Cl₂): δ=7.49 (ddd, ³J_{HH}=8.1 Hz, J₂2.0 Hz, J₃1.9 Hz, 2H, C_{4,6}H), 7.36-7.15 (m, 12H, CHₐᵣ), 7.02 (d, ³J_{HH}=8.1 Hz, 2H, C_{1,9}H) 6.97 (s, 2H, ═CH), 4.61 (d, ²J_{PH}=4.7 Hz, CHP)

³¹P-NMR (CD₂Cl₂): δ=−13.4

MS (m/z, %): 628 (20, M⁺), 443 (100, M⁺- P(ph)₂), 316 (26), 189 (64, M⁺-2I, —P(Ph)₂), 183 (43)

### Example 36

### 10-Cyano-5H-dibenzo[a,d]cyclohepten-5-ol

Empirical formula:

C₁₆H₁₁NO

Molecular weight: 233.27

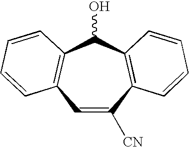

In a 500 ml round-bottomed flask with a Vigreux column and distillation apparatus connected therewith, 10-cyano-5H-dibenzo[a,d]cyclohepten-5-one (4.32 g, 18.6 mmol) was dissolved in 200 ml of isopropanol, and aluminum triisopropylate (5.30 g, 20.0 mmol) was added. The reaction mixture was heated to boil in such a way that the dropping rate on the condenser adapter was about 20 per minute. After 2 h, the mixture was poured onto ice, the precipitated hydrated aluminum hydroxides were redissolved by carefully adding 2 N hydrogen chloride, and the solution was extracted with dichloromethane. After drying over sodium sulfate, the solvent was distilled off, and the remaining residue was recrystallized from toluene to obtain the product as colorless rectangular parallelepipeds.

Yield: 4.20 g (96%)

M.p.: 142° C.

In the solution, there are both the endo and exo forms, which are interconverted by a rapid process and thus lead to broad signals. Therefore, assignment was only made partially.

¹H-NMR (CDCl₃): δ=7.84-7.66 (m, 4H), /0.59-7.47 (m, 2H), 7.43-7.29 (m, 3H), 5.27 (s(br), 1H, —CHOH), 3.13 (s(br), 1H, —OH)

MS (m/z, %): 233 (83, M⁺), 216 (84, M⁺—OH), 204 (100), 190 (65), 177 (83)

### Example 37

### 5-Chloro-10-cyano-5H-dibenzo[a,d]cycloheptene

Empirical formula:

C₁₆H₁₀ClN

Molecular weight: 251.72

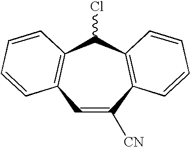

According to (II), the alcohol from Example 36 (2.33 g, 10.0 mmol) in 50 ml of chloroform was reacted with thionyl chloride (5 ml, 8.1 g, 68 mmol). The thus obtained pale yellow powder was sufficiently pure for the subsequent reaction. For analytical purposes, a small fraction thereof was recrystallized from toluene.

Yield: 2.44 g (97%)

M.p.: 147° C.

¹H-NMR (CDCl₃): δ=7.99-7.91 (m, 1H), 7.87 (s, 1H, —CH), 7.58-7.43 (m, 7H), 6.17 (s(br), 1H, CHCl)

MS (m/z, %): 251 (40, M⁺), 220 (92), 216 (84, M⁺—Cl), 189 (100), 165 (85)

### Example 38

### 10-Cyano-5-diphenylphosphanyl-5H-dibenzo[a,d]cycloheptene (^{CN}tropp^{Ph})

Empirical formula:

C₂₈H₂₀NP

Molecular weight: 401.45

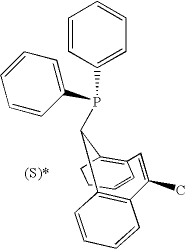

According to (III), diphenylphosphane [3] (1.75 ml, 1.86 g, 10 mmol) was reacted with the chlorine compound from Example 37 (2.52 g, 10.0 mmol) in 150 ml of toluene. The raw product was recrystallized from little toluene to obtain the racemic phosphane as a microcrystalline colorless powder.

Yield: 2.5 g (62%)

M.p.: 177° C.

MS (m/z, %): : 401 (36, M⁺), 216 (100, M⁺—P(Ph)₂), 183 (41)

¹H-NMR (CDCl₃): δ=7.79 (s, 1H, ═CH), 7.75 (dd, ³J_{HH}=7.5 Hz, ⁴J_{HH}=1.9 Hz, 1H, CHₐᵣ), 7.39-7.35.(m, 2H, CHₐᵣ), 7.28-7.15 (m, 12 H, CHₐᵣ), 7.04-6.94 (m, 3 H, CHₐᵣ), 4.83 (d, ²J_{PH}=5.1 Hz, —CHP)

### Example 39

### [Co(tropp)^{Ph})₂]

Empirical formula:

C₅₄H₄₂COP₂Ph₂

Molecular weight: 811.82

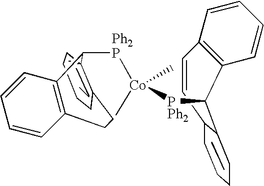

Aqueous cobalt(II) chloride (0.20 g, 1.5 mmol), 5-diphenylphosphanyl-5H-dibenzo[a,d]cycloheptene (1.20 g, 3.2 mmol) and zinc dust (0.5 g, 7.8 mmol) were admixed with 30 ml of THF. The reaction mixture was heated to boil for 45 min, during which the color of the cobalt(II) chloride turning from blue over olive-green to red, and a brown precipitate quickly formed. This precipitate was extracted repeatedly with boiling THF. Upon cooling, the complex was obtained in the form of brightly shining red-brown crystals.

Yield: 1.03 g (85%)

M.p.: 207-210° C.

UV (λₘₐₓ/nm): 350, 285 (THF)

### Example 40a

### [Ir(cod)(tropp^{Ph})]OTf

Empirical formula:

C₃₆H₃₃F₃IrO₃PS

Molecular weight: 825.92

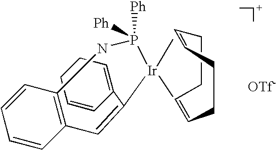

5-Diphenylphosphanyl-5H-dibenzo[a,d]cycloheptene (188 mg, 0.50 mmol) and [Ir(cod)₂]OTf (278 mg, 0.50 mmol) were reacted in accordance with (V). After covering the solution by a layer of hexane, the complex crystallized after some time in the form of deep-red shining needles.

Yield: 360 mg (88%)

M.p.: 190-195° C. (decomp.)

¹H-NMR (CD₂Cl₂): δ=7.64-7.58 (m, 2H, CHₐᵣ), 7.53-7.43 (m, 2H, CHₐᵣ), 7.40-7.28 (m, 8H, CHₐᵣ), 7.15-7.08 (m, 2H, CHₐᵣ), 6.98-6.86 (m, 2H, CHₐᵣ), 6.32 (d, J_{PH}=0.7 Hz, 2H, —CHₜᵣₒₚₚ), 5.80 (d, J_{PH}=14.6 Hz, 2H, CHP), 5.57 (s(br), 2H, ═CH_{cod}), 4.27 (s(br), 2H, —CH_{cod}), 2.57 (m(br), 4H, CH₂ cod), 2.11-1.77 (m(br), 4H, CH_{2 cod})

³¹P-NMR (CD₂Cl₂): δ=62.4

UV (λₘₐₓ/nm): 355 (CH₂Cl₂)

### Example 40b

### [Ir(cod)(tropp^{Cyc})]OTf

By analogy with Example 40a, 5-dicyclohexylphosphanyl-5H-dibenzo[a,d]cycloheptene (tropp^{Cyc}) (195 mg, 0.50 mmol) and [Ir(cod)₂]OTf (278 mg, 0.50 mmol) were reacted. After covering the solution by a layer of hexane, the product crystallized after some time in the form of red needles.

Yield: 315 mg (75%)

M.p.: 205-210° C. (decomp.)

¹H-NMR (CD₂Cl₂): δ=7.60-6.82 (m, 8H, CHₐᵣ), 6.30 (2H, ═CHₜᵣₒₚₚ), 5.77 (d, J_{PH}=15 Hz, H, CHP), 5.10-0.86 (m(br), 34H, cod+cyclohexyl)

³¹P-NMR (CD₂Cl₂): δ=60.8

### Example 41

### [Rh(cod)(tropp^{Ph})]PF₆

Empirical formula:

C₃₅H₃₃F₆P₂Rh

Molecular weight: 732.50

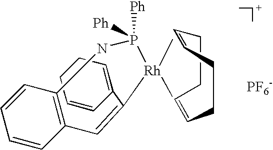

5-Diphenylphosphanyl-5H-dibenzo[a,d]cycloheptene (tropp^{Ph}) (188 mg, 0.50 mmol) and [Rh(cod)₂]PF₆ (232 mg, 0.50 mmol) were reacted in accordance with (V). After covering the solution by a layer of hexane, the complex precipitated from the reaction solution after some time in the form of deep-red shining crystals.

Yield: 340 mg (93%)

M.p.: 213-215° C. (decomp.)

¹H-NMR (CD₂Cl₂): δ=7.70 (d, ³J_{HH}=7.3 Hz, 2H, CHₐᵣ), 7.48 (m, 2H, CHₐᵣ), 7.43-7.30 (m, 8H, CHₐᵣ), 7.13-7.09 (m, 6H, CHₐᵣ), 6.74 (s, 2H, ═CHₜᵣₒₚₚ), 5.78 (s(br), 2H, ═CH_{cod}), 5.26 (d, ²J_{PH}=16.2 Hz, 1H, CHP), 4.49 (s(br), 2H, ═CH_{cod}), 2.62 (m(br), 4H, CH₂C_{cod}), 2.29 (m(br), 4H, CH_{2 cod})

³¹P-NMR (CD₂Cl₂): δ=87.4 (d, ¹J_{RhP}=157 Hz, −143.0 (sept, ³J_{PF}=712 Hz, PF₆⁻)

¹⁰³Rh-NMR (CD₂Cl₂): δ=345 (d)

UV (λₘₐₓ/nm): 351 (CH₂Cl₂)

### Example 42

### (2R,5R)-2,5-dimethylphospholane

Empirical formula:

C₆H₁₃P

Molecular weight: 116.14

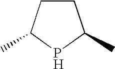

At −20° C., phenyl-(2R,5R)-2,5-dimethylphospholane (3.00 g, 15.5 mmol) was added dropwise and with vigorous stirring to a suspension of lithium powder (sodium content: 0.5%) (0.50 g, 72 mmol) in 20 ml of THF. Stirring was continued for 1 h at 0° C. After filtration from excess lithium, the deep-red solution was quenched with a few drops of degassed water. After distillation of the volatile components from the precipitated lithium hydroxide, the colorless solution of the raw product was subjected to fractional distillation over a Vigreux column.

Yield: 1.05 g (58%)

M.p.: 132° C.

¹H-NMR (CD₂Cl₂) δ=2.59-1.81 (m, 4H), 1.38-1.20 (m, 3H), 1.21 (d(br), ³J_{HH}=7.2 Hz, CH₃), 1.16 (d(br), ³J_{HH}=7.0 Hz, CH₃),

³¹P-NMR (CD₂Cl₂): δ=−27.5

### Example 43a

### 5-(2R,5R-2,5-dimethylphospholanyl)-5H-dibenzo[a,d]cycloheptene (R,R-tropphos^{Me})

Empirical formula:

C₂₁H₂₃P

Molecular weight: 306.39

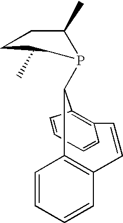

To a solution of 5-chloro-5H-dibenzo[a,d]cycloheptene (1.13 g, 5 mmol) in 10 ml of toluene, the phospholane from Example 42 (0.58 g, 5 mmol) was added at once, and the reaction mixture was stirred over night.

The hydrochloride was precipitated with 10 ml of hexane and filtered off. After the addition of diazabicyclooctane (DABCO, 280 mg, 2.5 mmol) in 10 ml of toluene, the mixture was stirred for 5 h to obtain the free phosphane by proton transfer. After further filtration, the solvent was removed under vacuum, and the raw product was recrystallized from 2 ml of acetonitrile to obtain the product in the form of colorless needles.

Yield: 0.98 g (64%)

M.p.: 125° C.

¹H-NMR (CDCl₃): δ=7.42-7.16 (m, 8H, CHₐᵣ), 7.04-6.92 (m, 2H, ═CH), 4.34 (d, ²J_{PH}=6.0 Hz, CHP), 2.13-1.93 (m, 3H, CHₐₗₖ), 1.69-1.51 (m, 2H, CHₐₗₖ), 1.20-1.08 (m, 1H, CHₐₗₖ), 1.05 (dd, ³J_{PH}=9.3 Hz, ³J_{HH}=7.0 Hz, 3H, CH_{3 exo}) 0.78 (dd, ³J_{PH}=17.8 Hz, ³J_{HH}=7.1 Hz, 3H, CH_{3 endo})

³¹P-NMR (CDCl₃): δ=5.6

MS (m/z, %): 306 (31, M⁺), 191 (100, dibenzotropylium⁺), 165 (26)

### Example 43b

### 5-(R,R)-dimethylphospholanyl-3,7-diiodo-5H-dibenzo[a,d]cycloheptene (R,R-_{I}tropphos^{Me})

Empirical formula:

C₂₂H₂₁I₂P

Molecular weight: 559.14

By analogy with Example 43a, 5-(R,R)-dimethylphospholane from Example 42 (0.68 g, 3.0 mmol) and the chlorine compound from Example 34 were reacted to obtain the product in the form of yellow needles.

Yield: 64%

¹H-NMR ((CD₂Cl₂): δ=7.49-7.15 (m, 6H, CHₐᵣ), 7,06-6.92 (m, 2H, ═CH), 4.35 (d, ²J_{PH}=5.9 Hz, CHP), 2.16-1.90 .(m, 3H, CHₐₗₖ), 1.70-1.48 (m, 2H, CHₐₗₖ), 1.20-1.05 (m, 1H, CHₐₗₖ), 1.08 (dd, ³J_{PH}=9.2 Hz, ³J_{HH}=7.1 Hz, 3H, CH_{3 exo}), 0.78 (dd, ³J_{PH}=18 Hz, ³J_{HH}=7Hz, 3H, CH_{3 endo})

³¹P-NMR (CD₂Cl₂): δ=−13.0

### Example 44

### [Ir(cod)(R,R-tropphos^{Me})]OTf

Empirical formula:

C₃₀H₃₅F₃IrO₃PS

Molecular weight: 755.86

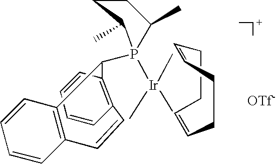

In accordance with (V), [Ir(cod)₂]OTf (108 mg, 0.2 mmol) was reacted with the phosphane from Example 43 (62 mg, 0.2 mmol). Cautiously covering the solution by a layer of hexane yielded the enantiomerically pure complex in the form of deep-red needles.

Yield: 142 mg (94%)

M.p.: 162-167° C. (decomp.)

¹H-NMR (CD₂Cl₂): δ=7.69 (ddd, ³J_{HH}=7.9 Hz, ⁴J_{HH}=1.4 Hz, ⁴J_{HH}=0.5 Hz, 1H, CHₐᵣ), 7.55 (td, ³J_{HH}=7.4 Hz, ⁴J_{HH}=1.3 Hz, 1H, CHₐᵣ), 7.52-7.47 (m, 1H, CHₐᵣ), 7.42-7.39 (m, 1H, CHₐᵣ), 7.39-7.34 (m, 1H, CHₐᵣ), 7.33 (m, 1H, CHₐᵣ), 7.31 (m, 1H, CHₐᵣ), 7.28 (m, 1H, CHₐᵣ), 6.66 (d, ³J_{PH}=9.0 Hz, 1H, ═CHₜᵣₒₚₚ), 6.13 (s(br), 1H, ═CH_{cod}), 5.56 (d, ²J_{PH}=13.4 Hz, CHP), 5.44 (dd, ³J_{PH}=9.0 Hz, J₂=2.1 Hz, 1H, ═CHₜᵣₒₚₚ), 5.42 (s(br), 1H, ═CH_{cod}), 4.64 (s(br), 1H, —CH_{cod}), 3.84 (s(br), 1H, ═CH_{cod}), 2.75-2.55 (m, 2H, CHₐₗₖ), 2.51-2.08 (m, 8H, CHₐₗₖ), 2.01-1.68 (m, 2H, CHₐₗₖ), 1.37-1.09 (m, 2H, CHₐₗₖ), 0.73 (dd, 3J_{PH}=13.6 Hz, 3J_{HH}=6.8 Hz, 3H, CH₃), 0.61 (dd, ³J_{PH}=16.8 Hz, ³J_{HH}=6.8 Hz, 3H, CH₃)

³¹P-NMR (CD₂Cl₂): δ=86.9

UV (λₘₐₓ/nm): 472, 413, 355 (CH₂Cl₂)

### Example 45

### Diphenyl[3-(phenylphosphanyl)propyl]phosphane

Empirical formula:

C₂₁H₂₂P₂

Molecular weight: 336.35

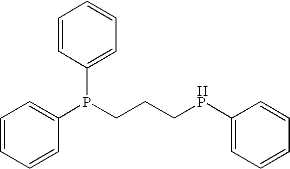

To a solution of phenylphosphane (3.58 g, 32.5 mmol) in 30 ml of THF, butyl-lithium solution (20.3 ml, 32.5 mmol, 1.6 M in hexane) was added dropwise at −15° C. An orange solution formed which was stirred in an ice bath for another 1 h and then brought to room temperature. To this solution, a solution of (3-chloropropyl)diphenylphosphane (8.55 g, 32.5 mmol) in 30 ml of THF was added dropwise at room temperature. A slightly exothermic reaction ensued, and the orange lithium phenylphosphide solution became colorless. After 1 h, 0.5 ml of MeOH was added, and the solvent was removed under vacuum. From the residue, the product was isolated as a colorless oil by vacuum distillation.

Yield: 9.50 g (87%)

M.p.: 188-195° C./high vacuum

H-NMR (250.1 MHz, CDCl₃): δ=7.52-7.42 (m, 6H, CHₐᵣ), 7.39-7.32 (m, 9H, CHₐᵣ), 4.26 (s, br, n_{1/2}=30 Hz, 1H, PH), 2.22-2.16 (m, 2H, CH_{2bridge}), 2.04-1.97 (m, 2H, CH_{2bridge}), 1.79-1.59 (m, 2H, CH_{2bridge})

³¹P-NMR (101.3 MHz, CDCl₃): δ=−16.4 (-CH₂PPh₂), -53.0 (—CH₂PHPh) (¹H-coupled as s, n1/2=36 Hz s)

MS (m/z, %): 336 (24, M⁺), 294 (35), 259 (100, M—Ph⁺), 224 (28), 199 (60), 183 (44), 108 (66), 91 (42), 78 (20)

### Example 46

### 5-[(3-Diphenylphosphanylpropyl)phenylphosphanyl]-5H-dibenzo[a,d]-cycloheptene (tropp^{Ph,(CH2)3PPh2})

Empirical formula:

C₃₆H₃₂P₂

Molecular weight: 526.60

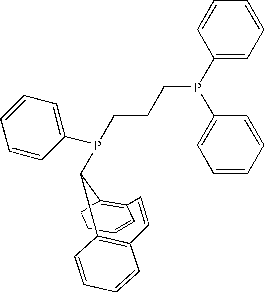

To a solution of 5-chloro-5H-dibenzo[a,d]cycloheptene (1.439 g, 6.35 mmol) in 30 ml of toluene, a solution of diphenyl[3-(phenylphosphanyl)propyl]phosphane (2.14 g, 6.35 mmol) in 10 ml of toluene was added at room temperature. A colorless crystalline precipitate formed which redissolved when subsequently heated (1 h, reflux). To this solution, 30 ml of saturated potassium carbonate solution was added, and the organic phase was separated off. The aqueous phase was extracted twice with 10 ml of toluene, and the combined toluene phases were dried and concentrated to obtain the racemic product as a white solid which still contained a little P-oxide as a contaminant. A pure product was obtained by recrystallization from hot toluene.

Yield: 1.605 g (48%) as very fine white needles

M.p.: 133° C.

¹H-NMR (250.1 MHz, CDCl₃): δ=7.31-7.15 (m, 20H, CHₐᵣ), 7.06 (dddd, J=7.4 Hz, J=7.4 Hz, J=1.2 Hz, J=1.2 Hz, 1H,CHₐᵣ), 6.93 (s, 1H, CH_{olefin}), 6.92 (s, 1H, CH_{olefin}), 6.90-6.84 (m, 1H, CHₐᵣ), 6.39 (ddd, J=7.6 Hz, J=1.2 Hz, J=1.2 Hz, 1H, CHₐᵣ), 4.08 (d, ²J_{PH}=6.6 Hz, 1H, CH_{benzyl}), 2.06-1.84 (m, 3H, CH_{2bridge}), 1.47-1.16 (m, 3H, CH_{2bridge})

³¹P-NMR (121.5 MHz, CDCl₃): δ=−16.4 (s, PPh₂⁺), −24.2 (s, TROPP)

MS (m/z, %): 526 (2, M⁺), 335 (100, PhP(CH₂)₃PPh₂⁺), 191 (83), 183 (24), 109 (12)

### Example 47

### Diphenyl[4-(phenylphosphanyl)butyl]phosphane

Empirical formula:

C₂₂H₂₄P₂

Molecular weight: 350.38

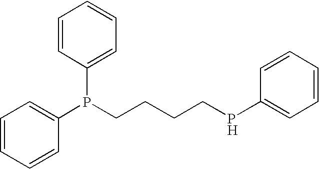

A solution of lithium diphenylphosphide freshly prepared from diphenylphosphane (3.32 g, 17.8 mmol) and butyllithium (11.1 ml, 17.8 mmol, 1.6 M in hexane) in 30 ml of THF was added dropwise to a solution of 1-chloro-4-iodobutane (3.89 g, 17.8 mmol) in 30 ml of THF at −78° C. The solution became completely colorless. Thereafter, the solution of (4-chlorobutyl)diphenylphosphane was added dropwise to a solution of lithium phenylphosphide (17.8 mmol) in 40 ml of THF cooled to −15° C. The solution was brought to room temperature, concentrated, and the product was isolated as a colorless oil from the residue by vacuum distillation.

Yield: 5.06 g (81%)

M.p.: 190° C./high vacuum

¹H-NMR (250.1 MHz, CDCl₃): δ=7.50-7.38 (m, 6H, CHₐᵣ), 7.35-7.30 (m, 9H, CHₐᵣ), 4.26 (ddd, ¹J_{PH}=211 Hz, J=6.5 Hz, J=6.5 Hz, 1H, PH), 2.06-2.00 (m, 2H, CH_{2bridge}), 1.87-1.72 (m, 2H, CH_{2bridge}), 1.67-1.46 (m, 4H, CH_{2bridge})

³¹P-NMR (101.3 MHz, CDCl₃): δ=−15.7 (-CH₂PPh₂), −51.3 (—CH₂PHPh) (¹H-coupled as d, ¹J_{PH}=211 Hz)

MS (m/z, %): 550 (52, M⁺), 273 (100, M—Ph⁺), 241 (76), 183 (78), 109 (78)

### Example 48

### 5-[(4-Diphenylphosphanylbutyl)phenylphosphanyl]-5H-dibenzo[a,d]-cycloheptene (tropp^{Ph,(CH2)4PPh2})

Empirical formula:

C₃₇H₃₄P₂

Molecular weight: 540.62

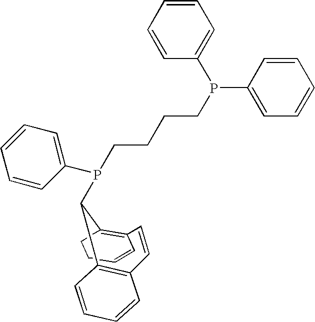

To a solution of diphenyl[4-(phenylphosphanyl)butyl]phosphane (1.345 g, 3.84 mmol) in 30 ml of toluene, a solution of 5-chloro-5H-dibenzo[a,d]cycloheptene (870 mg, 3.84 mmol) in 40 ml of toluene was added at −15° C. The solution was stirred at room temperature over night, and then 20 ml of saturated potassium carbonate solution was added. The organic phase was separated off, and the aqueous phase was extracted twice with 10 ml of toluene. The combined toluene phases were dried over sodium sulfate and concentrated to obtain a yellow oil from which the quaternary phosphonium salts and phosphane oxides could be precipitated with Et₂O and filtered off. From a solution of the product in toluene, the racemic product could be obtained in the form of white crystal needles by covering the solution by a layer of hexane.

Yield: 642 mg (31%)

M.p.: 139° C.

¹H-NMR (300.1 MHz, CDCl₃): δ=7.39-7.18 (m, 20H, CHₐᵣ), 7.06 (ddd, J=7.5 Hz, J=1.2 Hz, J=1.2 Hz, 1H, CHₐᵣ), 6.95 (s, 1H, CH_{olefin}), 6.94 (s, 1H, CH_{olefin}), 6.91-6.86 (m, 1H, CHₐᵣ), 6.40 (ddd, J=7.6 Hz, J=1.2 Hz, J=1.2 Hz, 1H, CHₐᵣ), 4.09 (d, ²J_{PH}=6.5 Hz, 1H, CH_{benzyl}), 1.88-1.75 (m, 3H, CH_{2bridge}), 1.42-1.19 (m, 4H, CH_{2bridge}), 1.16-1.00 (m, 1H, CH_{2bridge})

³¹P-NMR (121.5 MHz, CDCl₃): δ=−15.5 (s, PPh2), −23.1 (s, TROPP)

### Example 49

### 5-{[(Diisopropylphosphanyl)methyl]isopropylphosphanyl}-5H-dibenzo[a,d]cycloheptene (tropp^{iPr(CH2)PiPr2})

Empirical formula:

C₂₅H₃₄P₂

Molecular weight: 396.49

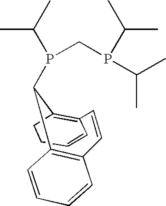

Diisopropyl[(isopropylphosphanyl)methyl]phosphane (1.031 g, 5.00 mmol) was added to a solution of 5-chloro-5H-dibenzo[a,d]cycloheptene (1.134 g, 5.00 mmol) in 40 ml of toluene, and the mixture was heated under reflux for 2 hours. Thereafter, 20 ml of saturated potassium carbonate solution was added, and the organic phase was separated off, dried over sodium sulfate and concentrated to obtain a colorless oil which was taken up in a little THF. By adding acetonitrile and cooling the solution, the product was obtained in the form of white crystals.

Yield: 1.090 g (55%)

M.p.: 130° C.

¹H-NMR (250.1 MHz, CDCl₃): δ=7.32-7.14 (m, 8H, CHₐᵣ), 6.92 (s, 1H, CH_{olefin}), 6.91 (s, 1H, CHolefn), 4.14 (d, J=5.4 Hz, 1H, CH_{benzyl}), 1.60-1.46 (m, 3H, CH_{3iPr}), 1.36 (dd, J=13.9 Hz, J=3.4 Hz, 1H, PCH₂P), 1.06-0.91 (m, 12H,. CH₃), 0.83 (dd, J=12.2 Hz, J=7.2 Hz, 6H, CH_{3iPr}), 0.85 (m, 1H, PCH₂P)

³¹P-NMR (101.3 MHz, CDCl₃): δ=−1.7 (d, 2J_{PP}=108.8 Hz, CH₂PiPr₂), −17.5 (d ²J_{PP}=108.5 Hz, TROPP)

MS (m/z, %): 396 (20, M⁺), 354 (100, M⁺-iPr), 311 (35), 205 (70,iPrPCH₂P(iPr)₂⁺), 191 (59), 163 (52), 131 (23), 78 (17), 43 (28)

### Example 50

### Trifluoroacetic acid 5H-dibenzo[a,d]cyclohepten-5-yl ester

Empirical formula:

C₁₇H₁₁F₃O₂

Molecular weight: 304.26

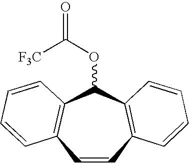

To 5-hydroxy-5H-dibenzo[a,d]cycloheptene (343 mg, 1.65 mmol) in 10 ml of CH₂CI₂, trifluoroacetic anhydride (744 mg, 3.54 mmol, about 2.1 eq.) was added at 0° C. to yield a red solution, which was stirred at 0° C. for another 10 min and then concentrated to obtain a red oil from which the product was isolated in the form of fine needles by sublimation (100° C., oil bath, high vacuum).

Yield: 459 mg (91%)

M.p.: 139° C.

¹H-NMR (300.1 MHz, CDCl₃): δ=7.58 (d, J=7.7 Hz, 2H, CHₐᵣ), 7.47-7.36 (m, 6H, CHₐᵣ), 7.12 (s, 2H, CH_{olefin}), 6.78 (br, 1H, CH_{benzyl})

¹⁹F-NMR (282.4 MHz, CDCl₃): δ=−75.4 (s, 3F, OCOCF₃)

MS (m/z, %): 304 (30, M⁺), (191, TROP⁺), 178 (6)

### Example 51

### 5-Bis(dimethylamino)phosphanyl-10,11-dihydro-5H-dibenzo[a,d]cycloheptene (H₂tropp^{NMe2})

Empirical formula:

C₁₉H₂₅N₂P

Molecular weight: 312.39

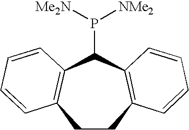

To 10,11-dihydro-5H-dibenzo[a,d]cycloheptene (10.55 g, 54.30 mmol) in THF (50 ml), butyllithium (36 ml, 1.6 M in hexane, 1.05 eq.) was added. This yielded a deep-red emulsion, which was stirred at room temperature for 1 h. Thereafter, the lithium compound was added dropwise to a cooled (−78° C.) solution of bis(dimethylamino)chlorophosphane (8.39 g, 54.30 mmol) in 100 ml of THF to obtain a colorless solution, which was brought to room temperature and concentrated under vacuum. The residue was taken up in toluene, filtered through Celite and again concentrated to obtain the product as a colorless crystalline solid, which was washed with a little hexane and dried under high vacuum.

Yield: 11.20 g (66%)

M.p.: 69° C.

¹H-NMR (300.1 MHz, CDCl₃): δ=7.18-7.05 (m, 8H, CHₐᵣ), 4.52 (d, ²J_{PH}=3.3 Hz, 1H, CH_{benzyl}), 4.03-3.89 (m, 2H, CH₂), 2.96-2.83 (m, 2H, CH₂), 2.63 (d, ⁴J_{PH}=8.8 Hz, 12H, NCH₃)

³¹P-NMR (121.5 MHz, CDCl₃): δ=99.2 (s)

### Example 52

### 5-Chlorodimethylaminophosphanyl-10,11-dihydro-5H-dibenzo[a,d]cycloheptene (H₂tropp^{Cl,NMe})

Empirical formula:

C₁₇H₁₉ClNP

Molecular weight: 303.77

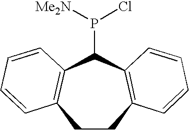

To a solution of 5-bis(dimethylamino)phosphanyl-10,11-dihydro-5H-dibenzo[a,d]-cycloheptene from Example 51 (3.88 g, 12.4 mmol) in 10 ml of CH₂Cl₂, phosphorus trichloride (1.71 g, 12.4 mmol) was added dropwise at 0° C. to yield a pale yellow solution, which was stirred first at room temperature for 1 h and then at 70° C. for 1 h after the solvent had been evaporated. Thereafter, dimethylaminodichlorophosphane was evaporated under vacuum, and the product was purified by vacuum distillation.

Yield: 3.39 g (90%)

M.p.: 140-150° C., 0.001 mbar

¹H-NMR (250.1 MHz, CDCl₃): δ=7.32-7.0 (m, 8H, CHₐᵣ), 4.59 (d, ²J_{PH}=1.6 Hz, 1H, CH_{benzyl}), 3.93-3.77 (m, 1H, CH₂), 3.73-3.60 (m, 1H, CH₂), 3.03-2.84 (m, 2H, CH₂), 2.73 (d, ⁴J_{PH}=11.9 Hz, 6H, NCH₃)

³¹P-NMR (101.3 MHz, CDCl₃): δ=148.1

### Example 53

### (4S,5R)-2-(5H-Dibenzo[a,d]cycloheptyl)-3,4-dimethyl-5-phenyl-1,3,2-oxazaphospholidine*borane (tropp^{(-)ephedrine})

Empirical formula:

C₂₅H₂9BNOP

Molecular weight: 401.30

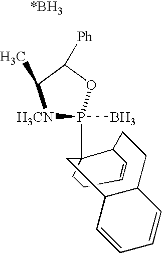

To (2R,4S,5R)-2-chloro-3,4-dimethyl-5-phenyl-1,3,2-oxazaphospholidine (1.236 g, 5.38 mmol) in 20 ml of THF, a solution of lithiated dibenzo[a,d]cycloheptane (cf. Example 51) (5.38 mmol) in 25 ml of THF was added dropwise at −18° C. over 20 min. This caused the deep-red solution of the dibenzo[a,d]cycloheptyl anion to become colorless immediately. The solution was stirred at room temperature for another 1 h. Reaction monitoring by ³¹P NMR showed, in addition to the main product (δ=163.6 ppm), a second product with about 15% intensity (δ=151.3 ppm). The solution was again brought to 0° C., and borane-dimethyl sulfide adduct (2.7 ml, 2.0 M in toluene, 5.4 mmol) was added. The solution was stirred at room temperature for another 1 h and then concentrated under vacuum. The product was taken up in 20 ml of CH₂Cl₂, filtered through Celite® and crystallized from CH₂Cl₂/toluene.

Yield: 1.264 g (59%) as colorless crystals

M.p.: 179° C.

¹H-NMR (300.1 MHz, CDCl₃): δ=7.32-7.13 (m, 11H, CHₐᵣ), 6.99-6.93 (m, 2H, CHₐᵣ), 5.53 (d, J=6.4 Hz, 1H, OCHPh), 4.48 (d, ²J_{PH}=15.9 Hz, 1H, CH_{benzyl}), 3.84-3.74 (m, 1H, CH₂), 3.65-3.56 (m, 1H, CH₂), 3.44-3.31 (m, 1H, CHCH₃), 3.06-2.84 (m, 2H, CH₂), 2.73 (d, J=6.7 Hz, 3H, NCH₃), 0.5 (br, dd, J=65 Hz, J=160 Hz, 3H, BH₃), 0.35 (d, J=6.7 Hz, 3H, CH₃)

³¹P-NMR (121.5 MHz, CDCl₃): δ=154.8 (br, pseudo d, ¹J_{BP}=86 Hz)

### Example 54

### (10,11-Dihydro-5H-dibenzo[a,d]cyclohepten-5-yl)methylphenylphosphane*BH₃

Empirical formula:

C₂₂H₂₄BP

Molecular weight: 330.22

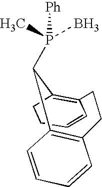

A deep-red solution of lithiated 10,11-dihydrodibenzo[a,d]cycloheptene (cf. Example 51) (7 mmol) in 30 ml of THF was added dropwise at −78° C. to a freshly prepared solution of (Rp)-chloromethylphenylphosphane (7 mmol) in 180 ml of toluene. This caused the solution to become colorless immediately. The solvent was evaporated under vacuum, and the residue was taken up in toluene, filtered off from the lithium chloride through Celite®, and concentrated to obtain the product in the form of white crystals.

Yield: 1.677 g (57%) as colorless crystals

M.p.: 155° C.

¹H-NMR (300.1 MHz, CDCl₃): δ=7.51-7.31 (m, 5H, CHₐᵣ), 7.27-7.07 (m, 6H, CHₐᵣ), 6.97 (dd, J=7.5 Hz, J=7.5 Hz, 1H,CHₐᵣ), 6.71 (d, J=7.7 Hz, 1H, CHₐᵣ), 4.64 (d, ²J_{PH}=17.5 Hz, 1H, CH_{benzyl}), 3.49-3.36 (m, 1H, CH₂), 3.28-3.17 (m, 1H, CH₂), 2.80-2.67 (m, 2H, CH₂), 1.49 (d, ²J_{PH}=9.0 Hz, 3H, CH₃), 0.78 (pseudo q, J=90 Hz, 1H, BH₃)

¹¹B-NMR (96.3 MHz, CDCl₃): δ=−34 (d, ¹J_{BP}=50 Hz)

³¹P-NMR (121.5 MHz, CDCl₃): δ=21.0 (br, pseudo d, ¹J_{BP}=65 Hz)

MS (m/z, %): 330 (60, M⁺), 327 (65), 316 (14, M⁺—BH₃), 193 (100,TROPH₂), 178 (89)

### Example 55

### (10,11-Dihydro-5H-dibenzo[a,d]cyclohepten-5-yl)methylphenylphosphane (H₂tropp^{Me,Ph})

Empirical formula:

C₂₂H₂₁P

Molecular weight: 316.39

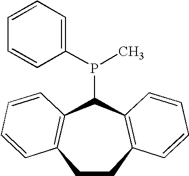

To (10,11-dihydro-5H-dibenzo[a,d]cyclohepten-5-yl)methylphenylphosphane*BH₃ from Example 54 (310 mg, 0.939 mmol), 10 ml of morpholine was added, and the resulting clear solution was stirred at room temperature for 2 h. Concentrating this solution under vacuum yielded a white solid, which was taken up in toluene and filtered over an about 5 cm thick layer of alumina N. Concentrating and recrystallizing from hexane/methylene chloride yielded the product in the form of white crystals.

Yield: 268 mg (90%)

M.p.: 125° C.

¹H-NMR (300.1 MHz, CDCl₃): δ=7.35-7.21 (m, 5H, CHₐᵣ), 7.19-7.07 (m, 5H, CHₐᵣ), 7.00 (dd, J=7.4 Hz, J=7.4 Hz, 1H,CHₐᵣ), 6.68 (dd, J=7,5 Hz, J=7.5 Hz, 1H, CHₐᵣ), 6.16 (d, 7.5 Hz, 1H, CHₐᵣ), 4.14-4.03 (m, 1H, CH₂) 3.97 (d, ²J_{PH}=6.5 Hz, 1H, CH_{benzyl}), 3.95-3.89 (m, 1H, CH₂), 3.02-2.87 (m, 2H, CH₂), 2.73 (d, ⁴J_{PH}=5.1 Hz, 3H, CH₃)

³¹P-NMR (121.5 MHz, CDCl₃): δ=−19.1 (s)

MS (m/z, %): 316 (8, M⁺), 281 (6), 207 (40),.193 (100,TROPH₂⁺), 178 (25), 165 (10)

### Example 56

### (5H-Dibenzo[a,d]cyclohepten-5-yl)methylphenylphosphane*borane

Empirical formula:

C₂₂H₂₂BP

Molecular weight: 328.19

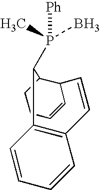

To dibenzo[a,d]cycloheptene (663 mg, 3.45 mmol) and lithium diisopropylamide (370 mg, 3.45 mmol) and potassium tert-butanolate (332 mg, 3.45 mmol), 20 ml of THF was added at −78° C. The deep-red solution was stirred at low temperature for 1 h (at room temperature, the trop anion will decompose within a few minutes to form black products) and then added dropwise to a freshly prepared solution of (Rₚ)-chloromethylphenylphosphane*borane (3.45 mmol) cooled to −78° C. Thereafter, the solution was brought to room temperature and concentrated under vacuum. The residue was taken up in toluene and filtered. Concentrating this toluene solution yielded the product as a white powder.

Yield: 645 mg (57%)

M.p.: 134° C.

¹H-NMR (300.1 MHz, CDCl₃): δ=7.44-7.38 (m, 1H, CHₐᵣ), 7.31-7.10 (m, 11H, CHₐᵣ), 7.01-6.98 (m, 1H, CHₐᵣ), 6.42 (s, 1H, CH_{olefin}), 6.42 (s, 1H, CH_{olefin}), 4.47 (d, ²J_{PH}=13.9 Hz, 1H, CH_{benzyl}), 1.44 (d, ²J_{PH}=9.7 Hz, 3H, CH₃), 0.59 (pseudo dd, J=84 Hz, J=190 Hz, 1H, BH₃)

³¹P-NMR (121.5 MHz, CDCl₃): δ=20.9 (br, pseudo d, ¹J_{BP}=70 Hz)

¹¹B-NMR (96.3 MHz, CDCl₃): δ=−35 (d, ¹J_{BP}=55 Hz)
   MS (m/z, %): 328 (35, M⁺), 191 (100, TROP⁺), 165 (16), 135 (15), 121 (12), 89 (12)

### Example 57

### (5H-Dibenzo[a,d]cyclohepten-5-yl)methylphenylphosphane (tropp^{Ph,Me})

Empirical formula:

C₂₂H₁₉P

Molecular weight: 314.36

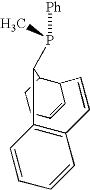

5-Methylphenylphosphanyl)-5H-dibenzo[a,d]cycloheptene*borane from Example 56 (550 mg, 1.75 mmol) was dissolved in 3 ml of morpholine and stirred for 1 h. The excess morpholine was evaporated under vacuum, and the product was separated from the borane-morpholine adduct by filtration over alumina N (toluene). Concentrating under vacuum yielded the product as a white powder.

Yield: 523 mg (92%)

M.p.: 118° C.

¹H-NMR (300.1 MHz, CDCl₃): δ=7.34-7.09 (m, 11H, CHₐᵣ), 6.96 (s, 1H, CH_{olefin}), 6.96 (s, 1H, CH_{olefin}), 6.45 (ddd, J=7.7 Hz, J=1.2 Hz, J=1.2 Hz, 1H, CHₐᵣ), 3.96 (d,²J_{PH}=6.9 Hz, 1H, CH_{benzyl}), 1.08 (d, ²J_{PH}=9.7 Hz, 3H, CH₃)

³¹P-NMR (121.5 MHz, CDCl₃): δ=−34.0 (s)

MS (m/z, %): 314 (32, M⁺), 191 (100, TROP⁺), 165 (9)

### Example 58

### (S)-4-(10,11-Dihydro-5H-dibenzo[a,d]cyclohepten-5-yI)-3,5-dioxa-4-phosphacyclohepta[2,1-a3,4.a′]dinaphthalene (S)-(H₂tropp^{ONp})

Empirical formula:

C₃₅H₂₅O₂P

Molecular weight: 508.56

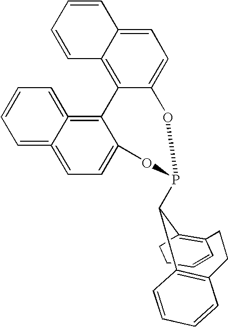

To a solution of 10,11-dihydro-5H-dibenzo[a,d]cycloheptene (2.146 g, 11.0 mmol) in 30 ml of THF, a solution of butyllithium (6.90 ml, 11.0 mmol, 1.6 M in hexane) was added at 0° C. to form a deep-red solution which was brought to room temperature and stirred for another 1 h. This solution was then added dropwise over 30 min at −78° C. to a solution of 4-chloro-(S)-3,5-dioxa-4-phosphacyclohepta[2,1-a3,4.a′]dinaphthalene (3.875 g, 11.0 mmol) in 30 ml of THF. The organolithium compound reacted immediately, and a colorless solution was obtained. It was brought to room temperature and concentrated. The product was taken up in toluene, filtered from the precipitated lithium chloride over Celite®, and concentrated. The solution was concentrated, and the product was obtained from Et₂O as a white powder.

Yield: 2.82 g (50%)

M.p.: 208° C.

¹H-NMR (250.1 MHz, CDCl₃): δ=8.03-7.90 (m, 4H, CHₐᵣ), 7.53-6.91 (m, 16H, CH₂), 4.39 (d, ²J_{PH}=2.4 Hz, 1H, CH_{benzyl}), 4.21-4.08 (m, 1H, CH₂), 3.58-3.47 (m, 1H, CH₂), 3.14-2.90 (m, 1H, CH₂)

³¹P-NMR (101.3 MHz, CDCl₃): δ=188.8

MS (m/z, %): 508 (5, M⁺), 315 (16, (NpO)₂P⁺), 193 (100, TROPH₂⁺), 178 (12), 115 (11), 91 (10)

### Example 59

### (R)-4-(5H-Dibenzo[a,d]cyclohepten-5-yl)-3,5-dioxa-4-phosphacyclohepta[2,1-a3,4.a′]dinaphthalene (R)-(tropp^{ONp})

Empirical formula:

C₃₅H₂₃O₂P

Molecular weight: 506.53

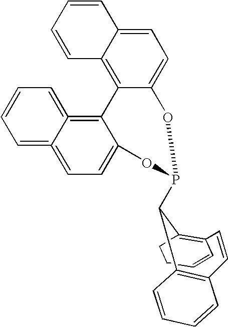

To 10,11-dihydro-5H-dibenzo[a,d]cycloheptene (1.00 g, 5.20 mmol) and lithium diisopropylamide (557 mg, 5.20 mmol) and potassium tert-butanolate (583 mg, 5.20 mmol), 30 ml of THF was added at −78° C. The deep-red solution was stirred for 1 h at low temperature and then added dropwise to a freshly prepared solution of (R)-4-chloro-3,5-dioxa-4-phosphacyclohepta[2,1-a3,4.a′]dinaphthalene (1.832 g, 5.20 mmol) cooled to −78° C. The solution was then brought to room temperature and concentrated under vacuum. The residue was taken up in toluene and filtered through alumina N. The toluene solution was concentrated, and hexane was added to obtain the product as a white powder.

Yield: 1.16 g (44%)

M.p.: 150° C.

¹H-NMR (121.5 MHz, CDCl₃): δ=7.99 (d, br, J=7.7 Hz, 1H, CHₐᵣ), 7.96 (d, J=8.6 Hz,1H, CHₐᵣ), 7.87 (d, J=8.9 Hz, 1H, CHₐᵣ), 7.86 (d, J=8.1 Hz, 1H, CHₐᵣ), 7.50-7.20 (m, 15H, CHₐᵣ), 7.05 (dd, J=8.6 Hz, J=0.7 Hz, 1H, CHₐᵣ), 7.01 (s, 2H, CH_{olefin}), 4.27 (d, J=2.3 Hz, 1H, CH_{benzyl})

³¹P-NMR (121.5 MHz, CDCl₃): δ=190.9

MS (m/z, %): 506 (85, M⁺), 332 (20), 286 (27), 191 (100, TROP⁺)

### Example 60

### 10-Methoxydibenzo[a,d]cyclohepten-5-one

To potassium (3.91 g, 100 mmol) in 100 ml of 1,4-dioxan, methanol (6.41 g, 8.11 ml, 200 mmol) was carefully added. After the formation of alcoholate was completed, 10-bromodibenzo[a,d]cyclohepten-5-one (5.70 g, 20 mmol) was added, and the suspension was brought to 100° C. for 30 min during which gas was released. Thereafter, the suspension was brought to room temperature, concentrated in vacuum and extracted three times with 100 ml each of TBME. The organic phase was washed with saturated NaCl, dried over Na₂SO₄ and concentrated to obtain the product as a white solid, which was purified by recrystallization from CH₂Cl₂/hexane.

Yield: 4.43 g (93%) as white microcrystals

M.p.: 139° C.

TLC (silica, toluene): R_{f}=0.22

¹H-NMR (300.1 MHz, CDCl₃): δ=7.80-7.60 (br, 3H, CHₐᵣ), 7.48-7.42 (m, 1H, CHₐᵣ), 7.34-7.15 (m, br 4H, CHₐᵣ), 6.36 (s, 1H, CH_{olefin}), 5.28 (s, br, 1H, CH_{benzyl}), 3.96 (s, 3H, OCH₃), 2.49 (s, br, 1H, OH)

MS (m/z, %): 238 (100, M⁺), 223 (40), 207 (56), 195 (38), 178 (80), 165 (75), 152 (22), 89 (15)

### Example 61

### 10-Methoxy-5H-dibenzo[a,d]cyclohepten-5-ol

Empirical formula:

C₁₆H₁₄O₂

Molecular weight: 238.29

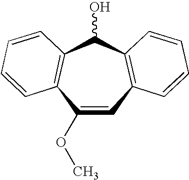

To 10-methoxydibenzo[a,d]cyclohepten-5-one from Example 60 (1.825 g, 7.72 mmol) and aluminum isopropylate (1.578 g, 7.72 mmol), 50 ml of isopropanol was added in a microstill, and the suspension was slowly heated to boil. Within 3 hours, about 30 ml of acetone/isopropanol was distilled off. Thereafter, the reaction solution was poured on about 100 g of ice and extracted three times with 30 ml of CH₂Cl₂. The organic phase was dried over Na₂SO₄ and concentrated to obtain a white solid, which was purified by FC (silica/toluene).

Yield: 890 mg (48%) as white microcrystals

### Example 62

### 5-Chloro-10-methoxy-5H-dibenzo [a,d]cycloheptene

Empirical formula:

C₁₆H₁₃ClO

Molecular weight: 256.73

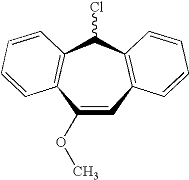

To a solution of 10-methoxy-5H-dibenzo[a,d]cyclohepten-5-ol (765 mg, 3.21 mmol) in 20 ml of toluene, thionyl chloride (2 ml, 27.4 mmol) was added dropwise at −18° C. The yellow solution was brought to room temperature and stirred over night. After the solvent had been evaporated, a beige powder remained. The product was washed with hexane and dried under high vacuum.

Yield: 705 mg (85%) as a light beige powder

M.p.: 148° C.

¹H-NMR (300.1 MHz, CDCl₃): main isomer δ=7.93-7.90 (m, 1H, CHₐᵣ), 7.46-7.17 (m, 7H, CHₐᵣ), 6.44 (s, 1H, CH_{olefin}), 6.18 (s, 1H, CH_{benzyl}), 4.00 (s, 3H, OCH₃), minor isomer δ=7.87-7.78 (m, 2H, CHₐᵣ), 7.67 (m, 1H, CHₐᵣ), 7.46-7.17 (m, 5H, CHₐᵣ), 6.39 (s, 1H, CH_{olefin}), 6.57 (s, 1H, CH_{benzyl}), 3.97 (s, 3H, OCH₃). In CDCl₃, the product exists as a mixture of endo and exo forms.

MS (m/z, %): 256 (21, M⁺), 221 (100, ^{MeO}Trop+), 178 (92), 152 (17), 89 (12)

### Example 63

### (10-Methoxy-5H-dibenzo[a,d]cyclohepten-5-yl)diphenylphosphane (^{MeO}tropp^{Ph})

Empirical formula:

C₂₈H₂₃OP

Molecular weight: 406.47

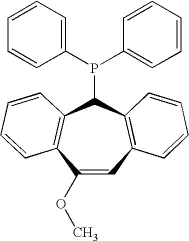

To 5-chloro-10-methoxy-5H-dibenzo[a,d]cycloheptene from Example 62 (1.284 g, 5 mmol) in 30 ml of toluene, a solution of diphenylphosphane (930 mg, 5 mmol) in 20 ml of toluene was added. After 1 h, 30 ml of saturated degassed sodium carbonate solution was added, and the solution was vigorously stirred for 10 min. The organic phase was separated off, dried over magnesium sulfate, and concentrated. Repeated recrystallizations from acetonitrile yielded the product in the form of white needles.

Yield: 564 mg (28%)

M.p.: 125° C.

¹H-NMR (300.1 MHz, CDCl₃): δ=7.73-7.70 (m, 1H, CHₐᵣ), 7.29-7.07 (m, 14H, CHₐᵣ), 7.00-6.92 (m, 3H, CHₐᵣ), 6.34 (s, 1H, CH_{olefin}), 4.79 (d, ²J_{PH}=6.1 Hz, 1H, CH_{benzyl}), 4.04 (s, 3H, OCH₃)

³¹P-NMR (121.5 MHz, CDCl₃): δ=−12.33 (s)

MS (m/z, %): 406 (12, M⁺), 391 (36), 221 (100, ^{MeO}Trop⁺), 178 (95), 152 (17)

### Example 64

### Dicyclohexyl(10-methoxy-5H-dibenzo[a,d]cyclohepten-5-yl)phosphane (^{MeO}tropp^{Cyc})

Empirical formula:

C₂₈H₃₅OP

Molecular weight: 418.56

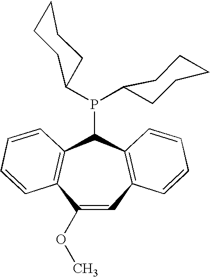

According to (III), the product was obtained from 5-chloro-10-methoxy-5H-dibenzo[a,d]cycloheptene (977 mg, 3.81 mmol) and dicyclohexylphosphane (755 mg, 3.81 mmol). By recrystallization from acetonitrile, the product could be obtained in a pure form.

Yield: 923 mg (58%) as a white powder

¹H-NMR (300.1 MHz, CDCl₃): δ=7.70-7.67 (m, 1H, CHₐᵣ), 7.33-7.12 (m, 7H, CHₐᵣ), 6.21 (s, 1H, CH_{olefin}), 4.39 (d, ²J_{PH}=6.0 Hz, 1H, CH_{benzyl}), 3.94 (s, 3H, OCH₃), 1.85-1.50 (m, 8H, 2 CH_{cyc} un 6 CH_{2Cyc}), 1.34-0.94 (m, 12H, CH_{2Cyc}), 0.90-0.73 (m, 2H, CH_{2Cyc})

³¹P-NMR (121.5 MHz, CDCl₃): δ=−1.0

### Example 65

### 10-[(−)-Menthyloxy]dibenzo[a,d]cyclohepten-5-one

Empirical formula:

C₂₅H₂₈O₂

Molecular weight: 360.49

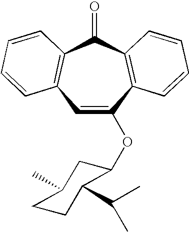

To 10-bromodibenzo[a,d]cyclohepten-5-one (12.00 g, 42.1 mmol) and potassium menthoxylate (8.99 g, 46.3 mmol, 1.1 eq., prepared from 1.2 eq. of menthol and 1 eq. of potassium at 100° C. in 1,4-dioxan), 150 ml of 1,4-dioxan was added. This caused a slight evolution of heat, and a red-brown solution formed. It was stirred at 100° C. for 3 h and then concentrated in vacuum. The residue was taken up in 250 ml of TBME, washed with saturated NaCl solution, dried over MgSO₄ and concentrated to obtain a yellow oil, which was purified by FC (silica; EE/hexane=1/9).

Yield: 13.66 g (90%) as a yellow oil

TLC (silica; EE/hexane=1/9): R_{f}=0.53

[α]_{D}−117 (c=1.0, CHCl₃)

¹H-NMR (300.1 MHz, CDCl₃): δ=8.09 (dd, J=7.9, 1.3Hz, 1H, CHₐᵣ), 8.02-7.96 (m, 2H, CHₐᵣ), 7.68-7.34 (m, 5H, CHₐᵣ), 6.47 (s, 1H, CH_{olefin}), 4.19 (d,d,d, J_{HH}=10.3 Hz, J_{HH}=10.3 Hz, ³J_{HH}=4.0 Hz, 1H, OCH), 2.34-2.24 (m, 2H, CH_{menthyl}, CH_{2menthyl}), 1.83-0.82 (m, 7H, CH_{menthyl}, CH_{2menthyl}), 0.98 (d, J_{HH}=7.0, 3H, CH_{3menthyl}), 0.94 (d, ³J_{HH}=6.5, 3H, CH_{3menthyl}), 0.83 (d, ³J_{HH}=7.0, 3H, CH_{3menthyl})

MS (m/z, %): 361 (65), 360 (74, M⁺), 223 (65), 222 (100), 194 (80), 176 (39), 165 (76), 139 (18), 83 (66), 69 (45), 55 (56)

### Example 66

### (5R/S)-10-[(−)-Menthyloxy]-5H-dibenzo[a,d]cyclohepten-5-ol

Empirical formula:

C₂₅H₃₀O₂

Molecular weight: 362.50

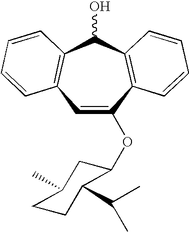

To 10-[(−)-menthyloxy]-5H-dibenzo[a,d]cyclohepten-5-one from Example 65 (10.00 g, 27.7 mmol) in 500 ml of MeOH, a solution of sodium borohydride (577 mg, 15.25 mmol, 55%) and sodium hydroxide (55 mg, 1.38 mmol, 5%) in 10 ml of water was added. The reaction solution was stirred at room temperature for 3 h and then concentrated under vacuum to obtain a yellow oil, which was extracted with Et₂O/saturated NaCI. The organic phase was separated, dried over Na₂SO₄ and concentrated to obtain a yellow oil from which 9.42 g of the product was isolated by means of MPLC (silica; hexane/EE=9/1).

Yield: 9.42 g (94%) as a colorless viscous oil

TLC (silica; EE/hexane=1/9): R_{f}=0.36

¹H-NMR (300.1 MHz, CDCl₃): δ=7.76-7.63 (m, br, 3H, CHₐᵣ), 7.48-7.40 (m, 1H, CHₐᵣ), 7.35-7.16 (m, 4H, CHₐᵣ), 6.52 (s, 0.5H, CH_{olefin}), 6.42 (s, 0.5H, CH_{olefin}), 5.26 (s, br, 1H, CH_{benzyl}), 4.28 (m, 0.5H, OCH_{menthy}), 4.04 (m, 0.5H, OCH_{menthyl}), 2.58 (s, br, 1H, OH), 2.45-2.31 (m, 2H, CH_{menthyl}, CH₂menthyl), 1.84-0.82 (m, 16H, CH_{menthyl}, CH_{2menthyl}).

The product exists as a mixture of the two diastereomers, which are formed at a ratio of about 50/50. The ¹³C signals are additionally broadened by the exchange between endo and exo forms. The signals observed are stated without assignment.

MS (m/z, %): 362 (12, M⁺), 224 (96), 207 (30), 195 (51), 179 (100), 178 (73), 165 (48), 152 (15), 83 (35), 69 (16), 55 (41)

### Example 67

### [(5S)-10-[(−)-Menthyloxy]-5H-dibenzo[a,d]cyclohepten-5-yl)diphenylphosphane((S)-^{menthyloxy}tropp) and

### [(5R)-10-[(1R)-Menthyloxy]-5H-dibenzo[a,d]cyclohepten-5-yl)diphenyl-phosphane((R)-^{menthyloxy}tropp)

Empirical formula:

C₃₇H₃₉OP

Molecular weight: 530.68

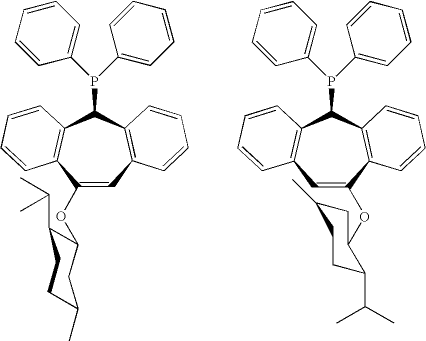

To a solution of (5R/S)-10-[(−)-menthyloxy]-5H-dibenzo[a,d]cyclohepten-5-ol from Example 66 (3.25 g, 8.97 mmol) in 50 ml of toluene, thionyl chloride (1.96 ml, 26.9 mmol, 3 eq.) was added dropwise at −15° C. The solution was brought to room temperature, and stirring was continued over night. Thereafter, the excess thionyl chloride was evaporated under vacuum together with the solvent, and the product was dissolved two more times in 10 ml of toluene and concentrated again to obtain a mixture of the two diastereomers of menthYloxYtropp chloride as a viscous yellow oil. It was dissolved in 30 ml of toluene, and diphenyl-phosphane (1.754 g, 9.42 mmol, 1.05 eq.) was added at room temperature. The reaction solution was heated to boil for 10 min, and then 20 ml of saturated Na₂CO₃ solution was added. The organic phase was separated, and the aqueous phase was extracted two more times with 10 ml of toluene. The combined organic phases were dried over Na₂SO₄ and concentrated. The raw product was separated from phosphane oxides and quaternary phosphonium salts by column chromatography (under argon, alumina N, THF/hexane 1/6, R_{f} 0.4) and concentrated to obtain 3.856 g of a mixture of the two diastereomers (7.27 mmol, 81%) as a colorless oil.

To 3.610 g of the mixture of diastereomers (6.80 mmol) in 20 ml of toluene, borane-dimethyl sulfide solution (3.40 ml, 2.0 M in toluene, 6.80 mmol) was added dropwise at −15° C. The solution was brought to room temperature and stirred for 1 h. Thereafter, the solvent was removed under vacuum, and the two borane-phosphane adducts were separated by FC (silica; toluene/hexane 1/1).

The 5-(S)-borane adduct (1.313 g, 2.54 mmol) was dissolved in 3 ml of morpholine and stirred for 1 h. Subsequently, the excess morpholine was removed under vacuum, and the free phosphane was separated from morpholine*BH₃ by filtration over alumina N (toluene). Concentration and crystallization from CH₃CN yielded the product (1280 mg, 2.41 mmol, 95%) as colorless crystals.

By analogy, the phosphane (904 mg, 1.70 mmol, 96%) was obtained from the 5-(R) isomer (966 mg, 1.77 mmol).

### [(5S)-10-[(−)-Menthyloxy]-5H-dibenzo[a,d]cyclohepten-5-yl)diphenyl-phosphane((S)-^{menthyloxy}tropp)

Empirical formula:

C₃₇H₃₉OP

Molecular weight: 530.68

Yield: 1280 mg (35%)

M.p.: 130° C.

¹H-NMR (300.1 MHz, CDCl₃): δ=7.75 (dd, J=7.5 Hz, J=1.7 Hz, 1H, CHₐᵣ), 7.37-7.09 (m, 14H, CHₐᵣ), 7.02 (ddd, J=7.3 Hz, J=7.3 Hz, J=1.1 Hz, 1H, CHₐᵣ), 6.97 (d,br, J=7.0 Hz, 2H, CHₐᵣ), 6.47 (s, 1H, CH_{olefin}), 4.84 (d, ²J_{PH}=5.6 Hz, 1H, CH_{benzyl}), 4.28 (ddd, J=10.4 Hz, J=10.4 Hz, J=4.0 Hz, 1H, OCH_{Menthyl}), 2.73 (d br, J=12.3 Hz, 1H, CH_{2menthyl}), 2.50 (pseudo sept d, J=7.0 Hz, J=2.7 Hz, 1H, CH_{menthyl}), 1.89-1.79 (m, 2H, CH_{2menthyl}), 1.75-1.53 (m, 2H, CH_{menthyl}, CH_{2menthyl}), 1.33-1.09 (m, 3H, CH_{menthyl}, CH_{2menthyl}), 1.07 (d, ³J_{HH}=6.5 Hz, CH_{3menthyl}), 1.05 (d, ³J_{HH}=7.1 Hz, CH_{3menthyl}), 1.00 (d, J=6.9 Hz, CH_{3menthyl})

³¹P-NMR (121.5 MHz, CDCl₃): δ=−14.1 (s)

MS (m/z, %): 530 (19, M⁺), 391 (100 M⁺-menthyl), 345 (6), 207 (74), 183 (14), 178 (28), 108 (6), 83 (25), 69 (15), 55 (46)

### [(5R)-10-[(−)-Menthyloxy]-5H-dibenzo[a,d]cyclohepten-5-yl)diphenyl-phosphane ((R)-^{menthyloxy}tropp)

Empirical formula:

C₃₇H₃₉OP

Molecular weight: 530.68

Yield: 904 mg (25%)

M.p.: 147° C.

¹H-NMR (300.1 MHz, CDCl₃): δ=7.81 (dd, J=7.6 Hz, J=1.7 Hz, 1H, CHₐᵣ), 7.32-7.08 (m, 14H, CHₐᵣ), 7.02-6.95 (m, 3H, CHₐᵣ), 6.40 (s, 1H, CH_{olefin}), 4.82 (d, ²J_{PH}=5.8 Hz, 1H, CH_{benzyl}), 4.40 (ddd, J=10.3 Hz, J=10.3 Hz, J=3.8 Hz, 1H, OCH_{Menthyl}), 2.84 (d br, J=12.8 Hz, 1H, CH_{2menthyl}), 2.56 (pseudo sept d, J=7.0 Hz, J=2.9 Hz, 1H, CH_{menthyl}), 1.92-1.73 (m, 3H, CH_{2menthyl}), 1.72-1.56 (m, 1H, CH_{menthyl}, CH_{2menthyl}), 1.34-1.11 (m, 3H, CH_{menthyl}, CH_{2menthyl}), 1.10 (d, ³J_{HH}=7.0 Hz, CH_{3menthyl}), 1.04 (d, ³J_{HH}=6.6 Hz, CH_{3menthyl}), 0.99 (d, ³J_{HH}=7.0 Hz, CH_{3menthyl})

³¹P-NMR (121.5 MHz, CDCl₃): δ=−12.8 (s)

### [(5S)-10-[(−)-Menthyloxy]-5H-dibenzo[a,d]cyclohepten-5-yl)diphenyl-phosphane*BH₃

Empirical formula:

C₃₇H₄₂BOP

Molecular weight: 544.51 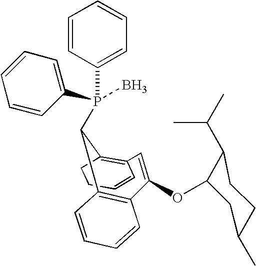
Yield: 1520 mg (25%)
¹H-NMR (300.1 MHz, CDCl₃): δ=7.74-7.68 (m, 1H, CHₐᵣ), 7.58-7.06 (m, 17H, CHₐᵣ), 5.71 (s, 1H, CH_{olefin}), 5.14 (d, ²J_{PH}=14.6 Hz, 1H, CH_{benzyl}), 4.05 (ddd, J=10.3 Hz, J=10.3 Hz, J=3.9 Hz, 1H, OCH_{menthyl}), 2.47-2.31 (m, 3H, CH_{menthyl}), 1.80-1.71 (m, 2H, CH_{2menthyl}), 1.64-1.52 (m, 1H, CH_{2menthyl}), 1.51-1.36 (m, 1H, CH_{menthyl}), 1.28-0.96 (m, 3H, CH_{2menthyl}), 1.00 (d, ³J_{HH}=7.0 Hz, CH_{3menthyl}), 0.94 (d, ³J_{HH}=6.9 Hz, CH_{3menthyl}), 0.93 (d, ³J_{HH}=6.6 Hz, CH_{3menthyl}), 1.4-0.2 (br, 3H, BH₃)
¹B-NMR (96.3 MHz, CDCl₃): δ=−36.5 (br)
³¹P-NMR (101.3 MHz, CDCl₃): δ=25.9 (br)

### [(5R)-10-[(−)-Menthyloxy]-5H-dibenzo[a,d]cyclohepten-5-yl)diphenyl-phosphane*BH₃

Empirical formula:

C₃₇H₄₂BOP

Molecular weight: 544.51 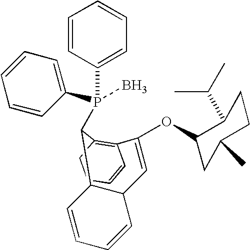
Yield: 940 mg (25%) as a colorless oil
¹H-NMR (300.1 MHz, CDCl₃): δ=7.84-7.80 (m, 1H, CHₐᵣ), 7.53-7.06 (m, 17H, CHₐᵣ), 5.73 (s, 1H, CH_{olefin}), 5.12 (d, ²J_{PH}=14.7 Hz, 1H, CH_{benzyl}), 4.02 (pseudo t d, J=10.5 Hz, J=4.0 Hz, 1H, OCH_{Menthyl}), 2.45-2.29 (m, 1H, CH_{menthyl}), 2.16 (d br, J=12.6 Hz, 1H, CH_{menthyl}), 1.80-1.60 (m, 3H, CH_{2menthyl}), 1.56-1.41 (m, 1H, CH_{2menthyl}), 1.19-0.89 (m, 3H, CH_{2menthyl}), 1.03 (d, ³J_{HH}=6.5 Hz, CH_{3menthyl}), 0.99 (d, ³J_{HH}=7.0 Hz, CH_{3menthyl}), 0.76 (d, ³J_{HH}=6.9 Hz, CH_{3menthyl}), 1.3-0.2 (br, 3H, BH₃)
¹¹B-NMR (96.3 MHz, CDCl₃): δ=−33.7 (br)
³¹P-NMR (121.5 MHz, CDCl₃): δ=25.6 (br)
MS (m/z, %): 544 (53, M⁺), 530 (17, M⁺-BH₃), 391 (100, M⁺-menthyl, —BH₃), 345 (10), 207 (40), 192 (5), 178 (12), 108 (6), 83 (10), 69 (12), 55 (22)

### Example 68

### [Ir(cod)((S)-^{menthyloxy}tropp^{Ph})]OTf

Empirical formula:

C₄₆H₅₁F₃IrO₄PS

Molecular weight: 980.14

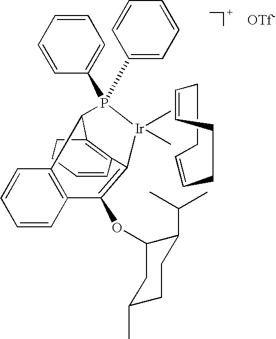

(S)-^{menthyloxy}tropp^{Ph} from Example 67 (106 mg, 0.20 mmol) and [Ir(cod)₂]OTf (111 mg, 0.20 mmol) were dissolved in 3 ml of CH₂Cl₂ to obtain a purple solution, from which the complex was obtained as a red powder by covering the solution by a layer of 5 ml of hexane.

Yield: 180 mg (92%)

M.p.: >188° C. (decomp.)

¹H-NMR (300.1 MHz, CDCl₃): δ=8.34 (dd, J=7.8 Hz, J=1.7 Hz, 1H, CHₐᵣ), 7.61-7.15 (m, 13H, CHₐᵣ), 7.02 (dd, J=7.7 Hz, J=7.7 Hz; 1H, CHₐᵣ), 6.89 (d, J=7.6 Hz, 1H, CHₐᵣ), 6.78 (d, J=2.1 Hz, 1H, CH_{olefin}), 6.69 (d, J=7.2 Hz, 1H, CHₐᵣ), 6.66 (dd, J=8.6 Hz, J=1.2 Hz, 1H, CHₐᵣ), 6.35 (m, br, 1H, —CHCOD), 5.84 (d, ²J_{PH}=14.3 Hz, 1H, CH_{benzyl}), 5.24 (m, br, 1H, CH_{coc}), 4.92 (ddd, J=10.3 Hz, J=10.3 Hz, J=4.0 Hz, 1H, OCH_{menthyl}), 3.77 (m, br, 1H, CH_{cod}), 3.40 (m, br, 1H, CH_{cod}), 2.52-2.38 (m, 2H, 1 CH_{menthyl} und 1 CH_{2COD}), 2.24-1.47 (m, 12H, 7 CH_{2COD} und 2 CH_{menthyl} und 3 CH_{2menthyl}), 1.37-1.24 (m, 1H, CH_{2menthyl}), 1.13 (d, ³J_{HH}=6.9.Hz, 3H, CH₃menthyl), 1.02 (d, ³J_{HH}=6.8 Hz, 3H, CH_{3menthyl}), 0.89-0.71 (m, 2H, CH_{2menthyl}), 0.66 (d, ³J_{HH}=6.3 Hz, 3H, CH_{3menthyl})

³¹P-NMR (121.5 MHz, CDCl₃): δ=69.1

UV (λₘₐₓ/nm): 497 (in CH₂Cl₂)

### Example 69

### [Ir(cod)((R)-^{menthyloxy}tropp^{Ph})]OTf

Empirical formula:

C₄₆H₅₁F₃IrO₄PS

Molecular weight: 980.14

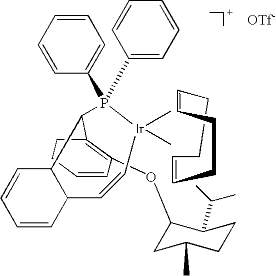

(R)-^{menthyloxy}tropp^{Ph} from Example 67 (106 mg, 0.20 mmol) and [Ir(cod)₂]OTf (111 mg, 0.20 mmol) were dissolved in 3 ml of CH₂Cl₂ to obtain a purple solution, from which the complex was obtained as a red powder by covering the solution by a layer of 5 ml of hexane.

Yield: 176 mg (90%)

M.p.: >195° C. (decomp.)

¹H-NMR (300.1 MHz, CDCl₃): δ=8.00 (dd, J=8.1 Hz, J=1.3 Hz, 1H, CHₐᵣ), 7.49-7.11 (m, 15H,CHₐᵣ), 7.00 (d, J=7.6 Hz, 1H, CHₐᵣ), 6.97 (dd, J=9.0 Hz, J=1.4 Hz, 1H, CHₐᵣ), 6.78 (d, J=2.4 Hz, 1H, CH_{olefin}), 6.02 (m, br, 1H, CH_{COD}), 5.90 (d, ²J_{PH}=13.8 Hz, 1H, CH_{benzyl}), 5.41 (m, br, 1H, CH_{cod}), 4.91 (ddd, J=10.2 Hz, J=10.2 Hz, J=4.2 Hz, 1H, OCH_{menthyl}), 3.86 (m, br, 1H, CH_{COD}), 3.05 (m, br, 1H, CH_{COD}), 2.52-1.11 (m, 16H, 8 CH_{2COD} und 3 CH_{menthyl} und 5 CH_{2menthyl}), 1.05-0.99 (m, 1H, CH_{2menthyl}), 1.01 (d, ³J_{HH}=6.3 Hz, 3H, CH_{3menthyl}), 0.85 (d, ³J_{HH}=7.0 Hz, 3H, CH_{3menthyl}), 0.79 (d, ³J_{HH}=6.9 Hz, 3H, CH_{3menthyl})

³¹P-NMR (121.5 MHz, CDCl₃): δ=64.8 ppm

UV (λₘₐₓ/nm): 497, 453 (in CH₂Cl₂)

### Example 70

### [Ir(cod)((R)-^{menthyloxy}tropp^{Ph})]PF₆

Empirical formula:

C₄₅H₅₁F₆IrOP₂

Molecular weight: 976.04

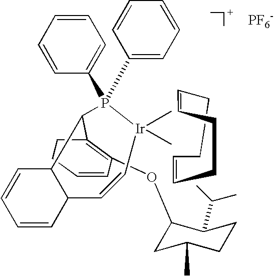

To [Ir(cod)Cl]₂ (19 mg, 0.057 mmol) in 2 ml of THF were added first 1,5-cyclooctadiene (0.1 ml, 88 mg, 0.81 mmol) and then thallium hexafluorophosphate (20 mg, 0.057 mmol). The suspension was briefly shaken to form a gray precipitate, and then 5-(R)-^{menthyloxy}Tropp^{Ph} (30 mg, 0.057 mmol) was immediately added. An intensive purple color formed. The solution was filtered from precipitated thallium chloride through Celite®, and the complex was precipitated by adding 5 ml of hexane. The product was isolated by vacuum filtration and dried under vacuum.

Yield: 44 mg (79%)

M.p.: >270° C. (decomp.)

¹H-NMR (250.1 MHz, CDCl₃): δ=8.00 (dd, J=8.0 Hz, J=1.6 Hz, 1H, CHₐᵣ), 7.49-6.96 (m, 17H, CHₐᵣ), 6.67 (d, J=2.4 Hz, 1H, CH_{olefin}), 5.93 (m, br, 1H, CH_{COD}), 5.85 (d, ²J_{PH}=14.0 Hz, 1H, CH_{benzyl}), 5.42 (m, br, 1H, CH_{COD}), 4.79 (ddd, J=10.2 Hz, J=10.2 Hz, J=4.2 Hz, 1H, OCH_{menthyl}), 3.86 (m, br, 1H, CH_{COD}), 3.10 (m, br, 1H, CH_{COD}), 2.52-1.11 (m, 16H, 8 CH_{2COD} und 3 CH_{menthyl} und 5 CH_{menthyl}), 1.05-0.99 (m, 1H, CH_{2menthyl}), 1.01 (d, ³J_{HH}=6.2 Hz, 3H, CH_{3menthyl}), 0.84 (d, ³J_{HH}=6.9 Hz, 3H, CH_{3menthyl}), 0.80 (d, ³J_{HH}=6.9 Hz, 3H, CH_{3menthyl})

³¹P-NMR (121.5 MHz, CDCl₃): δ=64.6 (TROPP^{(Ph)2}), −143.5 (h, ¹J_{PF}=713.2 Hz)

UV (λₘₐₓ/nm): 497, 455 (in CH₂Cl₂)

### Example 71

### [Ir(cod)((S)-^{menthyloxy}tropp^{Ph})]PF₆

(S)-^{menthyloxy}Tropp^{Ph} (106 mg, 0.20 mmol) and [Ir(cod)₂]PF₆ (111 mg, 0.20 mmol) were reacted by analogy with Example 70 to obtain a purple solution, from which the product was obtained as a red powder by covering the solution with a layer of 5 ml of hexane.

Yield: 176 mg (90%)

M.p.: >195° C. (decomp.)

¹H-NMR (300.1 MHz, CDCl₃): δ=8.00 (dd, J=8.1 Hz, J=1.3 Hz, 1H, CHₐᵣ), 7.49-7.11 (m, 15H, CHₐᵣ), 7.00 (d, J=7.6 Hz, 1H, CHₐᵣ), 6.97 (dd, J=9.0 Hz, J=1.4 Hz, 1H, CHₐᵣ), 6.78 (d, J=2.4 Hz, 1H, CH_{olefin}), 6.02 (m, br, 1H, CH_{COD}), 5.90 (d, ²J_{PH}=13.8 Hz, 1H, CH_{benzyl}), 5.41 (m, br, 1H, CH_{COD}), 4.91 (ddd, J=10.2 Hz, J=10.2 Hz, J=4.2 Hz, 1H, OCH_{menthyl}), 3.86 (m, br, 1H, CH_{COD}), 3.05 (m, br, 1H, CH_{COD}), 2.52-1.11 (m, 16H, 8 CH_{2COD} und 3 CH_{menthyl} und 5 CH_{2menthyl}), 1.05-0.99 (m, 1H, CH_{2menthyl}), 1.01 (d, ³J_{HH}=6.3 Hz, 3H, CH_{3menthyl}), 0.85 (d, ³J_{HH}=7.0 Hz, 3H, CH_{3menthyl}), 0.79 (d, ³J_{HH}=6.9 Hz, 3H, CH_{3menthyl})

³¹P-NMR (121.5 MHz, CDCl₃): δ=64.8 ppm

### Example 72

### [Rh(tropp^{Ph(CH2)3PPh2}) (CH₃CN)]PF₆

Empirical formula:

C₃₈H₃₅F₆N P₃Rh

Molecular weight: 815.52

To the phosphane from Example 46 (150 mg, 0.285 mmol), [Rh(cod)CI]₂ (70 mg, 0.142 mmol) and thallium hexafluorophosphate (99 mg, 0.284 mmol) was added 10 ml of CH₃CN. An orange solution with a white precipitate of thallium chloride immediately formed. The solution was filtered through Celite and concentrated to obtain the complex as a dark orange oil, which was dissolved in little CH₂Cl₂ and covered by a layer of toluene/hexane to obtain red crystals which were suitable for X-ray structural analysis.

Yield: 218 mg (94%)

M.p.: >192° C. (decomp.)

¹H-NMR (300.1 MHz, CD₃CN): δ=7.83 (dd, J=5.7 Hz, J=4.4 Hz, 1H, CHₐᵣ), 7.58-6.86 (m, 22H, CHₐᵣ), 6.56 (d, J=9.7 Hz, 1H, CH_{olefin}), 6.01 (dd, J=9.7 Hz, J=4.2, 1H, CHₐᵣ), 4.52 (d, 2J_{PH}=14.1 Hz, 1H, CH_{benzyl}), 2.52-2.07 (m, 4H, CH_{2bridge}), 1.71-1.40 (m, 2H, CH_{2bridge}), 1.97 (CH₃CN, CD₂HCN, free and coordinated)

³¹P-NMR (121.5 MHz, CD₃CN): δ=86.9 (dd, ¹J_{RhP}=170.3 Hz, ²J_{PP}=58.6 Hz, TROPP^{Ph}), 12.3 (dd, ¹J_{RhP}=155.6 Hz, J=58.6 Hz, CH₂PPh₂), −143.5 (h, ¹J_{PF}=712.6 Hz, PF₆)

### Example 73

### [Rh(tropp^{Ph(CH2)4PPh2})(CH₃CN)]PF₆

Empirical formula:

C₃₉H₃₇F₆N P₃Rh

Molecular weight: 829.54

A suspension of [Rh(cod)Cl]₂ (46 mg, 0.0925 mmol) in 2 ml of CH₃CN was covered by a layer of a solution of the phosphane from Example 48 (100 mg, 0.185 mmol) in 2 ml of toluene and 5 ml of CH₃CN to form a red solution, from which red crystals of the complex [Rh(tropp^{Ph(CH2)4PPh2})Cl] grew in the course of the next 48 h (Yield 89%). This complex was suspended in CH₃CN and reacted with thallium hexafluorophosphate (58 mg, 0.165 mmol). After 18 h, the solution was filtered from the precipitated thallium chloride and concentrated to 1 ml. The orange solution was admixed with 1 ml of toluene and covered by a layer of 5 ml of hexane. The product crystallized in the form of orange platelets.

Yield: 123 mg (90%)

M.p.: >170° C. (decomp.)

¹H-NMR (300.1 MHz, CD₃CN): δ=7.75-7.67 (m, 3H, CHₐᵣ), 7.58-7.32 (m, 13H, CHₐᵣ), 7.20-7.08 (m, 5H, CHₐᵣ), 6.90 (ddd, J=7.6 Hz, J=7.6 Hz, J=0.8 Hz, 1H, CHₐᵣ), 6.62 (d, br, J=7.6 Hz, 1H, CHₐᵣ), 6.33 (ddd, J=9.7 Hz, J=1.8 Hz, J=1.8 Hz, 1H, CH_{olefin}), 6.01 (dd, J=9.7 Hz, J=4.5, 1H, CH_{olefin}), 4.76 (d, ²J_{PH}=14.3 Hz, 1H, CH_{benzyl}), 2.36-2.15 (m, 2H, CH_{2bridge}), 1.88-1.43 (m, 5H, CH_{2bridge}), 1.16-0.96 (m, 1H, CH_{2bridge}), 1.97 (CH₃CN, CD₂HCN, free and coordinated)

³¹P-NMR (121.5 MHz, CD₃CN): δ=111.0 (dd, ¹J_{RhP}=184.1 Hz, 2J_{PP}=48.5 Hz, TROPP^{Ph}), 8.6 (dd, ¹J_{RhP}=154.3 Hz, 2J_{PP}=48.5 Hz, CH₂PPh₂), −143.9 (h, ¹J_{PF}=706.5 Hz, PF₆)

UV (λₘₐₓ/nm): 464 (in CH₂Cl₂)

### Example 74

### [Co(tropp^{Ph(CH2)3PPh2} )Cl]

Empirical formula:

C₃₆H₃₂ClCoP₃

Molecular weight: 620.99

The phosphane from Example 46 (263 mg, 0.50 mmol) and tris(triphenylphosphin)cobalt(I) chloride (440 mg, 0.50 mmol) were dissolved together in 5 ml of THF to form a dark red solution, which was stirred at room temperature for 1 h and then covered by a layer of 10 ml of hexane. The complex was obtained in the form of small red crystals, which were isolated by vacuum filtration, washed with hexane and dried under high vacuum. Crystals suitable for X-ray structural analysis were obtained by allowing hexane to slowly diffuse into a solution of this product in THF.

Yield: 200 mg (64%)

M.p.: 181° C. (decomp.)

IR (ν in cm⁻¹): 3054 m, 2919 m, 1981 w, 1572 w, 1483 m, 1432 m, 1397 w, 1341 w, 1317 m, 1292 m, 1184 m, 1156 m, 1097 s, 1029 m, 962 m, 827 m, 739 s, 691 s, 654 m, 543 m, 509 s

### Example 75

### [Rh(tropp^{Ph(CH2)3PPh2})(PPh₃)]PF₆

Empirical formula:

C₅₄H₄₇F₆P₄Rh

Molecular weight: 1036.76

To the rhodium complex from Example 72 (200 mg, 0.225 mmol) and triphenylphosphane (59 mg, 0.225 mg), 3 ml of CH₂Cl₂ was added, and the red solution was stirred for 1 h. Subsequently, the product was precipitated with 10 ml of hexane as an orange powder.

Yield: 226 mg (97%)

M.p.: 219° C. (decomp.)

¹H-NMR (300.1 MHz, C₆D₆): δ=7.48-7.42 (m, 6H, CHₐᵣ), 7.38-7.12 (m, 25H, CHₐᵣ), 7.07-7.01 (m, 3H, CHₐᵣ), 6.99-6.86 (m, 4H, CHₐᵣ), 6.56 (d, J=8.3 Hz, 1H, CHₐᵣ), 6.52 (d, J=7.8 Hz, 1H, CHₐᵣ), 5.45 (ddd, J=9.8 Hz, J=5.6 Hz, J=5.6 Hz, 1H, CH_{olefin}), 4.89 (dd, ²J_{PH}=14.6 Hz, J=6.1 Hz, 1H, CH_{benzyl}), 4.84-4.77 (m, 1H, CH_{olefin}), 2.77-2.63 (m, 2H, CH_{2bridge}), 2.26-2.00 8 (m, 2H, CH_{2bridge}), 1.83-1.72 (m, 1H, CH_{2brldge}), 1.50-1.14 (m, 3H, CH_{2bridge})

³¹P-NMR (101.3 MHz, CDCl₃): δ=71.4 (ddd, ¹J_{RhP}=132.9 Hz, 2J_{PP}=297.1 Hz, ²J_{PP}=57.2 Hz TROPP^{Ph}), 29.8 (ddd, ¹J_{Rhp}=119.9 Hz, ²J_{PP}=297.1 Hz, ²J_{PP}=31.7 Hz, PPh₃), 16.1 (ddd, ¹J^{RhP}=159.3 Hz, ²J_{PP}=57.2 Hz, ²J_{PP}=31.7 Hz, CH₂PPh₂), −143.4 (h, ¹J_{PF}=713.1 Hz, PF₆)

UV (λₘₐₓ/nm): 460, shoulder (in CH₂Cl₂)

### Example 76

### [Ir(tropp^{Ph(CH2)4PPh2})(CH₃CN)]OTf

Empirical formula:

C₄₀H₃₇F₃IrNO₃P₂S

Molecular weight: 922.95

To the phosphane from Example 48 (108 mg, 0.20 mmol) and [Ir(cod)₂]OTf (111 mg, 0.20 mmol) were added 2 ml of CH₃CN and 2 ml of hexane. The two-phased solution was shortly brought to boil, and the hexane phase was separated together with the released COD. The CH₃CN phase was again extracted with 2 ml of hexane and then concentrated to obtain the complex as a red powder, which was washed with little hexane and dried under high vacuum.

Yield: 167 mg (90%)

M.p.: >210° C. (decomp.)

¹H-NMR (300.1 MHz, CD₃CN): δ=7.62-7.10 (m, 21H, CHₐᵣ), 6.79 (dd, J=7.4 Hz, J=7.4 Hz, 1H, CHₐᵣ), 6.58 (d, br, J=7.7 Hz, 1H, CHₐᵣ), 4.48 (d, ²J_{PH}=13.2 Hz, 1H, CH_{benzyl}), 4.04 (m, 2H, 2 CH_{olefin}), 2.71-2.46 (m, 3H, CH_{2bridge}), 2.22-2.02 (m, 1H, CH_{2bridge}), 1.97 (s, 3H, CH₃CN), 1.88-1.75 (m, 1H, CH_{2bridge}) 1.66-1.48 (m, 1H, CH_{2bridge}), 1.30-1.08 (m, 2H, CH_{2bridge})

¹⁹F-NMR (282.4 MHz, CD₃CN): −79.6 (s, 3F, O₃SCF₃—)

³¹P-NMR (121.5 MHz, CD₃CN): δ=55.2 (d, ²J_{PP}=14.1 Hz, TROPP), −5.8 (d, ²J_{PP}=14.1 Hz, CH₂P(Ph)₂)

UV (λₘₐₓ/nm): 575, 503, 406 (in CH₃CN)

### Example 77

### [Ir(tropp^{Ph(CH2)3PPh2})(CH₃CN)₂]OTf

Empirical formula:

C₄lH₃₈F₃IrN₂O₃P₂S

Molecular weight: 949.97

The synthesis was performed by analogy with Example 76 from the phosphane from Example 46 (105 mg, 0.20 mmol) to yield the complex as a light beige powder.

Yield: 155 mg (82%)

M.p.: >99° C.

¹H-NMR (300.1 MHz, CD₃CN): δ=7.59 (d, J=7.4 Hz, 1H, CHₐᵣ), 7.50-7.15 (m, 19H, CHₐᵣ), 6.95-6.86 (m, 2H, CHₐᵣ), 6.77 (d, br, J=7.5 Hz, 1H, CHₐᵣ), 4.62 (d, ²J_{PH}=13.6 Hz, 1H, CH_{benzyl}), 3.93 (dd, J=9.6 Hz, J=5.7 Hz, 1H, CH_{olefin}), 3.87 (d, J=9.6 Hz, CH_{olefin}), 2.61-2.50 (m, 2H, CH_{2bridge}), 2.13-1.86 (m, 2H, CH_{2bridge}), 1.97 (s, 3H, CH₃CN), 1.80-1.68 (m, 1H, CH_{2bridge}), 1.15-1.02 (m, 1H, CH_{2bridge})

³¹P-NMR (121.5 MHz, CDCl₃): δ=38.4 (d, ²J_{PP}=23.4 Hz, TROPP), −10.1 (d, ²J_{PP}=23.4 Hz, CH₂P(Ph)₂)

UV (λₘₐₓ/nm): 565 (in CH₃CN)

### Example 78

### [Ir(cod)tropp^{iPrCH2P(iPr)2}]OTf

Empirical formula:

C₃₄H₄₆F₃IrO₃P₂S

Molecular weight: 845.96

To the phosphane from Example 49 (79 mg, 0.2 mmol) and [Ir(cod)₂]OTf (111 mg, 0.2 mmol) was added 2 ml of CH₃CN to form a yellow solution, which was allowed to stand for 1 h and then covered by a layer of 5 ml of hexane. The complex precipitated as a light beige powder, which was filtered off and dried under vacuum.

Yield: 149 mg (88%)

M.p.: >166° C. (decomp.)

¹H-NMR (250.1 MHz, CDCl₃): δ=7.65 (d, J=7.6 Hz, 1H, CHₐᵣ), 7.47 (dd, J=7.4 Hz, J=1.5 Hz, 1H, CHₐᵣ), 7.34-7.15 (m, 6H, CHₐᵣ), 5.57 (br, 1H, CH_{COD}), 5.02 (m, 1H, CH_{olefin}), 5.00 (d, ²J_{PH}=12.8 Hz, 1H, CH_{benyl}), 4.12 (ddd, J=9.4 Hz, J=3.9 Hz, J=3.9 Hz, 1H, CH_{olefin}), 4.08 (br, 1H, CH_{COD}), 3.45 (br, 1H, CH_{COD}), 3.39-3.24 (m, 1H, CH_{2COD}), 3.31 (m, 1H, PCH₂P), 3.12-2.31 (br,m, 5H, CH_{2cod}), 2.74 (m, 1H, PCH₂P), 2.72 (m, 1H, CHpr), 2.05 (m, 1H, CH_{2COD}), 2.04 (m, 1H, CH_{iPr}), 1.56 (m, 1H, CH_{2COD}), 1.54 (m, 1H, CH_{iPr}), 1.36 (dd, ³J_{HH}=7.1 Hz, ³J_{PH}=20.0 Hz, 3H, CH_{3iPr}), 1.31 (dd, ³J_{HH}=7.2 Hz, ³J_{PH}=13.3 Hz, 3H, CH_{3iPr}), 1.24 (dd, ³J_{HH}=7.1 Hz, ³J_{PH}=12.0 Hz, 3H, CH_{3iPr}), 1.15 (dd, ³J_{HH}=7.1 Hz, ³J_{PH}=16.5 Hz, 3H, CH_{3iPr}), 0.62 (dd, ³J_{HH}=7.2 Hz, ³J_{PH}=13.5 Hz, 3H, CH_{3iPr}), 0.58 (dd, ³J_{HH}=7.2 Hz, ³J_{PH}=16.4 Hz, 3H, CH_{3iPr})

³¹P-NMR (121.5 MHz, CDCl₃): δ=3.4 (d, 23pp =51.2 Hz, TROPP), -76.2 (d ²J_{PP}=51.2 Hz, CH₂P/Pr₂)

### Example 79

### [Ir(^{MeO}tropp^{Ph})(cod)]OTf

Empirical formula:

C₃₇H₃₅F₃IrOPS

Molecular weight: 855.93

To the phosphane from Example 63 (41 mg, 0.10 mmol) and [Ir(cod)₂]OTf (56 mg, 0.10 mmol) was added 2 ml of CH₂Cl₂ to form a red-brown solution, from which the product precipitated as a red powder when the solution was covered by a layer of 5 ml of toluene. It was isolated by vacuum filtration, washed with little hexane and dried under high vacuum. Crystals suitable for X-ray structural analysis (red needles) were obtained by covering a solution of the complex in CDCl₃ by a layer of toluene.

Yield: 78 mg (91%)

M.p.: 148° C. (decomp.)

¹H-NMR (300.1 MHz, CDCl₃): δ=8.01-7.98 (m, 1H, CHₐᵣ), 7.60 (dd, J=7.7 Hz, J=1.0 Hz, 1H, CHₐᵣ), 7.47-7.23 (m, 10H, CHₐᵣ), 7.18-7.11 (m, 3H, CHₐᵣ), 6.98 (ddd, J=7.8 Hz, J=1.2 Hz, J=1.2 Hz, 1H, CHₐᵣ), 6.93-6.86 (m, 2H, CHₐᵣ), 6.76 (d, J=2.4 Hz, 1H, CH_{olefin}), 6.28 (m, 1H, CH_{COD}), 5.81 (d, ²J_{PH}=14.3 Hz, 1H, CH_{benzyl}), 5.55 (m, 1H, CH_{COD}), 4.18 (s, 3H, OCH₃), 4.11 (m, 1H, CH_{COD}), 3.56 (m, 1H, CH_{cod}), 2.59-2.05 (m, 5H, CH_{2COD}), 1.87-1.62 (m, 3H, CH_{2COD})

³¹P-NMR (121.5 MHz, CDCl₃): δ=62.2

UV (λₘₐₓ/nm): 520, Schulter (in CH₂Cl₂)

### Example 80

### [Ir(^{MeO}tropp^{Cyc})(cod)]OTf

Empirical formula:

C₃₇H₄₇F₃IrO₄PS

Molecular weight: 868.03

^{methoxy}tropp^{Cyc} from Example 64 (84 mg, 0.20 mmol) and [Ir(cod)₂]OTf (112 mg, 0.20 mmol) were dissolved in 2 ml of CH₂Cl₂, and the solution was stirred for 15 min. Thereafter, the deep red solution was covered by a layer of 5 ml of hexane, and the complex crystallized in the form of extremely fine needles. These were isolated by vacuum filtration, washed with little hexane and dried under high vacuum.

Yield: 146 mg (84%)

M.p.: 170° C. (decomp.)

¹H-NMR (300.1 MHz, CDCl₃): δ=7.84 (dd, J=8.1 Hz, J=1.1 Hz, 1H, CHₐᵣ), 7.76 (d, J=7.6 Hz, 1H, CHₐᵣ), 7.63 (ddd, J=7.6 Hz,J =7.6 Hz, J=1.1 Hz, 1H, CHₐᵣ), 7.54 (dd, J=3.5 Hz, 1H, CHₐᵣ), 7.46 (dd, J=7.7 Hz, J=7.7 Hz, 1H, CHₐᵣ), 7.32-7.25 (m, 3H, CHₐᵣ), 5.96 (m, 1H, CH_{COD}), 5.89 (d, ²J_{PH}=13.1 Hz, 1H, CH_{benzyl}), 5.05 (m, 1H, CH_{COD}), 5.01 (m, 1H, CH_{COD}), 4.37 (m, 1H, CH_{COD}), 4.02 (s, 3H, OCH₃), 2.45-1.43 (m, 19H, 8 CH_{2COD} und 9 CH_{2Cyc} und 2 CH_{Cyc}), 1.24-0.81 (m, 9H, CH_{2Cyc}), 0.39-0.41 (m, 2H, CH_{2Cyc})

³¹P-NMR (121.5 MHz, CDCl₃): δ=66.5

### Example 81

### [Ir(cod) (^{Ph}tropp^{Ph})]OTf

Empirical formula:

C₄₂H₃₇F₃Ir₃O₃S

Molecular weight: 871.01

5-Diphenylphosphino-10-phenyl-5H-dibenzo[a,d]cycloheptene, which can be obtained from the literature-known 10-phenyl-5H-dibenzo[a,d]cycloheptenone according to (I), (II) and (III) in an overall yield of 68% (91 mg, 0.20 mmol), and [Ir(cod)₂]OTf (111 mg, 0.20 mmol) were dissolved in 3 ml of CH₂Cl₂ to form a dark violet solution, which was stirred at room temperature for 30 min and then covered by a layer of 1 ml of toluene and 5 ml of hexane. Over night, the complex precipitated as a purple powder. The product was isolated by vacuum filtration, washed with little hexane and dried under high vacuum.

Yield: 158 mg (91%)

M.p.: >191° C. (decomp.)

¹H-NMR (300.1 MHz, CDCl₃): δ=7.88 (d, J=6.6 Hz, 1H, CHₐᵣ), 7.68-7.05 (m, 21H, CHₐᵣ), 6.88 (d, J=7.5 Hz, 1H, CHₐᵣ), 6.71 (d, J_{PH}=2.5 Hz, 1H, CH_{olefin}), 6.23 (br, 1H, CH_{COD}), 5.89 (d, ²J_{PH}=14.5 Hz, 1H, CH_{benzyl}), 4.33 (br, 1H, CH_{COD}), 3.79 (br, 1H, CH_{COD}), 3.65 (br, 1H, CH_{COD}), 2.28-2.18 (m, 2H, CH_{2COD}), 2.03-1.92 (m, 1H, CH_{2COD}), 1.69-1.30 (m, 5H, CH_{2COD})

³¹P-NMR (121.5 MHz, CDCl₃): δ=53.4

UV (λₘₐₓ/nm): 553 (in CH₂Cl₂)

### Example 82

### 10-Fluorodibenzo[a,d]cyclohepten-5-one

Empirical formula:

C₁₅H₉FO

Molecular weight: 224.22

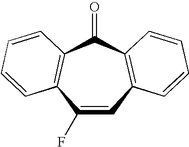

To 10-bromodibenzo[a,d]cyclohepten-5-one (2.85 g, 10 mmol) and cesium fluoride (3.20 g, 21 mmol) was added 20 ml of DMF. The dark orange suspension was stirred at 135° C. for 3 d. Thereafter, the solution was admixed with 100 ml of saturated NaCl and extracted three times with 100 ml of Et₂O. Concentrating the ether phases yielded a dark solid. Recrystallizing from CH₂Cl₂/hexane yielded the product as brown crystals.

Yield: 1.54 g (69%)

M.p.: 118° C.

¹H-NMR (300.1 MHz, CDCl₃): δ=8.19 (m, 1H, CHₐᵣ), 8.14 (m, 1H, CHₐᵣ), 7.94 (m, 1H, CHₐᵣ), 7.74-7.44 (m, 5H, CHₐᵣ),. 6.96 (d, ³J_{FH}=23.0 Hz, 1H, CH_{olefin})

¹⁹F-NMR (282.4 MHz, CDCl₃): δ=−105.9 (d, ³J_{FH}=22.9 Hz)

MS (m/z, %): 225 (30), 224 (91, M⁺), 206 (16), 196 (100), 170 (32), 98 (17)

### Example 83

### 10-Fluoro-5H-dibenzo[a,d]cyclohepten-5-ol

Empirical formula:

C₁₅H₁₁FO

Molecular weight: 226.22

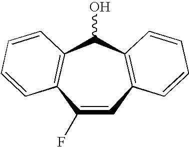

10-Fluorodibenzo[a,d]cyclohepten-5-one from Example 65 (1400 mg, 6.24 mmol) was suspended in 50 ml of MeOH, cooled to 0° C. and admixed with a solution of sodium borohydride (125 mg, 3.3 mmol) and sodium hydroxide (13 mg, 0.33 mmol) in 10 ml of water. After the solution had been stirred at room temperature for 3 h, 50 ml of water was added, the product precipitating as a beige powder.

Yield: 1230 mg (87%)

M.p.: 77° C.

¹H-NMR (300.1 MHz, CDCl₃): δ=7.76-7.68 (m, 3H, CHₐᵣ), 7.55 (m, 1H, CHₐᵣ)l 7.43-7.23 (m, 4H, CHₐᵣ), 6.92 (d, ³J_{FH}=20.2 Hz, 1H, CH_{olefin}), 5.37 (s, br, 1H, CH_{benzyl}), 2.45 (s, br, 1H, OH)

¹⁹F-NMR (282.4 MHz, CDCl₃): δ=−102.9 (br, v1/2=105 Hz)

MS (m/z, %): 226 (40, M⁺), 224 (38), 209 (45, ^{F}Trop⁺), 197 (52), 196 (98), 179 (100), 178 (60), 170 (15), 98 (17), 89 (15)

### Example 84

### 5-Chloro-10-fluoro-5H-dibenzo[a,d]cycloheptene

Empirical formula:

C₁₅H₁₀ClF

Molecular weight: 244.69

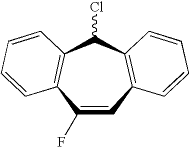

To 10-fluoro-5H-dibenzo[a,d]cyclohepten-5-ol from Example 66 (985 mg, 4.35 mmol) in 20 ml of toluene was added thionyl chloride (1.55 g, 13 mmol, about 3 eq.) at −15° C., and the solution was brought to room temperature within 1 h. Thereafter, stirring was continued over night, and the solvent was evaporated under vacuum together with excess thionyl chloride. The raw product was recrystallized from CH₂Cl₂/hexane.

Yield: 808 mg (76%)

¹H-NMR (250.1 MHz, CDCl₃): δ=7.68-7.83 (m, br, 1H, CHₐᵣ), 7.53-7.35 (m, br, 7H, CHₐᵣ), 7.00 (d, ³J_{FH}=21.1 Hz, 1H, CH_{olefin}), 6.24 (s, 1H, CH_{benzyl})

¹⁹F-NMR (282.4 MHz, CDCl₃): δ=−105.6 (d, ³J_{FH}=21.1 Hz)

MS (m/z, %): 244 (6, M⁺), 209 (100, TROP-F⁺), 105 (10)

### Example 85

### (10-Fluoro-5H-dibenzo[a,d]cyclohepten-5-yl)diphenylphosphane

Empirical formula:

C₂₇H₂₀FP

Molecular weight: 394.42

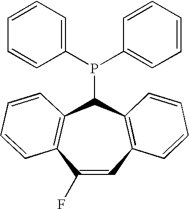

According to (III), 5-chloro-10-fluoro-5H-dibenzo[a,d]cycloheptene from Example 67 (208 mg, 0.85 mmol) was reacted with diphenylphosphane (166 mg, 0.89 mmol, 1.05 eq.). The product was crystallized from CH₂Cl₂/hexane.

Yield: 221 mg (66%)

¹H-NMR (300.1 MHz, CDCl₃): δ=7.65 (ddd, J=7.6 Hz, J=1.1 Hz, J=1.1 Hz, 1H, CHₐᵣ), 7.29-7.05 (m, 15H, CHₐᵣ), 6.98-6.91 (m, 2H, CHₐᵣ), 6.89 (d, ³J_{FH}=20.9 Hz, 1H, CH_{olefin}), 4.85 (d, ²J_{PH}=5.6 Hz, 1H, CH_{benzyl})

¹³C-NMR (75.5 MHZ, CDCl₃): δ=138.3 (d, J=8.2 Hz, C_{quart}), 137.1 (d, J=9.4 Hz, C_{quart}), 136.7 (d, J=8.8 Hz, C_{quart}), 136.6 (d, J=10.3 Hz, C_{quart}), 133.7 (d, J=18.3 Hz, 2 CHₐᵣ), 133.5 (d, J=18.0 Hz, 2 CHₐᵣ), 130.2 (CHₐᵣ), 130.2 (d, J=3.1 Hz, CHₐᵣ), 130.1 (dd, J=3.2 Hz, J=3.2 Hz, CHₐᵣ), 129.4 (dd, J=3.9 Hz, J=1.5 Hz, CHₐᵣ), 128.6 (CHₐᵣ), 128.5 (CHₐᵣ), 128.0 (CHₐᵣ), 127.9 (d, J=7.0 Hz, 2 CHₐᵣ), 127.9 (d, J=6.7 Hz, 2CHₐᵣ), 126.7 (d, J=1.5 Hz, CHₐᵣ), 126.5 (CHₐᵣ), 125.4 (dd, J=7.0 Hz, J=1.6 Hz, CHₐᵣ), 112.5 (dd, J=29.8 Hz, J=4.9 Hz, CH_{olefin}), 56.6 (d, ³J_{PC}=21.3 Hz, CH_{benzyl})

³¹P-NMR (121.5 MHz, CDCl₃): δ=−11.9

¹⁹F-NMR (282.4 MHz, CDCl₃): δ=−102.9 (d, ³J_{FH}=20.9 Hz)

MS (m/z, %): 394 (10, M⁺), 209 (100, TROPF⁺), 183 (7)

### Example 86

### [Ir(cod)(^{F}tropp^{Ph})]OTf

Empirical formula:

C₂₈H₂₀F₄IrO₃S

Molecular weight: 704.73

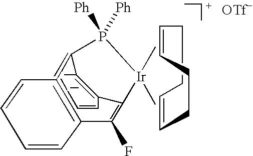

5-Diphenylphosphino-10-fluoro-5H-dibenzo[a,d]cycloheptene from Example 68 (47 mg, 0.12 mmol) and [Ir(cod)₂]OTf (67 mg, 0.12 mmol) were dissolved together in 2 ml of CH₂Cl₂ to obtain a dark brown solution, which was covered by a layer of 5 ml of hexane. The complex deposited as a dark brown oil. The supernatant solvent was pipetted off, and the product was again washed with hexane and then dried under vacuum.

Yield: 63 mg (74%) as a brown oil

¹H-NMR (300.1 MHz, CDCl₃): δ=8.10 (d, J=7.9 Hz, 1H, CHₐᵣ), 7.63-7.16 (m, 14H, CHₐᵣ), 6.95 (m, 1H, CHₐᵣ), 6.63 (br, 1H, CH_{COD}), 6.57 (d, J=7.7 Hz, 1H, CHₐᵣ), 6.55 (d, J=8.4 Hz, 1H, CHₐᵣ), 6.31 (dd, ³J_{FH}=17.7 Hz, ³J_{PH}=2.0 Hz, 1H, CH_{olefin}), 5.85 (d, ²J_{PH}=14.9 Hz, 1H, CH_{benzyl}), 5.79 (br, 1H, CH_{COD}), 4.76 (br, 1H, CH_{COD}), 4.62 (br, 1H, CH_{COD}), 2.77-2.26 (m, 5H, CH_{2COD}), 2.01-1.96 (m, 2H, CH_{2COD}), 1.52-1.43 (m, 1H, CH_{2cod})

³¹P-NMR (121.5 MHz, CDCl₃): δ=61.2

### Example 87

### [Pd ((S)-^{menthyloxy}tropp^{Ph})Cl₂]

Empirical formula:

C₃₇H₃₉Cl₂OPPd

Molecular weight: 708.00

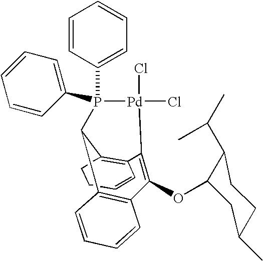

(S)-^{menthyloxy}tropp^{Ph} from Example 67 (106 mg, 0.200 mmol) and dichlorobis(benzonitrile)palladium(II) (77 mg, 0.200 mmol) were dissolved in 2 ml of CH₂Cl₂ and stirred for 1 h. Thereafter, the orange solution was covered by a layer of 5 ml of toluene, and the product precipitated over night as an orange powder. The product was filtered off, washed with little hexane and dried under vacuum.

Yield: 122 mg (86%)

M.p.: >165° C. (decomp.)

¹H-NMR (300.1 MHz, CDCl₃): δ=7.99 (dd, J=7.7 Hz, J=1.5 1H, CHₐᵣ), 7.73 (d, J=8.1 Hz, 1H, CHₐᵣ), 7.69 (d, J=7.4 Hz, 1H, CHₐᵣ), 7.56 (dd, J=7.8 Hz, J=1.1 Hz, 1H, CHₐᵣ), 7.39-7.15 (m, 14H, CHₐᵣ), 7.28 (s, 1H, CH_{olefin}), 6.22 (ddd, J=10.5 Hz, J=10.5 Hz, J=3.9 Hz, 1H, OCH_{menthyl}), 5.26 (d, ¹J_{PH}=15.2 Hz, 1H, CH_{benzyl}), 2.45-2.29 (m, 2H, 1 CH_{menthyl} und 1 CH_{2menthyl}), 1.92-1.63 (m, 4H, 2 CH_{menthyl} und 2 CH_{2menthyl}), 1.43 (ddd, J=12.8 Hz, J=12.8 Hz, J=3.1 Hz, 1H, CH_{2menthyl}), 1.20 (d, J=7.0 Hz, 3H, CH_{3menthyl}), 1.12 (d, J=7.3 Hz, 3H, CH_{3menthyl}), 1.11 (m, 1H, CH_{2menthyl}), 0.98 (m, 1H, CH_{2menthyl}), 0.93 (d, J=6.4 Hz, 3H, CH_{3menthyl})

³¹P-NMR (121.5 MHz, CDCl₃): δ=111.1

UV (λₘₐₓ/nm): 391, 277 (in CH₂Cl₂)

### Example 88

### [Pd((R)-^{menthyloxy}tropp^{Ph})Cl₂]

Empirical formula:

C₃7H₃₉Cl₂OPPd

Molecular weight: 708.00

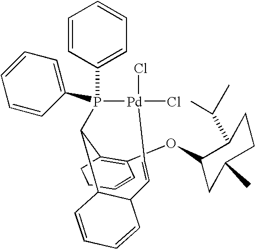

(R)-^{menthyloxy}tropp^{Ph} from Example 67 (120 mg, 0.226 mmol) and dichlorobis(benzonitrile)palladium(II) (87 mg, 0.226 mmol) were dissolved in 2 ml of CH₂Cl₂ and stirred for 1 h. Thereafter, the orange solution was covered by a layer of 5 ml of toluene, and the product precipitated over night as fine orange platelets.

Yield: 147 mg (92%)

M.p.: >260° C. (decomp.)

¹H-NMR (300.1 MHz, CDCl₃): δ=8.04-8.00 (m, 1H, CHₐᵣ), 7.70 (d, J=7.7 Hz, 1H, CHₐᵣ), 7.66 (d, J=7.5 Hz, 1H, CHₐᵣ), 7.51 (d, J=7.6 Hz, 1HCHₐᵣ), 7.43 (s, 1H, CH_{olefin}), 7.41-7.08 (m, 14H, CHₐᵣ), 5.97 (ddd, J=10.3 Hz, J=10.3 Hz, J=4.4 Hz, 1H, OCH_{menthyl}), 5.22 (d, ²J_{PH}=15.5 Hz, CH_{benzyl}), 3.00 (d, br, J=11.9 Hz, 1H, CH_{2menthyl}), 1.83-1.75 (m, 3H, 2 CH_{2menthyl} und 1 CH_{menthyl}), 1.63 (dd, J=11.7 Hz, J=11.7 Hz, 1H, CH_{menthyl}), 1.44-1.26 (m, 3H, 2 CH_{2menthyl} und 1 CH_{menthyl}), 1.02 (d, J=6.5 Hz, 3H, CH_{3menthyl}), 0.99 (m, 1H, CH_{2menthyl}), 0.95 (d, J=7.0 Hz, 3H, CH_{3menthyl}), 0.78 (d, J=6.9 Hz, 3H, CH_{menthyl})

³¹P-NMR (121.5 MHz, CDCl₃): δ=111.0 (s)

UV (λₘₐₓ/nm): 385 (in CH₂Cl₂)

Catalysis Experiments

General Remarks

Catalytic hydrosilylations with platinum complexes

### Example 89

### Catalytic Preparation of diphenyl(methylbutadienyl)silane

Empirical formula:

C₁₇H₁₈Si

Molecular weight: 250.40

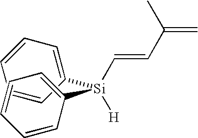

Diphenylsilane (1.000 g, 5.42 mmol) and methylbutenyne (359 mg, 5.42 mmol) were heated to 60° C. in an NMR tube with a teflon spindle cap together with [Pt(tropnp(NEt²)²)₂] from Example 4c (5 mg, S/C=1000). After 1 h, a complete conversion had been achieved.

B.p.: 140° C./high vacuum

¹H-NMR (300.1 MHz, CDCl₃): δ=7.82-7.79 (m, 4H, CHₐᵣ), 7.58-7.55 (m, 6H, CHₐᵣ), 6.97 (d, ³J_{HH}=18.9 Hz, 1H, CH_{olefin}), 6.26 (dd, ³J_{HH}=18.9 Hz, 3J_{HH}=3.4 Hz, 1H, CH_{olefin}), 5.29 (d, ³J_{HH}=3.4 Hz, 1H, SiH), 5.15 (s, 1H, CH_{2olefin}), 5.13 (s, 1H, CH_{2olefin}), 1.96 (s, 3H, CH₃)

²⁹Si-NMR (59.6 MHz, CDCl₃): δ=−20.8 (¹J_{SiH}=200 Hz)

### Example 90

### Catalytic Preparation of diphenylbis(methylbutadienyl)silane

Empirical formula:

C₂₂H₂₄Si

Molecular weight: 316.51

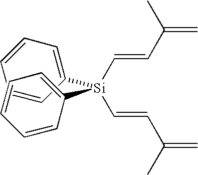

Diphenylsilane (922 g, 5.00 mmol) and methylbutenyne (668 mg, 10.1 mmol) were filled into an NMR tube with a teflon spindle cap together with [Pt(tropnp(NEt²)²)₂] from Example 4c and maintained at 60° C. for 3 d. Thereafter, NMR spectroscopy indicated a complete conversion of the educts. A vacuum distillation (140° C./high vacuum) yielded a pure product, which immediately crystallizes at room temperature.

M.p.: 63° C.

¹H-NMR (300.1 MHz, CDCl₃): δ=7.60-7.56 (m, 4H, CHₐᵣ), 7.44-7.36 (m, 6H, CHₐᵣ), 6.75 (d, ³J_{HH}=18.9 Hz, 1H, CH_{olefin}), 6.18 (d, ³J_{HH}=18.9 Hz, 1H, CH_{olefin}), 5.14 (s, 1H, CH_{2olefin}), 5.05 (s, 1H, CH_{2olefin}), 1.96 (s, 3H, CH₃)

²⁹Si-NMR (59.6 MHz, CDCl₃): δ=−19.8

Catalytic Hydrogenation with Iridium Complexes

The catalyses were performed within a pressure range of from 10 to 100 bar at 15-50° C. in different solvents in a 60 ml high-pressure steel autoclave with a sampling valve supplied by Medimex. Controlling of the pressure was performed by a Pressflow Controller bpc 6002 supplied by Buchi. The withdrawal of the measured samples was effected after rinsing the sampling valve with about 1 ml of reaction solution. For the separation of the mixtures of substances (H₂ carrier gas), the following columns were employed:
HP-5 Crosslinked 5% PH ME SILOXANE (30 m×0.32 mm×0.25 mm).
Lipodex® E (25 m×0.25 mm ID), Machery & Nagel.

Phenyl(1-phenylethyl)amine from phenyl(1-phenylethylidene)amine: Determination of conversion on HP-5, 150° C. isothermal, 1.9 ml of H₂/min, 9.2 min phenyl(1-phenylethyl)amine, 10.5 min phenyl(1-phenylethylidene)amine ee determination: Lipodex® E: 110° C. for 1 min, followed by heating to 150° C. at 0.6° C./min, 0.9 ml of H₂/min, 65.7 min ((S)-phenyl(1-phenylethyl)amine), 66.4 min ((R)-phenyl(1-phenylethyl)amine).

N-(1-phenylethyl)acetamide from N-(1-phenylvinyl)acetamide: Determination of conversion on HP-5, 150° C. isothermal, 1.9 ml of H₂/min, 3.6 min (N-acetyl-1-phenylethylamine), 4.5 min (N-acetyl-1-phenyletheneamine) ee determination: Lipodex® E: 140° C. for 1 min, followed by heating to 150° C. at 0.6° C./min, 0.7 ml of H₂/min, 16.4 min ((R)-N-(1-phenylethyl)acetamide), 16.9 min ((S)-N-(1-phenylethyl)acetamide).

Benzylphenylamine from benzylidene aniline: Determination of conversion on HP-5, 150° C. isothermal, 1.9 ml of H₂/min, 8.3 min (benzylidene aniline), 9.7 min (benzylphenylamine).

TABLE 1
Hydrogenation of N-benzylideneaniline under the following
conditions: T = 50° C., p[H₂] = 50 bar,
1 mole percent of catalyst; solvent: THF, [S] = 0.1 mol/l

| | | Conversion in % after | | | | |
|---|---|---|---|---|---|---|
| Example | Catalyst | 1 h | 2 h | 4 h | 6 h | 18 h |
| 91 | [Ir(cod)(tropp^{Ph,Et-2-Py})]OTf | 36 | 62 | 90 | >99 | |
| 92 | [Ir(cod)(tropp^{Cyc,Et-2-Py})]OTf | 40 | 67 | 93 | >99 | |
| 93 | [Ir(cod)(tropp^{Ph,Et-N-Pyrro})]OTf | 47 | 86 | >99 | | |
| 94 | [Ir(cod)(tropp^{Cyc,Et-N-Pyrro})]OTf | 30 | 52 | 79 | 96 | >99 |
| 95 | [Ir(tropp^{Ph(CH2)4PPh2})(CH₃CN)]OTf | 75 | >99 | | | |
| 96 | [Ir(tropp^{Ph(CH2)3PPh2})(CH₃CN)]OTf | 27 | 72 | 97 | >99 | |
| 97 | [Ir(cod)(tropp^{iPr(CH2)PiPr2})]OTf | 11 | 75 | >99 | | |
| 98 | [Ir(cod)(tropp^{Ph})]OTf | 96 | >99 | | | |
| 99 | [Ir(cod)(tropp^{Cyc})]OTf | >99 | | | | |

TABLE 2
Hydrogenation of N-benzylideneaniline under the
following conditions: T = 50° C.,
p[H₂] = 50 bar; solvent: THF, [S] = 1 mol/l

| | | Cat | Conversion in % after | | | | |
|---|---|---|---|---|---|---|---|
| Example | Catalyst | (mole %) | 0.1 h | 1 h | 4 h | 6 h | 18 h |
| 100 | [Ir(tropp^{Ph(CH2)4PPh2})(CH₃CN)]OTf | 0.1 | | 11 | 57 | 81 | >99 |
| 101 | [Ir(tropp^{Ph(CH2)4PPh2})(CH₃CN)]OTf | 0.05 | | | | | >99 |
| 102 | [Ir(cod)(tropp^{Ph})]OTf | 0.1 | 48 | >99 | | | |
| 103 | [Ir(cod)(tropp^{Cyc})]OTf | 0.1 | >99 | | | | |
| 104 | [Ir(cod)(tropp^{Cyc})]OTf | 0.05 | | >99 | | | |

TABLE 3
Hydrogenation of N-benzylideneaniline under the following conditions:
T = 50° C., p[H₂] = 50 bar; 0.1 mole percent
of catalyst; [S] = 1 mol/l, variable solvent:

| | | | Conversion |
|---|---|---|---|
| Example | Catalyst | Solvent | in % after 6 h |
| 105 | [Ir(cod)(tropp^{Ph})]OTf | THF | 50.0 |
| 106 | [Ir(cod)(tropp^{Ph})]OTf | CH₂Cl₂ | 60.5 |
| 107 | [Ir(cod)(tropp^{Ph})]OTf | ethanol | 7.5 |
| 108 | [Ir(cod)(tropp^{Ph})]OTf | THF/acetic acid 1/1 | 9.0 |
| 109 | [Ir(cod)(tropnp^{Ph})] | THF | 25.2 |

TABLE 4
Hydrogenation of phenyl(1-phenylethylidene)amine under
the following conditions: [S] = 0.1 mol/l for
catalyst = 1 or 4 mole percent; [S] = 1 mol/l
for catalyst = 0.1 mole percent

| | | Cat | Conv. in % | | | p[H₂] | | |
|---|---|---|---|---|---|---|---|---|
| Ex. | Catalyst | (mole %) | (h) | | Temp. | (bar) | Solv. | ee |
| 110 | [Ir(cod)(tropp^{Ph})]OTf | 0.1 | 49(6) | >99(24) | 50° C. | 50 | THF | — |
| 111 | [Ir(cod)(tropp^{Cyc})]OTf | 0.1 | 52(6) | >99(24) | 50° C. | 50 | THF | — |
| 112 | [Ir(cod)(R,R- | 0.1 | 10(4) | 56(24) | 15° C. | 50 | THF | 35 |
| | tropphos^{Me})]OTf | | | | | | | |
| 113 | [Ir(cod)(R,R- | 0.1 | 28(4) | >99(24) | 50° C. | 50 | THF | 34 |
| | tropphos^{Me})]OTf | | | | | | | |
| 114 | [Ir(cod)(R,R- | 0.1 | 58(4) | >99(24) | 50° C. | 100 | THF | 28 |
| | tropphos^{Me})]OTf | | | | | | | |
| 115 | [Ir(cod)(S- | 1 | >99(2) | | 20° C. | 50 | CHCl₃ | 45 |
| | ^{Menthyloxy}tropp^{Ph})]OTf | | | | | | | |
| 116 | [Ir(cod)(R- | 1 | >99(2) | | 20° C. | 50 | CHCl₃ | 85 |
| | ^{Menthyloxy}tropp^{Ph})]OTf | | | | | | | |
| 117 | [Ir(cod)(R- | 1 | >75(3) | >99(24) | 20° C. | 4 | CHCl₃ | 85 |
| | ^{Menthyloxy}tropp^{Ph})]OTf | | | | | | | |
| 118 | [Ir(cod)(R- | 1 | >99(2) | | 20° C. | 50 | CH₂Cl₂ | 50 |
| | ^{Menthyloxy}tropp^{Ph})]OTf | | | | | | | |
| 119 | [Ir(cod)(R- | 1 | >99(24) | | 20° C. | 4 | Chlorobenzene | 80 |
| | ^{Menthyloxy}tropp^{Ph})]OTf | | | | | | | |
| 120 | R-^{Menthyloxy}tropp^{Ph} + | 1 | >99(2) | | 20° C. | 50 | CH₂Cl₂ | 50 |
| | [Ir(cod)₂]OTf | | | | | | | |
| 121 | R-^{Menthyloxy}tropp^{Ph} + | 4 | >99(2) | | 20° C. | 4 | CHCl₃ | 86 |
| | [Ir(cod)₂]OTf | | | | | | | |
| 122 | R-^{Menthyloxy}tropp^{Ph} + | 1 | 96(2) | >99(24) | 20° C. | 4 | Benzene | 68 |
| | [Ir(cod)₂]OTf | | | | | | | |

TABLE 5
Hydrogenation of N-(1-phenylvinyl)acetamide under the following
conditions: [S] = 0.1 mol/l, catalyst = 2 mole percent, p[H₂] = 4 bar,
t = 18 h, temp. = 20° C.

| Exam- | | Conver- | | |
|---|---|---|---|---|
| ple | Catalyst | sion in % | Solvent | ee |
| 123 | [Ir(cod)(S-^{menthyloxy}tropp^{Ph})]OTf | >99 | CHCl₃ | 60 (S) |
| 124 | [Ir(cod)(R-^{menthyloxy}tropp^{Ph})]OTf | >99 | CHCl₃ | 24 (R) |
| 125 | [Ir(cod)(R-^{menthyloxy}tropp^{Ph})]OTf | >99 | CH₂Cl₂ | 21 (R) |

TABLE 6
Hydrogenation of 1,5-cyclooctadiene under the following conditions:
[S] = 1 mol/l, catalyst = 0.1 mole percent, p[H₂] = 4 bar,
t = 60 minutes, temp. = 20° C., solvent CHCl₃

| Exam- | | Conversion in % to | |
|---|---|---|---|
| ple | Catalyst | 1-cyclooctene | cyclooctane |
| 126 | [Ir(cod)(R-^{menthyloxy}tropp^{Ph})]OTf | 22.5 | 9.5 |

1. Compounds of general formula (I) are suitable for use in catalytic processes: 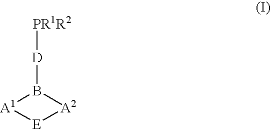
wherein
R¹ and R² independently represent a monovalent residue containing from 1 to 30 carbon atoms; or
PR¹R² together represent a five- to nine-membered heterocyclic residue which contains a total of 2 to 50 carbon atoms and contains up to three further heteroatoms selected from the group consisting of oxygen and nitrogen; and
D is absent or represents NR³, wherein
R³ represents C₁-C₁₂ alkyl, C₃-C₁₂ alkenylalkyl, C₄-C₁₅ aryl or C₅-C₁₆ arylalkyl; and
in the case where D is absent:
B represents nitrogen or CH; and
in the case where D represents NR³:
B represents CH; and
A¹ and A² independently represent a substituted or unsubstituted orthoarylene residue; and
E represents E¹ or E2, and E¹ represents an unsubstituted, mono- or disubstituted vicinal cis-alkenediyl residue, and E² represents a vicinal alkanediyl residue in which each of the two -yl- carbon atoms bears one or two hydrogen atoms;
wherein
5-diphenylphosphanyl-10-methyl-5H-dibenzo[a,d]cycloheptene, 5-diphenylphosphanyl-10-ethyl-5H-dibenzo[a,d]cycloheptene, 5-diphenylphosphanyl-10-pentyl-5H-dibenzo[a,d]cycloheptene and 5-diphenylphosphanyl-10-benzyl-5H-dibenzo[a,d]cycloheptene are excepted; and
at least one or more of the following conditions are met:
A¹-E-A² does not possess a mirror plane as an element of symmetry orthogonal to the carbon-carbon bond which connects the two vicinal -yl- residues of E;
R¹ and R² are different;
PR¹R² as a whole possesses at least one stereogenic center;
R³ possesses a stereogenic center.

2. The compounds according to claim 1, characterized in that at least one of the following conditions is met:
E does not possess a mirror plane as an element of symmetry orthogonal to the carbon-carbon bond which connects the two vicinal -yl- residues of E;
PR¹R² as a whole possesses at least one stereogenic center.

3. The compounds according to either of claims 1 or 2, characterized in that:
R¹ and R² independently represent C₁-C₁₈ alkyl, C₁-C₁₈ perfluoroalkyl, C₁-C₁₈ perfluoroalkoxy, C₁-C₁₈ alkoxy, C₃-C₂₄ aryl, C₃-C₂₄ aryloxy, C₄-C₂₅ arylalkyl, C₄-C₂₅ arylalkoxy or NR⁴R⁵, wherein R⁴ and R⁵ independently represent C₁-C₁₂ alkyl, C₃-C₁₄ aryl or C₄-C₁₅ arylalkyl, or NR⁴R⁵ as a whole represents a five- to seven-membered cyclic amino residue with a total of 4 to 12 carbon atoms; or
R¹ and R² independently represent residues of general formula (II):
F-Het¹-(R⁶)ₙ (II)
wherein
F represents a C₁-C₈ alkylene residue; and
Het¹ represents a heteroatom which is selected from the group consisting of sulfur, oxygen, phosphorus or nitrogen; and
for sulfur and oxygen: n=1; and
for phosphorus or nitrogen: n=2; and
R⁶ independently represents C₁-C₁₂ alkyl, C₄-C₁₄ aryl or C₅-C₁₅ arylalkyl; and
for n=2, in addition:
Het¹-(R⁶)₂ represents a five- to nine-membered heterocyclic residue which contains a total of 2 to 20 carbon atoms and optionally up to three further heteroatoms selected from the group consisting of nitrogen and oxygen; or
R¹ and R² independently represent residues of general formulas (IIIa) and (IIIb):
F-R⁸-G-R⁹ (IIIa)
F-G-R⁷ (IIIb)
wherein
F has the meaning as mentioned under general formula (II);
G represents carbonyl or sulfonyl; and
R⁷ represents R⁹, NH, NR⁹, N(R⁹)₂, OH or OM or, if G is carbonyl, also OR⁹;
R⁸ represents NH, NR⁹ or, if G is carbonyl, also oxygen; and
R⁹ independently represents C₁-C₁₂ alkyl, C₄-C₁₄ aryl or C₅-C₁₅ arylalkyl; or
N(R⁹)₂ together represents a five- to seven-membered heterocyclic residue with a total of 2 to 12 carbon atoms which optionally contains up to three further heteroatoms selected from the group consisting of sulfur, nitrogen and oxygen;
M¹ represents 1/m equivalents of a metal ion with a valence of m or optionally substituted ammonium, preferably ammonium or an equivalent of an alkali metal ion, such as lithium, sodium, potassium or cesium; or
PR¹R² together represents a five- to seven-membered heterocyclic residue of general formula (IV): 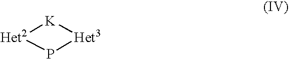
wherein
Het² and Het³ independently are absent or represent oxygen or NR¹⁰, wherein R¹⁰ represents C₁-C₁₂ alkyl, C₄-C₁₄ aryl or C₅-C₁₅ arylalkyl; and
K represents an alkanediyl residue with 2 to 25 carbon atoms, a divalent arylalkyl residue with 5 to 15 carbon atoms, an arylene residue with a total of 5 to 14 carbon atoms or a 2,2′-(1,1′-bisarylene) residue with a total of 10 to 30 carbon atoms.

4. The compounds according to one or more of claims 1 to 3, characterized in that A¹ and A² independently represent an ortho-phenylene residue of general formula (V) 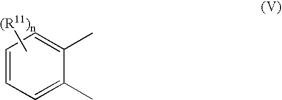
wherein
n represents 0, 1, 2, 3 or 4; and
R¹¹ is independently selected from the group consisting of fluorine, chlorine, bromine, iodine, nitro, free or protected formyl, C₁-C₁₂ alkyl, C₁-C₁₂ alkoxy, C₁-C₁₂ haloalkoxy, C₁-C₁₂ haloalkyl, C₃-C₁₀ aryl, C₄-C₁₁ arylalkyl or residues of general formula (VI):
L-Q-T-W (VI)
in which independently:
L is absent or represents an alkylene residue with 1 to 12 carbon atoms or an alkenylene residue with 2 to 12 carbon atoms; and
Q is absent or represents oxygen, sulfur or NR¹²;
wherein R¹² represents hydrogen, C₁-C₈ alkyl, C₅-C₁₄ arylalkyl or C₄-C₁₅ aryl; and
T represents a carbonyl group; and
w represents R¹³ OR¹³, NHR¹⁴ or N(R¹⁴)₂;
wherein
R¹³ represents C₁-C₈ alkyl, C₅-C₁₅ arylalkyl or C₅-C₁₄ aryl; and
R¹⁴ independently represents C₁-C₈ alkyl, C₅-C₁₄ arylalkyl or C₄-C₁₅ aryl, or N(R¹³)₂ together represents a five- or six-membered cyclic amino residue;
or residues of general formulas (VIIa-g):
L-W (VIIa)
L-SO₂-W (VIIb)
L-NR¹³²—SO₂R¹³ (VIIc)
L-SO₃Z (VIId)
L-PO₃Z₂ (VIIe)
L-COZ (VIIf)
L-CN (VIIg)
wherein L, Q, W and R¹³ have the meanings as stated under the general formula (VI), and Z represents hydrogen or M¹, wherein M¹ has the meaning as stated under the definition of R⁷.

5. The compounds according to claim 4, characterized in that n represents 1 or 2.

6. The compounds according to one or more of claims 1 to 5, characterized in that E² represents residues of general formula (VIIIb): 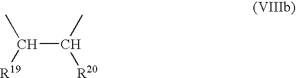
wherein
R¹⁹ and R²⁰ independently represent hydrogen, C₁-C₁₈ alkyl, C₃-C₂₄ aryl or C₄-C₂₅ arylalkyl.

7. The compounds according to one or more of claims 1 to 6, characterized in that E represents E¹.

8. The compounds according to claim 7, characterized in that E¹ represents residues of general formula (VIIIa) 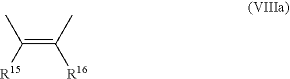
wherein
R¹⁵ and R¹⁶ independently represent hydrogen, cyano, fluorine, chlorine, bromine, iodine, C₁-C₁₈ alkyl, C₄-C₂₄ aryl, C₅-C₂₅ arylalkyl, CO₂M, CONH₂, SO₂N(R¹⁷)₂, SO₃M¹, wherein M¹ has the meaning as stated under R7, and R¹⁷ independently has the meaning defined below, or residues of general formula (IX):
T²-Het⁴-R¹⁸ (IX)
wherein
T² is absent or represents carbonyl;
Het⁴ represents oxygen or NR¹⁷, wherein R¹⁷ represents hydrogen, C₁-C₁₂ alkyl, C₄-C₁₄ aryl or C₅-C₁₅ arylalkyl; and
R¹⁸ represents C₁-C₁₈ alkyl, C₃-C₂₄ aryl or C₄-C₂₅ arylalkyl.

9. The compounds according to one or more of claims 1 to 8, characterized in that B in general formula (I) represents CH.

10. The compounds according to one or more of claims 1 to 9, characterized in that D in general formula (I) is absent.

11. The compounds according to one or more of claims 1 to 10, characterized by being stereoisomer-enriched.

12. (5R)-5-(phenyl-2-(2-pyridyl)ethylphosphanyl)-5H-dibenzo[a,d]cycloheptene;
(5S)-5-(phenyl-2-(2-pyridyl)ethylphosphanyl)-5H-dibenzo[a,d]cycloheptene;
(5R)-5-(phenyl-2-(N-pyrrolidinyl)ethylphosphanyl)-5H-dibenzo[a,d]cycloheptene;
(5S)-5-(phenyl-2-(N-pyrrolidinyl)ethylphosphanyl)-5H-dibenzo[a,d]cycloheptene;
(5S)-5-(cyclohexyl-2-(2-pyridyl)ethylphosphanyl)-5H-dibenzo[a,d]cycloheptene;
(5R)-5-(cyclohexyl-2-(2-pyridyl)ethylphosphanyl)-5H-dibenzo[a,d]cycloheptene;
(5R)-5-(cyclohexyl-2-(N-pyrrolidinyl)ethylphosphanyl)-5H-dibenzo[a,d]-cycloheptene;
(5S)-5-(cyclohexyl-2-(N-pyrrolidinyl)ethylphosphanyl)-5H-dibenzo[a,d]-cycloheptene;
(5R)-10-cyano-5-diphenylphosphanyl-5H-dibenzo[a,d]cycloheptene;
(5S)-10-cyano-5-diphenylphosphanyl-5H-dibenzo[a,d]cycloheptene;
(2S,5S-2,5-dimethylphospholanyl)-5H-dibenzo[a,d]cycloheptene;
(2R,5R-2,5-dimethylphospholanyl)-5H-dibenzo[a,d]cycloheptene;
(2S,5S-2,5-dimethylphospholanyl)-3,7-diiodo-5H-dibenzo[a,d]cycloheptene;
(2R,5R-2,5-dimethylphospholanyl)-3,7-diiodo-5H-dibenzo[a,d]cycloheptene;
(5R)-5-[(3-diphenylphosphanylpropyl)phenylphosphanyl]-5H-dibenzo-[a,d]cycloheptene;
(5S)-5-[(3-diphenylphosphanylpropyl)phenylphosphanyl]-5H-dibenzo-[a,d]cycloheptene;
(5R)-5-[(4-diphenylphosphanylbutyl)phenylphosphanyl]-5H-dibenzo[a,d]-cycloheptene;
(5S)-5-[(4-diphenylphosphanylbutyl)phenylphosphanyl]-5H-dibenzo[a,d]-cycloheptene;
(5R)-5-{[(diisopropylphosphanyl)methyl]isopropylphosphanyl}-5H-di-benzo[a,d]cycloheptene;
(5S)-5-{[(diisopropylphosphanyl)methyl]isopropylphosphanyl}-5H-dibenzo[a,d]cycloheptene;
(4S,5R)-2-(5H-dibenzo[a,d]cycloheptyl)-3,4-dimethyl-5-phenyl- 1,3,2-oxazaphospholidine;
Rₚ-10,11-dihydro-5H-dibenzo[a,d]cyclohepten-5-yl)methylphenylphosphane;
Sₚ-10,11-dihydro-5H-dibenzo[a,d]cyclohepten-5-yl)methylphenylphosphane;
(S)-4-(10,11-dihydro-5H-dibenzo[a,d]cyclohepten-5-yl)-3,5-dioxa-4-phosphacyclohepta[2,1-a3,4.a′]dinaphthalene;
(R)-4-(10,1 1-dihydro-5H-dibenzo[a,d]cyclohepten-5-yl)-3,5-dioxa-4-phosphacyclohepta[2,1-a3,4.a′]dinaphthalene;
(S)-4-(5H-dibenzo[a,d]cyclohepten-5-yl)-3,5-dioxa-4-phosphacyclohepta-[2,1-a3,4.a′]dinaphthalene;
(R)-4-(5H-dibenzo[a,d]cyclohepten-5-yl)-3,5-dioxa-4-phosphacyclohepta-[2,1-a3,4.a′]dinaphthalene;
(5R)-10-methoxy-5H-dibenzo[a,d]cyclohepten-5-yldiphenylphosphane;
(5S)-10-methoxy-5H-dibenzo[a,d]cyclohepten-5-yldiphenylphosphane;
(5R)-10-methoxy-5H-dibenzo[a,d]cyclohepten-5-yldicyclohexylphosphane;
(5S)-10-methoxy-5H-dibenzo[a,d]cyclohepten-5-yldicyclohexylphosphane;
(5R)-10-fluoro-5H-dibenzo[a,d]cyclohepten-5-yldiphenylphosphane;
(5S)-10-fluoro-5H-dibenzo[a,d]cyclohepten-5-yldiphenylphosphane;
[(5S)-10-[(-)-menthyloxy]-5H-dibenzo[a,d]cyclohepten-5-yl]diphenylphosphane;
[(5R)-10-[(-)-menthyloxy]-5H-dibenzo[a,d]cyclohepten-5-yl]diphenylphosphane.

13. Salts of compounds according to one or more of claims 1 to 12 and acids of formula H-LG in which LG represents chlorine, bromine, a carboxylate of a carboxylic acid having a pKₐ value of from 0 to 3, or a sulfonate.

14. Adducts of compounds according to one or more of claims 1 to 12 with boranes.

15. Compounds of general formula (Xb): 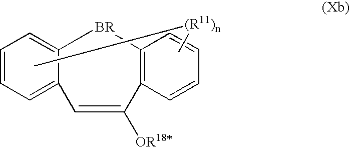
in which
BR represents C═O, CH—OH or CH-LG, wherein LG represents chlorine, bromine, a carboxylate of a carboxylic acid having a pKₐ value of from 0 to 3, or a sulfonate; and
n represents 0 or 1; and
R¹¹ has the meaning as stated under claims 8 to 11; and
R^{18*} represents a chiral C₅-C₁₈ arylalkyl residue.

16. A method for preparing compounds according to one or more of claims 1 to 12, characterized in that compounds of general formula (XVI) 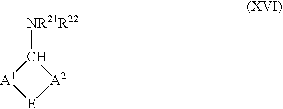
in which
A¹, A² and E have the meanings as stated under claims 1 to 12; and
R²¹ and R²² independently represent hydrogen, C₁-C₁₈ alkyl, C₄-C₂₄ aryl or C₅-C₂₅ arylalkyl, or NR²¹R²² as a whole represents a five- to seven-membered cyclic amino residue having a total of 5 to 24 carbon atoms;
with phosphines of general formula (XV)
HPR¹R² (XV)
in which PR¹R² or R¹ and R² respectively have the meanings as stated under claim 1;
in the presence of an acid.

17. The method according to claim 16, characterized in that, as phosphines of general formula (XV), those are employed in which R¹ and R² are bonded to the phosphorus through a carbon atom.

18. Compounds of general formula (XIX) 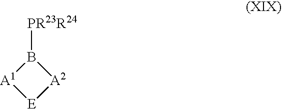
wherein A¹, A², B and E have the meanings as mentioned in claim 1, and R²³ and R²⁴ independently represent a residue selected from the group consisting of halogen or NR²⁵R²⁶ in which R²⁵ and R²⁶ independently represent C₁-C₆ alkyl, or NR²⁵R²⁶ together represents a five- or six-membered cyclic amino residue.

19. The compounds according to claim 18, characterized in that halogen in general formula (XIX) represents chlorine.

20. The compounds according to either of claims 18 to 19, characterized in that NR²⁵R²⁶ in general formula (XIX) represents dimethylamino, diethylamino or diisopropylamino.

21. 5-Bis(diethylamino)phosphanyl-5H-dibenzo[a,d]cycloheptene,
5-bis(dimethylamino)phosphanyl-5H-dibenzo[a,d]cycloheptene,
5-bis(dimethylamino)phosphanyl-10,11-dihydro-5H-dibenzo[a,d]cycloheptene,
5-chlorodimethylaminophosphanyl-10,11-dihydro-5H-dibenzo[a,d]cycloheptene
5-bis(diethylamino)phosphanyl-5H-dibenzo[b,f]azepine
5-(bischlorophosphanyl-10/11-dihydro-5H-dibenzo[a,d]cycloheptene; and
5-(bischlorophosphanyl-5H-dibenzo[a,d]cycloheptene (tropp^{Cl}).

22. A process for preparing chiral compounds, characterized by being performed in the presence of compounds according to one or more of claims 1 to 12.

23. A process for preparing chiral compounds, characterized by being performed in the presence of compounds according to claim 11.

24. Transition metal complexes containing compounds according to one or more of claims 1 to 12.

25. The transition metal complexes according to claim 24, characterized in that said transition metal is selected from the group consisting of cobalt, rhodium, iridium, nickel, palladium, platinum, copper, osmium and ruthenium.

26. Transition metal complexes obtainable by reacting transition metal compounds with compounds according to one or more of claims 1 to 12.

27. The transition metal complexes according to claim 26, characterized in that the molar content of the transition metal in the transition metal compound employed is from 50 to 200 mole percent, based on the compound according to one or more of claims 1 to 22 employed.

28. The transition metal complexes according to either of claims 26 and 27, characterized in that the transition metal compounds employed are those of general formula (XXIIa)
M²(Y¹)ₚ (XXIIa)
in which
M² represents ruthenium, rhodium, iridium, nickel, palladium, platinum or copper; and
Y¹ represents chloride, bromide, acetate, nitrate, methanesulfonate, trifluoromethanesulfonate, allyl, methallyl or acetylacetonate; and
p represents 3 for ruthenium, rhodium and iridium, 2 for nickel, palladium and platinum, and 1 for copper;
or transition metal compounds of general formula (XXIIb)
M³(Y²)ₚB¹₂ (XXIIb)
in which
M³ represents ruthenium, rhodium, iridium, nickel, palladium, platinum or copper; and
Y² represents chloride, bromide, acetate, methanesulfonate, trifluoromethanesulfonate, tetrafluoroborate, hexafluorophosphate, perchlorate, hexafluoroantimonate, tetrakis[3,5-bis(trifluoromethyl)phenyl]-borate; and
p represents 1 for rhodium and iridium, 2 for nickel, palladium, platinum and ruthenium, and 1 for copper;
each B¹ represents a C₂-C₁₂ alkene, such as ethylene or cyclooctene, or a nitrile, such as acetonitrile, benzonitrile or benzylnitrile; or
B¹₂ together represent a (C₄-C₁₂) diene, such as norbornadiene or 1,5-cyclooctadiene;
or transition metal compounds of general formula (XXIIc)
[M⁴B²Y¹₂]₂ (XXIIc)
in which
M⁴ represents ruthenium; and
B² represents aryl residues, such as cymyl, mesityl, phenyl or cyclooctadiene, norbornadiene or methylallyl;
or transition metal compounds of general formula (XXIId)
M⁵p[M⁶(Y³)₄] (XXIId)
in which
M⁶ represents palladium, nickel, iridium or rhodium; and
Y³ represents chloride or bromide; and
M⁵ represents lithium, sodium, potassium, ammonium or organic ammonium; and
p represents 3 for rhodium and iridium, and 2 for nickel, palladium and platinum;
or transition metal compounds of general formula (XXIIe)
[M⁷(B³)₂]An (XIIIe)
in which
M⁷ represents iridium or rhodium; and
B³ represents a (C₄-C₁₂) diene, for example, norbornadiene or 1,5-cyclooctadiene; and
An represents a non-coordinating or weakly coordinating anion, such as methanesulfonate, trifluoromethanesulfonate (Otf, OTf), tetrafluoroborate, hexafluorophosphate, perchlorate, hexafluoroantimonate, tetrakis[3,5-bis(trifluoromethyl)phenyl]borane, tetraphenylborate or a closo-boranate or a carboboranate;
or transition metal compounds selected from the group consisting of Ni(1,5-cyclooctadiene)₂, Pd₂(dibenzylideneacetone)₃, Pt(norbornene)₃, Ir(pyridine)₂(1,5-cyclooctadiene), [Cu(CH₃CN)₄]BF₄ and [Cu(CH₃CN)₄]PF₆ or polynuclear bridged complexes, such as [Rh(1,5-cyclooctadiene)Cl]₂ and [Rh(1,5-cyclooctadiene)Br]₂, [Rh(ethene)₂Cl]₂, [Rh(cyclooctene)₂C]₂.

29. Catalysts containing transition metal complexes according to one or more of claims 23 to 28.

30. A process for the hydrogenation or hydrosilylation of substrates, characterized by being performed in the presence of catalysts according to claim 45.

31. N-Diphenylphosphanyldibenzo[a,d]azepine;
5-bis(2-methoxyphenyl)phosphanyl-5H-dibenzo[a,d]cycloheptene;
5-bis(2-pyridyl)phosphanyl-5H-dibenzo[a,d]cycloheptene;
3,7-difluoro-5-diphenylphosphanyl-5H-dibenzo[a,d]cycloheptene; and
3,7-diiodo-5-diphenylphosphanyl-5H-dibenzo[a,d]cycloheptene.

32. Iridium complexes obtainable by reacting iridium compounds with compounds of general formula (XXIII) 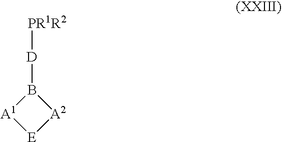
in which
R¹ and R² independently represent a monovalent residue containing from 1 to 30 carbon atoms; or
PR¹R² together represent a five- to nine-membered heterocyclic residue which contains a total of 2 to 50 carbon atoms and contains up to three further heteroatoms selected from the group consisting of oxygen and nitrogen; and
D is absent or represents NR³, wherein
R³ represents C₁-C₁₂ alkyl, C₃-C₁₂ alkenylalkyl, C₄-C₁₅ aryl or C₅-C₁₆ arylalkyl; and
in the case where D is absent:
B represents nitrogen or CH; and
in the case where D represents NR³:
B represents CH; and
A¹ and A² independently represent a substituted or unsubstituted orthoarylene residue; and
E represents E¹ or E2, and E¹ represents an unsubstituted, mono- or disubstituted vicinal cis-alkenediyl residue, and E² represents a vicinal alkanediyl residue in which each of the two -yl- carbon atoms bears one or two hydrogen atoms.

33. The iridium complexes according to claim 32, characterized in that the molar content of iridium in the iridium compound employed is from 50 to 200 mole percent, based on the compound of general formula (XXIII) employed.

34. The iridium complexes according to either of claims 32 or 33, characterized in that said iridium compound is selected from the group consisting of [Ir(cod)₂]PF₆, [Ir(cod)₂]ClO₄, [Ir(cod)₂]SbF₆ [Ir(cod)₂]BF₄, [Ir(cod)₂]OTf, [Ir(cod)₂]BAr₄, [Ir(nbd)₂]PF₆, [Ir(nbd)₂]CI0₄, [Ir(nbd)₂]SbF₆, [Ir(nbd)₂]BF₄, [Ir(nbd)₂]OTf, [Ir(nbd)₂]BAr₄ and Ir(pyridine)₂(nbd).

35. Iridium complexes containing compounds of general formula (XXIII) 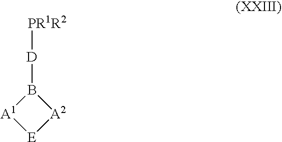
in which
R¹ and R² independently represent a monovalent residue containing from 1 to 30 carbon atoms; or
PR¹R² together represent a five- to nine-membered heterocyclic residue which contains a total of 2 to 50 carbon atoms and contains up to three further heteroatoms selected from the group consisting of oxygen and nitrogen; and
D is absent or represents NR³, wherein
R³ represents C₁-Cl₂ alkyl, C₃-C₁₂ alkenylalkyl, C₄-C₁₅ aryl or C₅-C₁₆ arylalkyl; and
in the case where D is absent:
B represents nitrogen or CH; and
in the case where D represents NR³:
B represents CH; and
A¹ and A² independently represent a substituted or unsubstituted orthoarylene residue; and
E represents E¹, and E¹ represents an unsubstituted, mono- or disubstituted vicinal cis-alkenediyl residue, with the proviso that the optionally present substituents are bound through an atom to the double bond of the cis-alkenediyl residue which bears no hydrogen atoms.

36. The iridium complexes according to claim 35, characterized in that the molar ratio of metal to compounds of general formula (I) is one to one.

37. The iridium complexes according to claim 35, characterized by being covered by general formula (XXVIIa)
[Ir(XXIII)(L¹)₂]An (XXVIIa)
in which
(XXIV) represents a compound of general formula (XXIII) with the meaning as mentioned in claim 51; and
each L¹ represents an olefin ligand; or
(L¹)₂ as a whole represents a diolefin ligand; and
An represents the anion of an oxy acid or a complex acid.

38. The iridium complexes according to claim 35, characterized by being covered by general formula (XXVIIIa)
[Ir(XXIII)(L²)ₓ]An (XXVIIIa)
in which
(XXIII) represents compounds of general formula (XXIII) with the meaning as mentioned in claim 51; and
L² represents a coordinated solvent molecule; and
x represents one, two or three.

39. The iridium complexes according to either of claims 37 or 38, characterized in that at least one of the following conditions is met by compounds of general formula (XXIII):
A¹-E-A² does not possess a mirror plane as an element of symmetry orthogonal to the carbon-carbon bond which connects the two vicinal -yl- residues of E;
R¹ and R² are different;
PR¹R² as a whole possesses at least one stereogenic center;
R³ possesses a stereogenic center.

40. [Ir(cod)(tropnp^{Ph})]Otf, [Ir(cod)(_{Me2NO2S}tropp^{Ph})]Otf, [Ir(cod)(tropp^{Ph})]Otf, [Ir(^{F}tropp^{Ph})(cod)]Otf.

41. [Ir(cod)((R)-tropp^{Ph,Et-2-Py})]Otf, [Ir(cod)((S)-tropp^{Ph,Et-2-Py})]Otf, [Ir(cod)-((R)-tropp^{Cyc,Et-2-PY)]Otf, [Ir(cod)((R)-tropp}^{Cyc,Et-2-Py})]PF₆, [Ir(cod)((S)-tropp^{Cyc,Et-2-Py})]Otf, [Ir(cod)((R)-tropp^{Ph,Et-N-Pyrro})]Otf, [Ir(cod)((S)-tropp^{Ph,Et-N-Pyrro})]Otf, Ir(cod)((R)-tropp^{Cyc,Et-N-Pyrro})]Otf, Ir(cod)((S)-tropp^{Cyc,Et-N-Pyrro})]Otf, [Ir(cod)-(R,R)-tropphos^{Me})]Otf, [Ir(cod)(S,S)-tropphos^{Me})]Otf, [Ir((R)-^{menthyoxy}tropp^{Ph})(cod)]PF₆, [Ir((S)-^{menthyloxy}tropp^{Ph})(cod)]PF₆, [Ir((R)-tropph)(cod)]Otf, [Ir((S)-tropp^{Ph}) (cod)]Otf, [Ir(cod)((R)-^{menthyloxy}-tropp^{Ph})]Otf, [Ir(cod)((S)-^{menthylox}ytropp^{Ph})]Otf, [Ir(cod)((R)-^{metpxy}tropp-^{Cyc})]Otf, [Ir(cod)((S)-^{methoxy}tropp^{Cyc})]Otf, [Ir(cod)((R)-^{methoxy}tropp^{Ph})]Otf, [Ir(cod )((S)-^{methoxy}tropp^{Ph})]Otf, [Ir(cod)((R)-tropp^{iPrCH2P(iPr)2})]Otf, [Ir(cod)-((S)-tropp^{iPrCH2P(iPr)2})]Otf.

42. Catalysts containing iridium complexes according to one or more of claims 32 to 41.

43. A process for the hydrogenation of olefins, enamines, enamides and imines, characterized by being performed in the presence of catalysts according to claim 42.

44. A process for the hydrogenation of compounds of general formula (XXIV)
Ar—N═CR²⁷R²⁸ (XXIV)
in which
Ar represents a C₄-C₂₄ aryl or C₅-C₂₅ arylalkyl; and
R²⁷ and R28 independently represent hydrogen, C₁-C₁₈ alkyl, C₄-C₂₄ aryl or C₅-C₂₅ arylalkyl, or CR²⁷R²⁸ together form a five- to seven-membered cyclic residue which may contain up to two further heteroatoms selected from the group consisting of oxygen or nitrogen; or
one of the residues R²³ or R²³ together with the residue Ar and the imine function forms a five- or six-membered N-heterobicyclic residue with a total of from 4 to 34 carbon atoms;
characterized by being performed in the presence of catalysts according to claim 58.

45. A process for the hydrogenation of compounds of general formula (XXV) 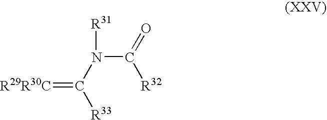
in which
R²⁹ and R³⁰ independently represent hydrogen, C₁-C₁₈ alkyl, C₅-C₂₄ aryl or C₆-C₂₅ arylalkyl, or CR²⁹R³⁰ together form a five- to seven-membered residue which contains up to two further heteroatoms selected from the group consisting of oxygen or nitrogen;
R³⁰ represents hydrogen or C₁-C₁₆ alkyl; and
R³¹ represents C₁-C₁₈ alkyl, C₅-C₂₄ aryl or C₆-C₂₅ arylalkyl; and
R³² represents hydrogen, C₁-C₁₈ alkyl or residues of general formula (XXVI): 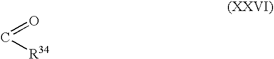
in which
R³⁴ represents C₁-C₁₈ alkoxy, C₅-C₂₄ aryloxy or C₆-C₂₅ arylalkoxy or amino, C₁-C₆ alkylamino or di(C₁-C₆ alkyl)amino;
characterized by being performed in the presence of catalysts according to claim 58.

46. Use of compounds according to one or more of claims 18 to 21 for the synthesis of compounds according to one or more of claims 1 to 13.

47. Use of catalysts according to one or more of claims 29 and 42 in a process for preparing agrochemicals, medicaments or intermediates thereof.

48. Compounds of general formula (Ia) 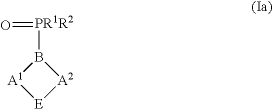
in which
R¹ and R² independently represent a monovalent residue containing from 1 to 30 carbon atoms; or
PR¹R² together represent a five- to nine-membered heterocyclic residue which contains a total of 2 to 50 carbon atoms and contains up to three further heteroatoms selected from the group consisting of oxygen and nitrogen; and
B represents nitrogen or CH; and
A¹ and A² independently represent a substituted or unsubstituted orthoarylene residue; and
E represents E¹ or E2, and E¹ represents an unsubstituted, mono- or disubstituted vicinal cis-alkenediyl residue, and E² represents a vicinal alkanediyl residue in which each of the two -yl- carbon atoms bears one or two hydrogen atoms;
wherein at least one or more of the following conditions are met:
A¹-E-A² does not possess a mirror plane as an element of symmetry orthogonal to the carbon-carbon bond which connects the two vicinal -yl- residues of E;
R¹ and R² are different;
PR¹R² as a whole possesses at least one stereogenic center.
